(19) United States
(12) Patent Application Publication
(10) Pub. No.: US 2024/0370024 A1
(43) Pub. Date: Nov. 7, 2024

(54) UNMANNED AERIAL VEHICLE

(71) Applicants: HEXAGON GEOSYSTEMS SERVICES AG, Heerbrugg (CH); LEICA GEOSYSTEMS AG, Heerbrugg (CH)

(72) Inventors: Burkhard BÖCKEM, Jonen (CH); Pascal STRUPLER, Ennetbaden (CH); Pascal GOHL, Winterthur (CH); Fabio DIEM, Zürich (CH); Adrien KERROUX, Zürich (CH); Andreas JÄGER, Zürich (CH); Axel MURGUET, Zürich (CH); Cédric DE CROUSAZ, Zürich (CH); Dimitris GRYPARI, Glattbrugg (CH); Dominik HONEGGER, Zug (CH); Dominique MERZ, Bronstetten (CH); Garance BRUNEAU, Zürich (CH); Jean-Bernard BERTEAUX, Zürich (CH); Jerome KÄSER, Rombach (CH); Lukas SCHMID, Zürich (CH); Marko PANJEK, Zürich (CH); Moritz PFLANZER, Zürich (CH); Tim OBERHAUSER, Basel (CH)

(73) Assignees: HEXAGON GEOSYSTEMS SERVICES AG, Heerbrugg (CH); LEICA GEOSYSTEMS AG, Heerbrugg (CH)

(21) Appl. No.: 18/573,391

(22) PCT Filed: Jun. 23, 2021
(86) PCT No.: PCT/EP2021/067262

§ 371 Date: Dec. 21, 2023

(51) Int. Cl. G05D 1/224; G05D 1/223; G05D 1/622

(52) U.S. Cl. CPC G05D 1/2246; G05D 1/2232; G05D 1/622

(57) ABSTRACT

The invention relates to an unmanned aerial vehicle (UAV), the operation of a UAV, and the control of a UAV. Aspects of the invention relate to a UAV including a directional distance measuring module for inspecting/surveying/measuring/digitizing the UAV's environment.

### FIELD OF THE INVENTION

The invention relates to an unmanned aerial vehicle (UAV), the operation of a UAV, and the control of a UAV. Aspects of the invention relate to a UAV including a directional distance measuring module for inspecting/surveying/measuring/digitizing the UAV's environment.

### BACKGROUND TO THE INVENTION

UAVs, in particular rotary wing drone type UAVs, have flooded the consumer- and service-market and are being developed to manage a wide variety of tasks in technical and non-technical fields: Recording movie scenes, freight transportation, inspection of buildings/technical installations, surveying/measuring/digitizing physical environments etc.

The functionality of UAVs is rapidly increasing, as is the complexity of the tasks, which can be performed by UAVs. With the increasing complexity of the tasks, providing an intuitive, simple and reliable controllability can be challenging.

In the fields of inspecting buildings/technical installations and surveying/digitizing physical environments it is a long lasting desire to provide a UAV for, at least semi-autonomously, performing the inspection and surveying/digitizing.

Various attempts have been made to attach inspecting/surveying/digitizing equipment to UAV's. Nevertheless, it remains challenging to provide a UAV for, at least semi-autonomously, performing the inspection and surveying/digitizing, which is intuitively, simple and reliably controllable.

Remote controlling UAVs is typically based on using a control system, an environment sensor system including at least one sensor module, for example a directional distance measuring module, and a motion generation system. The systems are at least communicatively interconnected.

The control system controls at least the UAV's propulsion units.

The environment sensor system is typically arranged on the UAV and senses/inspects/surveys/digitizes the environment of the UAV. Sensing/inspecting/surveying/digitizing typically relates to surveying the environment and/or objects in the environment to generate point cloud data representing the environment and/or objects and detecting obstacles in the environment of the UAV in order to avoid collisions.

The motion generation system generates control commands based on user input and on sensing output of the environment sensor system, wherein these control commands are received by the control system. User input is typically received through a graphical user interface (GUI) of a mobile control device having a touch sensitive display, wherein the GUI presents high-level control commands, which can be triggered by the user. Triggering a high-level control command typically results in the execution of numerous complex control commands by the control system finally guiding the movement of the UAV.

To present an easily graspable GUI with intuitive top-level control commands, the GUI typically shows a three-dimensional view (3D-view), e.g. a three-dimensional-like representation, of the physical environment of the UAV from a perspective of the UAV, which is generated by an on board camera system, in a live-view. The GUI is then displaying the 3D-view of the physical environment of the UAV, for example on the touch sensitive display of the mobile control device. Thereby, a simple image generated by a camera of the UAV represents a 3D-view of the physical environment—as it provides a perspective view and thereby comprises depth information—, as is e.g. a 3D-model of the environment, which comprises model-points of the environment with 3D-point information.

### OBJECT OF THE INVENTION

It is an object of the invention to provide a UAV, with an improved operability and controllability.

It is a further object of the invention to provide improved methods for controlling the flight of a UAV in a physical environment.

It is a further object of the invention to provide a UAV including a directional distance measuring module for sensing/inspecting/surveying/digitizing the UAV's environment.

It is a further object of the invention to provide a UAV for, at least semi-autonomously, performing an inspection and surveying/digitizing of an environment, which is intuitively, simple and reliably controllable.

It is a further object of the invention to provide improved methods for autonomously navigating a UAV in a physical environment.

### SUMMARY OF A FIRST ASPECT OF THE INVENTION

A first aspect of the invention relates to a computer implemented method for controlling the flight of a UAV in a physical environment, the method includes the steps outlined in the following.

A step of providing a communicative connection between a mobile control device having a touch sensitive display and the UAV.

The mobile control device can be for example a tablet pc, a mobile phone, a smart watch, a laptop with touchscreen etc. The mobile control device is further configured to receive touch inputs. The mobile control device can further be realized as part of an augmented reality (AR) and/or virtual reality (VR) system. Then the touch sensitive display is realized by the display functionality of the AR and/or VR system interacting with a touch sensitive controller, which is configured to receive touch inputs.

The communicative connection relates to a connection for transmitting and receiving (transceiving) data. Data can relate for example to signals, in particular sensor signals, inputs, in particular control inputs, outputs, in particular sensor outputs or outputs generated by processing units of the control device or UAV etc.

The communicative connection can be provided based on using any of the established technologies enabling a wireless communicative connection. The communicative connection can be provided based on using for example Wi-Fi/WLAN standards, Bluetooth standards, LTE standards, satellite communication standards, radio standards, NFC standards, infrared standards etc. Furthermore, the communicative connection can be provided based on using one or a plurality of the established technologies enabling a wireless communicative connection. In case more than one of the established technologies is used, the usage of one of the technologies can be based on a criterion relating to, for example, the availability of needed infrastructure/signal strength for establishing the communicative connection or a distance between the UAV and the mobile control device.

A step of receiving environment data from at least one sensor module of the UAV, wherein the UAV has at least a directional distance measuring module as sensor module with a field of view having a main view direction.

Environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV.

For example, a sensor module can be a radar based distance measuring module. The sensing action then relates to sensing a distance to an object/object surface/a surface of the environment. The environment data then includes distance information for determining a distance to the object/object surface/surface of the environment.

As a further example, a sensor module can be a temperature measuring module. The sensing action then relates to sensing a temperature of the environment. The environment data then includes temperature information for determining a temperature of the environment.

As a further example, a sensor module can be a barometer module. The sensing action then relates to sensing air pressure of the environment. The environment data then includes pressure information for determining an air pressure of the environment.

As a further example, the sensor module can be a directional distance measuring module. The sensing action then relates to sensing a distance and direction to an object/object surface/a surface of the environment. The environment data then includes distance and direction information for determining a distance and direction to the object/object surface/surface of the environment. Based on such environment information a representation of the physical environment of the UAV can be generated, for example a 3D point cloud based representation.

The directional distance measuring module can, for example, be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

As a further example, the sensor module can be a camera system. The sensing action then relates to sensing light of the environment. The environment data then includes light information/image information, for example in the form of image data, for generating an image of the environment.

As a further example, the sensor module can be an inertial measurement unit (IMU). The sensing action then relates to sensing an angular rate and/or an acceleration. The environment data then includes angular rate information and/or acceleration information for determining, for example, an orientation and/or directional acceleration of the UAV in the environment.

As a further example, the sensor module can be a global navigation satellite system (GNSS) receiver. The sensing action then relates to sensing/receiving signals from GNSS satellites. The environment data then includes GNSS information, in the form of, for example, global position data, for determining a position of the UAV in a local, regional or global reference coordinate system.

A step of determining at least a part of an object surface based on the environment data.

An object is a physical object of and/or in the physical environment of the UAV. The object can be, for example, a building, a tower, a car, a human being, a tree etc. The object has a surface. The surface can be in different forms. For example, the surface can be flat, curved, kinked etc.

Determining at least part of an object surface relates to determining geometric/form features of the surface. Geometric/form features relating to for example a curvature, a surface topology, a texture, a dimension etc. of the at least a part of the surface. The geometric/form features can be determined based on the environment data. For example, based on distance information for determining a distance to the at least a part of the object surface and/or based on distance and direction information for determining a distance and direction to the at least a part of the object surface and/or based on light information/image information, in the form of image data, for generating an image of the environment etc.

A step of generating a view of the physical environment of the UAV based on the environment data.

The view relates to a representation of at least a part of the physical environment. The representation can be for example an image of at least a part of the physical environment. The representation can be for example a 3D point cloud based representation of at least a part of the physical environment. The representation can be for example a 3D model of at least a part of the physical environment. The representation can be for example a temperature map of at least a part of the physical environment.

The view can be generated based on for example image data, distance and direction information, temperature information etc. Thereby, generating the view can be based on using selected environment data from the entire environment data available.

A step of displaying the view of the physical environment in a live-view by the touch sensitive display.

Displaying relates to presenting the view aiding a display device/display functionality such that the view is perceptible by, for example, a user of the UAV. For example, if the mobile control device is a tablet pc with a touch sensitive display the view is displayed by displaying the view on the touch sensitive display.

The live-view relates to displaying a view, which is typically based on most recent environment data. It can relate to displaying the view at a predefined frequency/frame rate, wherein the view is generated at least at the predefined frequency/frame rate. Each generation of the view is typically based on most recent environment data.

A step of providing a constant distance mode.

A constant distance mode relates to a mode within which the UAV is moving along an object surface at a constant distance. For example, if the object is a building the object surface can be a façade. Then, within the constant distance mode, the UAV is flying along the façade at a constant distance, for example at a constant distance of three, five, 10 etc. meters. The constant distance can be predefined. The constant distance can depend on properties of the directional distance measuring module.

A step of—within the constant distance mode—receiving a touch input, indicative of moving the UAV in the physical environment.

A touch input can relate to, for example, a touching of the touch sensitive display, or touch sensitive controller, with a finger or a pen-like mean. A touch input can relate to, for example, a touching of the touch sensitive display with a finger or a pen and while touching moving the finger or the pen across the touch sensitive display. A touch input can relate to for example a “two finger pinch”, “two finger stroke”, “single tap”, “one-finger stroke” or “double tap” touch input.

The touch input is a touch input, which indicates a movement of the UAV. For example, a “single tap” touch input can indicate a rotational movement of the UAV, or a “two-finger pinch” touch input can indicate a translational movement of the UAV etc.

A step of—within the constant distance mode—instructing—based thereon, in particular based on receiving a touch input—the UAV to move.

Instructing the UAV to move relates to generating control commands based on the touch input, in particular and on environment data, wherein these control commands are received by a control system of the UAV finally guiding the movement of the UAV.

A step of instructing, in case the touch input being a “stroke”-based touch input with a stroke progression, while receiving the “stroke”-based touch input, the UAV to position and orient itself such that the main view direction is aligned in a predefined way to the determined at least a part of the object surface, maintain during moving the alignment of the main view direction in the predefined way, and a constant distance to the object surface, and move along the object surface based on the stroke progression.

A “stroke”-based touch input relates to a touching of the touch sensitive display, or touch sensitive controller, with at least one finger or a pen-like mean, wherein the finger or pen-like mean strokes over the touch sensitive display, or touch sensitive controller without interrupting the touch/contact. The stroke progression relates to the stroke movement, in particular to the movement of the at least one finger or pen-like mean stroking from one location to another one.

While receiving the “stroke”-based touch input relates to the UAV being instructed to move starting from receiving the “stroke”-based touch input until the touch/contact is interrupted/the “stroke”-based touch input is completed.

Aligned in a predefined way/a predefined alignment can relate to the main view direction being aligned under a predefined, in particular horizontal, angle to the determined at least a part of the object surface. The predefined, in particular horizontal, angle can be an angle relating to a perpendicular alignment of the main view direction to the determined at least a part of the object surface. A predefined alignment can relate to the main view direction being aligned under a predefined, in particular horizontal, angle to the determined at least a part of the object surface, wherein the predetermined, in particular horizontal, angle is determined based on a predefined criterion relating to a quality criterion with respect to measuring directional distances with the directional distance measuring module.

The object surface can include parts, which are not determinable when the at least a part of the object surface is determined. Nevertheless, these parts can be determinable, after the at least a part of the object surface has been determined, by moving the UAV. Then, the alignment of the main view direction in the predefined way and the constant distance to these parts of the object surface are maintained during moving the UAV. This means that the alignment of the main view direction in the predefined way and the constant distance can be applied with respect to parts of the object surface which are determinable after the at least a part of the object surface has been determined and by moving the UAV.

A constant distance to the at least a part of the object surface/the object surface can be maintained based on measuring directional distances to the at least a part of the object surface/the object surface.

According to a specific embodiment of the first aspect of the invention, the “stroke”-based touch input is a “two-finger stroke” touch input.

According to an embodiment of the first aspect of the invention, the method includes deriving a stroke progression start state, a stroke progression end state, and a stroke direction based on the stroke progression start state and stroke progression end state, and instructing the UAV to move along the object surface along the stroke direction.

A stroke progression can include a plurality of stroke progression start states and stroke progression end states adding up to the stroke progression.

According to an embodiment of the first aspect of the invention, the method includes determining a distance between a location of the stroke progression start state and a location of the stroke progression end state, and instructing the UAV to move along the object surface based on the distance.

According to an embodiment of the first aspect of the invention, the method includes determining a flight-velocity based on the distance, and instructing the UAV to move along the object surface based on the flight-velocity.

According to an embodiment of the first aspect of the invention, the method includes a step of providing a selectability of the at least a part of the object surface on the touch sensitive display, wherein providing the constant distance mode is based thereon.

A selectability can be provided for example by enabling the selection of the at least a part of the object surface by touching it on the display. Providing a selectability can further include highlighting the at least a part of the object surface.

According to an embodiment of the first aspect of the invention, the method includes a step of providing, based on a predefined criterion relating to the determined at least a part of the object surface, in particular together with the selectability of the at least a part of the object surface, a selectability of the constant distance mode on the touch sensitive display, wherein providing the constant distance mode is based thereon.

A predefined criterion can relate to a geometric/form feature of the surface, for example to a curvature, a surface topology, a texture, a dimension etc. of the at least a part of the surface.

A selectability can be provided for example by enabling the selection of the constant distance mode by touching an indicator indicating the constant distance mode on the touch sensitive display or touch sensitive controller. Providing a selectability can further include displaying an indicator on the touch sensitive display or touch sensitive controller. The indicator can be, for example, an actuable symbol being overlaid to the view of the physical environment.

According to an embodiment of the first aspect of the invention, the predefined criterion relates to a determined curvature of the determined at least a part of the object surface, wherein the determined curvature having a predefined relation to a curvature threshold level triggers providing the selectability of a constant distance mode.

A predefined relation can relate to, for example, the determined curvature being above the curvature threshold level or a value determinable based on the determined curvature being below the curvature threshold value.

According to an embodiment of the first aspect of the invention, the predefined criterion relates to a discontinuity in the determined at least a part of the object surface, wherein the identification of a discontinuity triggers providing the selectability of a constant distance mode.

A discontinuity can relate for example to a step, kink, edge, gap etc. in the at least a part of the object surface.

According to an embodiment of the first aspect of the invention, the method includes a step of receiving environment data in the form of image data from a camera system of the UAV, the camera system being a sensor module of the UAV.

According to an embodiment of the first aspect of the invention, the method includes a step of receiving environment data in the form of 3D point cloud data derived from directional distance information provided by the directional distance measuring module.

Directional distance information can include, for example, distance information relating to a distance to an object surface/a point of an object surface and/or direction information relating to a direction to an object surface/a point of an object surface.

According to an embodiment of the first aspect of the invention, the method includes a step of correlating the image data and the 3D point cloud data, and determining the at least a part of the object surface based on correlated image data and 3D point cloud data.

Correlating can relate to assign the image data to 3D point cloud data based on feature recognition algorithms. The feature recognition algorithms can use, for example, the recognition of features in the 3D point cloud data and the image data for correlating the image data to 3D point cloud data. Correlating can also relate to assign location information to the image data and correlate the image data to 3D point cloud data based on the location information assigned to the image data.

According to an embodiment of the first aspect of the invention, the method includes a step of providing the selectability of the constant distance mode by overlaying an actuable symbol to the determined at least a part of the object surface in the displayed view of the physical environment.

According to an embodiment of the first aspect of the invention, the UAV has a body extending along an axis, in particular the roll axis of the UAV, from a front end to a back end, and the directional distance measuring module is integrated in the front end of the body such that the main view direction is aligned along the axis, in particular along the roll axis of the UAV.

According to an embodiment of the first aspect of the invention, the directional distance measuring module measures distances and directions to object surfaces based on the light detection and ranging (lidar) principle.

Thereby, distances and directions to object surfaces typically relate to distances and directions to points of the object surfaces. Measuring distances and directions to object surfaces can relate to measuring a horizontal angle, a vertical angle and a distance to the object surface and/or a point of the object surface. The lidar principle relates to measuring a distance based on the time of flight of a distance measurement radiation pulse hitting an object surface and being reflected to be detected by the directional distance measuring module.

The directional distance measuring module can be a scanner module, using distance measurement radiation to scan the physical environment, and based thereon measuring distances and directions to object surfaces. The scanner module can be a laser scanner module and the distance measurement radiation can be laser radiation.

According to a specific embodiment of the first aspect of the invention, the UAV of the method is a UAV according to the fifteenth aspect of the invention.

The first aspect of the invention further relates to a computer program product comprising machine readable program code, which when executed by processing units related to a mobile control device having a touch sensitive display and/or a UAV, wherein the UAV has at least one sensor module, and at least a directional distance measuring module as sensor module with a field of view having a main view direction, enables controlling the flight of the UAV, according to the method of the first aspect of the invention.

The first aspect of the invention further relates to a system for controlling the flight of a UAV in a physical environment, the system includes: the UAV, wherein the UAV has at least one sensor module, and at least a directional distance measuring module as sensor module with a field of view having a main view direction, and a computer program product according to the first aspect of the invention.

According to an embodiment of the first aspect of the invention, the system further includes a mobile control device having a touch sensitive display.

According to an embodiment of the first aspect of the invention, the UAV has a camera system, the camera system including a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways. The cameras are arranged such that each field of view overlaps to a predefined degree at least one adjacent field of view, and the camera system provides an all-round view to the physical environment.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the first aspect of the invention, the directional distance measuring module is configured to measure a distance and direction to an object surface of the physical environment of the UAV, and—at least part of which object surface—is within at least one field of view of a camera.

According to a specific embodiment of the first aspect of the invention, the UAV of the system is a UAV according to the fifteenth aspect of the invention.

### SUMMARY OF A SECOND ASPECT OF THE INVENTION

A second aspect of the invention relates to a computer implemented method for controlling the flight of a UAV in a physical environment, the method includes the steps outlined in the following.

A step of continuously generating a view of the physical environment of the UAV based on image data from a camera system of the UAV.

The view relates to a representation of at least a part of the physical environment. The representation can be for example an image of at least a part of the physical environment, the image being based on image data from the camera system.

Continuously generating a view relates to steadily generating the view. Thereby, the view can be steadily/continuously generated at a given frequency/frame rate. The frequency can be variable. For example, the view can be generated 50 times per second, relating to generating 50 views per second. The view can be generated, for example, between 50 to 250 times per second, relating to generating 50 to 250 views per second.

A step of continuously displaying the view of the physical environment in a live-view by a touch sensitive display.

Displaying relates to presenting the view aiding a display device/display functionality such that the view is perceptible by, for example, a user of the UAV. For example, if the touch sensitive display is part of a mobile control device being a tablet pc with a touch sensitive display the view is displayed by displaying the view on the touch sensitive display. The touch sensitive display can be part of a tablet pc, a mobile phone, a smart watch, a laptop etc.

The touch sensitive display is further configured to receive touch inputs. The touch sensitive display can also be realized as part of an augmented reality (AR) and/or virtual reality (VR) system. Then the touch sensitive display is realized by a display functionality of the AR and/or VR system interacting with a touch sensitive controller, which is configured to receive touch inputs.

Continuously displaying the view is performed in analogy to continuously generating the view. Nevertheless, continuously displaying the view can be performed at a given frequency/frame rate. This given frequency/frame rate can be different to the frequency of continuously generating a view.

The live-view relates to displaying a view, which is typically based on most recent image data. It can relate to displaying the view at a predefined frequency/frame rate, wherein the view is generated at least at the predefined frequency/frame rate. Each generation of the view is typically based on most recent image data.

A step of receiving and identifying a “two-finger pinch” touch input with two pitch points, indicative of moving the UAV in the physical environment along a pinch direction.

The “two-finger pinch” touch input is a touch input, which indicates a movement of the UAV. For example, the “two-finger pinch” touch input indicates a translational movement of the UAV. A pitch point relates to a point, where the touch input of one finger is received. The pitch points can be for example the two locations on a touch sensitive display, where the two fingers touch the display while performing the “two-finger pinch” touch input.

The pinch direction relates to a direction derived based on the two pitch points. The pinch direction is a direction towards a point in the physical environment or away from it.

A step of, based thereon, instructing the UAV to move.

Instructing the UAV to move relates to generating control commands based on the “two-finger pinch” touch input, in particular and on environment data, wherein these control commands are received by a control system of the UAV finally guiding the movement of the UAV. Thereby, environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV. Environment data can include image data from the camera system of the UAV.

A step of, while receiving the “two-finger pinch” touch input, determining a pitch point progression of the pitch points, and adapting the live-view by digitally scaling the view based on the pitch point progression.

Digitally scaling can relate, for example, to digitally scaling the view and continuously generating and displaying the digitally scaled view in the live-view. Thereby, it is still a live-view but from a digitally scaled view.

A step of deriving a pitch point progression start state and a pitch point progression end state.

A pitch point progression can include a plurality of pitch point progression start states and pitch point progression end states adding up to the pitch point progression.

A step of instructing the UAV to move along the pinch direction based on the pitch point progression start state and end state.

According to an embodiment of the second aspect of the invention, the method includes a step of deriving a first distance between the two pitch points in the pitch point progression start state and a second distance between the two pitch points in the pitch point progression end state, and a step of instructing the UAV to move along the pinch direction based on the derived first distance and second distance.

According to an embodiment of the second aspect of the invention, the method includes a step of deriving an end-midpoint between the two pitch points in the pitch point progression end state, and a step of instructing the UAV to move along the pinch direction based on the derived end-midpoint.

The end-midpoint relates to a point, which is located at a middle position between the two pitch points, in the pitch point progression end state.

According to an embodiment of the second aspect of the invention, the method includes a step of deriving a start-midpoint between the two pitch points in the pitch point progression start state, and a step of instructing the UAV to move along the pinch direction based on the derived start-midpoint.

The start-midpoint relates to a point, which is located at a middle position between the two pitch points, in the pitch point progression start state.

According to an embodiment of the second aspect of the invention the camera system includes a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, the method including, while receiving the “two-finger pinch” touch input, determining, based on the pitch point progression, at least one of the plurality of cameras, based on the image data of which the view is continuously generated and displayed.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the second aspect of the invention, the method includes deriving a pitch point progression start state and a pitch point progression end state, and instructing the UAV to move along the pinch direction based on the pitch point progression start state and end state, while receiving the “two-finger pinch” touch input.

According to an embodiment of the second aspect of the invention, the method includes instructing the UAV to move along the pinch direction based on the pitch point progression start state and end state, after the “two-finger pinch” touch input has been received.

According to an embodiment of the second aspect of the invention, the method includes digitally scaling the view to a digitally scaled end-view in the pitch point progression end state, and while the UAV is moving along the pinch direction, digitally scaling the view from the digitally scaled end view smoothly to a digitally un-scaled view, and continuously displaying the digitally un-scaled view of the physical environment in the live-view by the touch sensitive display.

Scaling smoothly can relate to scale from one view to the other slowly but fluently, to create the impression of a smooth transition between the one view and the other view.

According to an embodiment of the second aspect of the invention, the method includes, while the UAV is moving along the pinch direction, the view being a simulated view of the physical environment, and continuously displaying the simulated view by the touch sensitive display.

The simulated view is a view, which is continuously generated and displayed based on image data or environment data, which has been previously recorded.

According to an embodiment of the second aspect of the invention, the method includes, while the UAV is moving along the pinch direction, the view being a freezed view of the physical environment, and continuously displaying the freezed view by the touch sensitive display.

According to an embodiment of the second aspect of the invention, the method includes, while the UAV is moving along the pinch direction, the view being a blank view, and continuously displaying the blank view by the touch sensitive display.

A blank view can relate, for example, to a totally blackened or whitened view, not including any features of the environment.

According to an embodiment of the second aspect of the invention, the method includes, after a movement of the UAV along the pinch direction, passing from the view to a digitally un-scaled view of the physical environment and continuously displaying the digitally un-scaled view in the live-view by the touch sensitive display.

The second aspect of the invention further relates to a computer program product comprising machine readable program code, which when executed by processing units related to a mobile control device having a touch sensitive display and/or a UAV enables controlling the flight of a UAV including a camera system, according to the method of the second aspect of the invention.

According to a specific embodiment of the second aspect of the invention, the UAV of the method is a UAV according to the fifteenth aspect of the invention.

### SUMMARY OF A THIRD ASPECT OF THE INVENTION

A third aspect of the invention relates to a computer implemented method for controlling the flight of a UAV having a main view direction in a physical environment, the method includes the steps outlined in the following.

A step of continuously generating a view of the physical environment of the UAV based on image data from a camera system of the UAV.

The view relates to a representation of at least a part of the physical environment. The representation can be for example an image of at least a part of the physical environment, the image being based on image data from the camera system.

Continuously generating a view relates to steadily generating the view. Thereby, the view can be steadily/continuously generated at a given frequency/frame rate. The frequency can be variable. For example, the view can be generated 50 times per second, relating to generating 50 views per second. The view can be generated, for example, between 50 to 250 times per second, relating to generating 50 to 250 views per second.

A step of continuously displaying the view of the physical environment, in a first view direction, in a live-view by a touch sensitive display.

Displaying relates to presenting the view aiding a display device/display functionality such that the view is perceptible by, for example, a user of the UAV. For example, if the touch sensitive display is part of a mobile control device being a tablet pc with a touch sensitive display the view is displayed by displaying the view on the touch sensitive display. The touch sensitive display can be part of a tablet pc, a mobile phone, a smart watch, a laptop etc.

The first view direction can be different from the main view direction.

The touch sensitive display is further configured to receive touch inputs. The touch sensitive display can also be realized as part of an augmented reality (AR) and/or virtual reality (VR) system. Then the touch sensitive display is realized by a display functionality of the AR and/or VR system interacting with a touch sensitive controller, which is configured to receive touch inputs.

Continuously displaying the view is performed in analogy to continuously generating the view. Nevertheless, continuously displaying the view can be performed at a given frequency/frame rate. This given frequency/frame rate can be different to the frequency of continuously generating a view.

The live-view relates to displaying a view, which is typically based on most recent image data. It can relate to displaying the view at a predefined frequency/frame rate, wherein the view is generated at least at the predefined frequency/frame rate. Each generation of the view is typically based on most recent image data.

A step of receiving and identifying a “two-finger stroke” touch input with a stroke progression, indicative of moving the UAV in the physical environment along a stroke direction.

The “two-finger stroke” touch input is a touch input, which indicates a movement of the UAV. For example, the “two-finger stroke” touch input indicates a translational movement of the UAV.

The “two-finger stroke” touch input relates to touching of the touch sensitive display, or touch sensitive controller, with two fingers, wherein the fingers stroke over the touch sensitive display, or touch sensitive controller without interrupting the touch/contact.

The stroke progression relates to the stroke movement, in particular to the movement of the two fingers stroking from one location to another one.

The stroke direction relates to a direction derived based on the stroke progression.

A step of, based thereon, in particular based on receiving and identifying a “two-finger stroke” touch input, instructing the UAV to move.

Instructing the UAV to move relates to generating control commands based on the “two-finger stroke” touch input, in particular and on environment data, wherein these control commands are received by a control system of the UAV finally guiding the movement of the UAV. Thereby, environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV. Environment data can include image data from the camera system of the UAV.

A step of, while receiving the “two-finger stroke” touch input, determining the stroke progression.

A step of deriving a stroke progression start state and a stroke progression end state.

A stroke progression can include a plurality of stroke progression start states and stroke progression end states adding up to the stroke progression.

A step of instructing the UAV to move transverse to the first view direction and along the stroke direction, based on the stroke progression start state and end state.

According to an embodiment of the third aspect of the invention, the method includes a step of determining a first location of the stroke progression start state, and a second location of the stroke progression end state, a step of determining the stroke direction based on the first location and the second location, and a step of instructing the UAV to move transverse to the first view direction and along the stroke direction, based on the first location and the second location.

According to an embodiment of the third aspect of the invention, the method includes a step of determining a distance between the first location and the second location, and a step of instructing the UAV to move transverse to the first view direction and along the stroke direction, based on the distance.

According to an embodiment of the third aspect of the invention, the method includes a step of determining a flight-velocity based on the distance, and instructing the UAV to move based on the flight-velocity.

According to an embodiment of the third aspect of the invention, the method includes a step of instructing the UAV to move at a constant distance to an identified object surface.

An object is a physical object of and/or in the physical environment of the UAV. The object can be, for example, a building, a tower, a car, a human being, a tree etc. An object has a surface. The surface can be in different forms. For example, the surface can be flat, curved, kinked etc.

An object can be identified, for example, by image recognition algorithms, or by a sensor module of the UAV, which generates environment data based on which objects can be identified. The moving at a constant distance to the object surface can be based on using distance information generated by a sensor module of the UAV, wherein based on the distance information a distance to an identified object can be determined and maintained during moving the UAV.

According to an embodiment of the third aspect of the invention, the camera system includes a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, the method including, while receiving the “two-finger stroke” touch input, determining, based on the stroke progression, at least one of the plurality of cameras, based on the image data of which the view is continuously generated and displayed.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the third aspect of the invention, the method includes deriving a stroke progression start state and a stroke progression end state, and instructing the UAV to move transverse to first view direction and along the stroke direction, based on the stroke progression start state and end state, while receiving the “two-finger stroke” touch input.

While receiving the “two-finger stroke” touch input relates to the UAV being instructed to move starting from receiving the “two-finger stroke” touch input until the touch/contact is interrupted/the “two-finger stroke” touch input is completed.

According to an embodiment of the third aspect of the invention, the method includes instructing the UAV to move transverse to the first view direction and along the stroke direction, based on the stroke progression start state and end state, after the “two-finger stroke” touch input has been received.

According to an embodiment of the third aspect of the invention, the method includes, while the UAV is moving transverse to the first view direction and along the stroke direction, the view being a simulated view of the physical environment, and continuously displaying the simulated view by the touch sensitive display.

The simulated view is a view, which is continuously generated and displayed based on image data or environment data, which has been previously recorded.

According to an embodiment of the third aspect of the invention, the method includes, while the UAV is moving transverse to the first view direction and along the stroke direction, the view being a freezed view of the physical environment, and continuously displaying the freezed view by the touch sensitive display.

According to an embodiment of the third aspect of the invention, the method includes, while the UAV is moving transverse to the first view direction and along the stroke direction, the view being a blank view, and continuously displaying the blank view by the touch sensitive display.

A blank view can relate, for example, to a totally blackened or whitened view, not including any features of the environment.

The third aspect of the invention further relates to a computer program product comprising machine readable program code, which when executed by processing units related to a mobile control device having a touch sensitive display and/or a UAV, enables controlling the flight of a UAV including a camera system, according to the method of the third aspect of the invention.

According to a specific embodiment of the third aspect of the invention, the UAV of the method is a UAV according to the fifteenth aspect of the invention.

### SUMMARY OF A FOURTH ASPECT OF THE INVENTION

A fourth aspect of the invention relates to a computer implemented method for controlling the flight of a UAV in a physical environment, the method including, in particular in a hovering state of the UAV, the steps outlined in the following.

A step of continuously generating a view of the physical environment of the UAV based on image data from a camera system of the UAV.

The view relates to a representation of at least a part of the physical environment. The representation can be, for example, an image of at least a part of the physical environment, the image being based on image data from the camera system.

Continuously generating a view relates to steadily generating the view. Thereby, the view can be steadily/continuously generated at a given frequency/frame rate. The frequency can be variable. For example, the view can be generated 50 times per second, relating to generating 50 views per second. The view can be generated, for example, between 50 to 250 times per second, relating to generating 50 to 250 views per second.

A step of continuously displaying the view of the physical environment in a live-view by a touch sensitive display.

Displaying relates to presenting the view aiding a display device/display functionality such that the view is perceptible by, for example, a user of the UAV. For example, if the touch sensitive display is part of a mobile control device being a tablet pc with a touch sensitive display the view is displayed by displaying the view on the touch sensitive display. The touch sensitive display can be part of a tablet pc, a mobile phone, a smart watch, a laptop etc.

The touch sensitive display is further configured to receive touch inputs. The touch sensitive display can also be realized as part of an augmented reality (AR) and/or virtual reality (VR) system. Then the touch sensitive display is realized by a display functionality of the AR and/or VR system interacting with a touch sensitive controller, which is configured to receive touch inputs.

Continuously displaying the view is performed in analogy to continuously generating the view. Nevertheless, continuously displaying the view can be performed at a given frequency/frame rate. This given frequency/frame rate can be different to the frequency of continuously generating a view.

The live-view relates to displaying a view, which is typically based on most recent image data. It can relate to displaying the view at a predefined frequency/frame rate, wherein the view is generated at least at the predefined frequency/frame rate. Each generation of the view is typically based on most recent image data.

A step of receiving and identifying a “single tap” touch input with a tap point, indicative of moving the UAV in the physical environment by a rotational movement of the UAV around one of its principle axes, the principle axes relating to the UAV's yaw axis, roll axis and pitch axis.

A tap point relates to a point, where the touch input of the finger is received. The tap point can be for example the location on a touch sensitive display, where the finger touches the display while performing the “single tap” touch input.

A step of, based thereon, instructing the UAV to move.

Instructing the UAV to move relates to generating control commands based on the “single tap” touch input, in particular and on environment data, wherein these control commands are received by a control system of the UAV finally guiding the movement of the UAV. Thereby, environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV. Environment data can include image data from the camera system of the UAV.

A step of upon receiving the “single tap” touch input, determining a location of the tap point, and adapting the live-view by digitally rotating the view around at least one of the principle axes in order to centre the location of the tap point in the view.

Digitally rotating can relate, for example, to digitally rotating the view and continuously generating and displaying the digitally rotated view in the live-view. Thereby, it is still a live-view but from a digitally rotated view.

A step of determining a rotational motion pattern based on the location of the tap point.

A rotational motion pattern, can relate to, for example, control commands to be received by a control system of the UAV finally guiding the movement of the UAV according to the motion pattern. The motion pattern can, for example, determine a flight-velocity/rotation-velocity, acceleration, deceleration etc. based on which the UAV moves.

A step of instructing the UAV, based on the rotational motion pattern, to move by a rotational movement around at least one of the principle axes, in particular around the UAV's yaw axis, in order to centre the location of the tap point in the view.

According to an embodiment of the fourth aspect of the invention, the method includes, receiving the “single tap” touch input by the touch sensitive display, the touch sensitive display comprising a plurality of touch zones spread to the live-view, wherein determining the location of the tap point relates to identifying the touch zone where the “single tap” touch input is received.

The touch zones can be spread to the live-view, for example, in the form of a two dimensional touch zone-raster. The raster can include, for example, only rows, only columns, or rows and columns. Thereby, a touch zone can be, for example, line-shaped, rectangular-shaped, circular, oval etc.

According to an embodiment of the fourth aspect of the invention, the method includes, a touch zone having assigned thereto, predetermined rotational movement information for digitally rotating the view, and/or instructing the UAV to move by a rotational movement around at least one of the principle axes, in particular around the UAV's yaw axis, in order to centre the location of the tap point in the view.

Thereby, the predetermined rotational movement information can relate to a predetermined rotational motion pattern.

According to an embodiment of the fourth aspect of the invention, the method includes, the view of the physical environment being continuously displayed from a virtual camera position in a view direction assigned to the virtual camera position, the view being digitally rotated by digitally rotating the view direction with respect to the virtual camera position around at least one of the principle axes in order to centre the location of the tap point in the view, and the view of the physical environment being continuously displayed from the virtual camera position in a digitally rotated view direction.

According to an embodiment of the fourth aspect of the invention, the camera system includes a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, the method including, upon receiving the “single tap” touch input, determining, based on the location of the tap point, at least one of the plurality of cameras, based on the image data of which the view is continuously generated and displayed.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the fourth aspect of the invention, the method includes determining a rotational motion pattern based on the location of the tap point, and instructing the UAV, based on the rotational motion pattern, to move by a rotational movement around at least one of the principle axes, in particular around the UAV's yaw axis, in order to centre the location of the tap point in the view, while adapting the live-view by digitally rotating the view around at least one of the principle axes in order to centre the location of the tap point in the view.

According to an embodiment of the fourth aspect of the invention, the method includes instructing the UAV, based on the rotational motion pattern, to move by a rotational movement around at least one of the principle axes, in particular around the UAV's yaw axis, in order to centre the location of the tap point in the view, after adapting the live-view by digitally rotating the view around at least one of the principle axes in order to centre the location of the tap point in the view.

According to an embodiment of the fourth aspect of the invention, the method includes digitally rotating the view to a digitally rotated end-view having the location of the tap point centred in the view, and while the UAV is moving by a rotational movement around at least one of the principle axes, in particular around the UAV's yaw axis, digitally rotating the view from the digitally rotated end-view smoothly to a digitally un-rotated—with respect to, at least, the at least one of the principle axes—view, and continuously displaying the digitally un-rotated view of the physical environment in the live-view by the touch sensitive display.

Rotating smoothly can relate to rotate from one view to the other slowly but fluently, to create the impression of a smooth transition between the one view and the other view.

According to an embodiment of the fourth aspect of the invention, the method includes, while the UAV is moving by a rotational movement around at least one of the principle axes, in particular around the UAV's yaw axis, the view being a simulated view of the physical environment, and continuously displaying the simulated view by the touch sensitive display.

The simulated view is a view, which is continuously generated and displayed based on image data or environment data, which has been previously recorded.

According to an embodiment of the fourth aspect of the invention, the method includes, while the UAV is moving by a rotational movement around at least one of the principle axes, in particular around the UAV's yaw axis, the view being a freezed view of the physical environment, and continuously displaying the freezed view by the touch sensitive display.

According to an embodiment of the fourth aspect of the invention, the method includes, while the UAV is moving by a rotational movement around at least one of the principle axes, in particular around the UAV's yaw axis, the view being a blank view, and continuously displaying the blank view by the touch sensitive display.

A blank view can relate, for example, to a totally blackened or whitened view, not including any features of the environment.

According to an embodiment of the fourth aspect of the invention, the method includes, after a movement of the UAV by a rotational movement around at least one of the principle axes, in particular around the UAV's yaw axis, passing from the view to a digitally un-rotated—with respect to, at least, the at least one of the principle axes—view of the physical environment and continuously displaying the digitally un-rotated view in the live-view by the touch sensitive display.

The fourth aspect of the invention further relates to a computer program product comprising machine readable program code, which when executed by processing units related to a mobile control device having a touch sensitive display and/or a UAV enables controlling the flight of a UAV including a camera system, according to the method of the fourth aspect of the invention.

According to a specific embodiment of the fourth aspect of the invention, the UAV of the method is a UAV according to the fifteenth aspect of the invention.

### SUMMARY OF A FIFTH ASPECT OF THE INVENTION

A fifth aspect of the invention relates to a computer implemented method for controlling the flight of a UAV in a physical environment, the method including, in particular in a hovering state of the UAV, the steps outlined in the following.

A step of continuously generating a view of the physical environment of the UAV based on image data from a camera system of the UAV.

The view relates to a representation of at least a part of the physical environment. The representation can be, for example, an image of at least a part of the physical environment, the image being based on image data from the camera system.

Continuously generating a view relates to steadily generating the view. Thereby, the view can be steadily/continuously generated at a given frequency/frame rate. The frequency can be variable. For example, the view can be generated 50 times per second, relating to generating 50 views per second. The view can be generated, for example, between 50 to 250 times per second, relating to generating 50 to 250 views per second.

A step of continuously displaying the view of the physical environment in a live-view by a touch sensitive display.

Displaying relates to presenting the view aiding a display device/display functionality such that the view is perceptible by, for example, a user of the UAV. For example, if the touch sensitive display is part of a mobile control device being a tablet pc with a touch sensitive display the view is displayed by displaying the view on the touch sensitive display. The touch sensitive display can be part of a tablet pc, a mobile phone, a smart watch, a laptop etc.

The touch sensitive display is further configured to receive touch inputs. The touch sensitive display can also be realized as part of an augmented reality (AR) and/or virtual reality (VR) system. Then the touch sensitive display is realized by a display functionality of the AR and/or VR system interacting with a touch sensitive controller, which is configured to receive touch inputs.

Continuously displaying the view is performed in analogy to continuously generating the view. Nevertheless, continuously displaying the view can be performed at a given frequency/frame rate. This given frequency/frame rate can be different to the frequency of continuously generating a view.

The live-view relates to displaying a view, which is typically based on most recent image data. It can relate to displaying the view at a predefined frequency/frame rate, wherein the view is generated at least at the predefined frequency/frame rate. Each generation of the view is typically based on most recent image data.

A step of receiving and identifying a “one-finger stroke” touch input with a stroke progression, indicative of moving the UAV in the physical environment by a rotational movement of the UAV around one of its principle axes, the principle axes relating to the UAV's yaw axis, roll axis and pitch axis.

The “one-finger stroke” touch input is a touch input, which indicates a movement of the UAV. For example, the “one-finger stroke” touch input indicates a rotational movement of the UAV.

The “one-finger stroke” touch input relates to touching of the touch sensitive display, or touch sensitive controller, with one finger, wherein the finger strokes over the touch sensitive display, or touch sensitive controller without interrupting the touch/contact.

The stroke progression relates to the stroke movement, in particular to the movement of the one finger stroking from one location to another one.

A step of, based thereon, in particular based on receiving and identifying a “one-finger stroke” touch input, instructing the UAV to move.

Instructing the UAV to move relates to generating control commands based on the “one-finger stroke” touch input, in particular and on environment data, wherein these control commands are received by a control system of the UAV finally guiding the movement of the UAV. Thereby, environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV. Environment data can include image data from the camera system of the UAV.

A step of, while receiving the “one-finger stroke” touch input, determining the stroke progression, and adapting the live-view by digitally rotating the view around at least one of the principle axes and along a stroke direction based on the stroke progression.

Digitally rotating can relate, for example, to digitally rotating the view and continuously generating and displaying the digitally rotated view in the live-view. Thereby, it is still a live-view but from a digitally rotated view.

The stroke direction relates to a direction derived based on the stroke progression.

A step of deriving a stroke progression start state and a stroke progression end state.

A stroke progression can include a plurality of stroke progression start states and stroke progression end states adding up to the stroke progression.

A step of instructing the UAV to move by a rotational movement around at least one of the principle axes, in particular around the UAV's yaw axis, and along the stroke direction, based on the stroke progression start state and end state.

According to an embodiment of the fifth aspect of the invention, the method includes a step of determining a first location of the stroke progression start state, and a second location of the stroke progression end state, a step of determining the stroke direction based on the first location and the second location, and a step of instructing the UAV to move to move by a rotational movement around at least one of the principle axes, in particular around the UAV's yaw axis, and along the stroke direction, based on the first location and the second location.

According to an embodiment of the fifth aspect of the invention, the method includes a step of determining a distance between the first location and the second location, and a step of instructing the UAV to move transverse to the first view direction and along the stroke direction, based on the distance.

According to an embodiment of the fifth aspect of the invention, the method includes a step of determining a flight-velocity based on the distance, and instructing the UAV to move based on the flight-velocity.

According to an embodiment of the fifth aspect of the invention, the method includes the view of the physical environment being continuously displayed from a virtual camera position in a view direction assigned to the virtual camera position, the view being digitally rotated by digitally rotating the view direction with respect to the virtual camera position around at least one of the principle axes and along the stroke direction based on the stroke progression, and the view of the physical environment being continuously displayed from the virtual camera position in a digitally rotated view direction.

According to an embodiment of the fifth aspect of the invention, the camera system includes a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, the method including, while receiving the “one-finger stroke” touch input, determining, based on the stroke progression, at least one of the plurality of cameras, based on the image data of which the view is continuously generated and displayed.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the fifth aspect of the invention, the method includes deriving a stroke progression start state and a stroke progression end state, and instructing the UAV to move by a rotational movement around at least one of the principle axes, in particular around the UAV's yaw axis, and along the stroke direction, based on the stroke progression start state and end state, while receiving the “one-finger stroke” touch input.

While receiving the “one-finger stroke” touch input relates to the UAV being instructed to move starting from receiving the “one-finger stroke” touch input until the touch/contact is interrupted/the “one-finger stroke” touch input is completed.

According to an embodiment of the fifth aspect of the invention, the method includes instructing the UAV to move by a rotational movement around at least one of the principle axes, in particular around the UAV's yaw axis, and along the stroke direction, based on the stroke progression start state and end state, after the “one-finger stroke” touch input has been received.

According to an embodiment of the fifth aspect of the invention, the method includes a step of digitally rotating the view to a digitally rotated end-view in the stroke progression end state, and a step of, while the UAV is moving by a rotational movement around at least one of the principle axes, in particular around the UAV's yaw axis, and along the stroke direction, digitally rotating the view from the digitally rotated end view smoothly to a digitally un-rotated—with respect to, at least, the at least one of the principle axes—view, and continuously displaying the digitally un-rotated view of the physical environment in the live-view by the touch sensitive display.

Rotating smoothly can relate to rotate from one view to the other slowly but fluently, to create the impression of a smooth transition between the one view and the other view.

According to an embodiment of the fifth aspect of the invention, the method includes while the UAV is moving by a rotational movement around at least one of the principle axes, in particular around the UAV's yaw axis, and along the stroke direction, the view being a simulated view of the physical environment, and continuously displaying the simulated view by the touch sensitive display.

The simulated view is a view, which is continuously generated and displayed based on image data or environment data, which has been previously recorded.

According to an embodiment of the fifth aspect of the invention, the method includes while the UAV is moving by a rotational movement around at least one of the principle axes, in particular around the UAV's yaw axis, and along the stroke direction, the view being a freezed view of the physical environment, and continuously displaying the freezed view by the touch sensitive display.

According to an embodiment of the fifth aspect of the invention, the method includes while the UAV is moving by a rotational movement around at least one of the principle axes, in particular around the UAV's yaw axis, and along the stroke direction, the view being a blank view, and continuously displaying the blank view by the touch sensitive display.

A blank view can relate, for example, to a totally blackened or whitened view, not including any features of the environment.

According to an embodiment of the fifth aspect of the invention, the method includes after a rotational movement around at least one of the principle axes, in particular around the UAV's yaw axis, and along the stroke direction, passing from the view to a digitally un-rotated—with respect to, at least, the at least one of the principle axes—view of the physical environment and continuously displaying the digitally un-rotated view in the live-view by the touch sensitive display.

The fifth aspect of the invention further relates to a computer program product comprising machine readable program code, which when executed by processing units related to a mobile control device having a touch sensitive display and/or a UAV, enables controlling the flight of a UAV including a camera system, according to the method of the fifth aspect of the invention.

According to a specific embodiment of the fifth aspect of the invention, the UAV of the method is a UAV according to the fifteenth aspect of the invention.

### SUMMARY OF A SIXTH ASPECT OF THE INVENTION

A sixth aspect of the invention relates to a computer implemented method for controlling the flight of a UAV in a physical environment, the method including, in particular in a hovering state of the UAV, the steps outlined in the following.

A step of continuously generating a view of the physical environment of the UAV based on image data from a camera system of the UAV.

The view relates to a representation of at least a part of the physical environment. The representation can be, for example, an image of at least a part of the physical environment, the image being based on image data from the camera system.

Continuously generating a view relates to steadily generating the view. Thereby, the view can be steadily/continuously generated at a given frequency/frame rate. The frequency can be variable. For example, the view can be generated 50 times per second, relating to generating 50 views per second. The view can be generated, for example, between 50 to 250 times per second, relating to generating 50 to 250 views per second.

A step of continuously displaying the view of the physical environment in a live-view by a touch sensitive display.

Displaying relates to presenting the view aiding a display device/display functionality such that the view is perceptible by, for example, a user of the UAV. For example, if the touch sensitive display is part of a mobile control device being a tablet pc with a touch sensitive display the view is displayed by displaying the view on the touch sensitive display. The touch sensitive display can be part of a tablet pc, a mobile phone, a smart watch, a laptop etc.

The touch sensitive display is further configured to receive touch inputs. The touch sensitive display can also be realized as part of an augmented reality (AR) and/or virtual reality (VR) system. Then the touch sensitive display is realized by a display functionality of the AR and/or VR system interacting with a touch sensitive controller, which is configured to receive touch inputs.

Continuously displaying the view is performed in analogy to continuously generating the view. Nevertheless, continuously displaying the view can be performed at a given frequency/frame rate. This given frequency/frame rate can be different to the frequency of continuously generating a view.

The live-view relates to displaying a view, which is typically based on most recent image data. It can relate to displaying the view at a predefined frequency/frame rate, wherein the view is generated at least at the predefined frequency/frame rate. Each generation of the view is typically based on most recent image data.

A step of receiving and identifying a “double tap” touch input with a tap point, indicative of moving the UAV in the physical environment.

A tap point relates to a point, where the touch input of the finger is received. The tap point can be for example the location on a touch sensitive display, where the finger touches the display while performing the “single tap” touch input.

A step of, based thereon, in particular based on receiving and identifying a “double tap” touch input, instructing the UAV to move.

Instructing the UAV to move relates to generating control commands based on the “double tap” touch input, in particular and on environment data, wherein these control commands are received by a control system of the UAV finally guiding the movement of the UAV. Thereby, environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV. Environment data can include image data from the camera system of the UAV.

A step of, upon receiving the “double tap” touch input, determining a location of the tap point and based thereon a tap direction, adapting the live-view by digitally rotating the view around at least one of the principle axes in order to centre the location of the tap point in the view, and/or digitally scaling the view to a predetermined scale-level.

The tap direction relates to a direction, which is associated with the tap point/the location of the tap point. The tap direction can be, for example, a direction, which is derivable by correlating the tap point/the location of the tap point with a reference point. The tap direction can be, for example, a direction, which is pre-assigned to a possible tap point candidate.

Digitally rotating can relate, for example, to digitally rotating the view and continuously generating and displaying the digitally rotated view in the live-view. Thereby, it is still a live-view but from a digitally rotated view.

Digitally scaling can relate, for example, to digitally scaling the view and continuously generating and displaying the digitally scaled view in the live-view. Thereby, it is still a live-view but from a digitally scaled view.

The predetermined scale-level can relate to a scale-level, which is related to, for example, a zoomed-in view or a zoomed-out view.

A step of determining a motion pattern based on the location of the tap point.

A motion pattern, can relate to, for example, control commands to be received by a control system of the UAV finally guiding the movement of the UAV according to the motion pattern. The motion pattern can, for example, determine a flight-velocity/rotation-velocity, acceleration, deceleration etc. based on which the UAV moves.

A step of instructing the UAV, based on the motion pattern, to move by a rotational movement around at least one of its principle axes, the principle axes relating to the UAV's yaw axis, roll axis and pitch axis, in order to centre the location of the tap point in the view, and at a predetermined amount along the tap direction.

A predetermined amount can relate to, for example, a distance of 10, 5 or 3 meters.

According to an embodiment of the sixth aspect of the invention, the method includes, receiving the “double tap” touch input by the touch sensitive display, the touch sensitive display comprising a plurality of touch zones spread to the live-view, wherein determining the location of the tap point relates to identifying the touch zone, where the “double tap” touch input is received.

The touch zones can be spread to the live-view in the form of, for example, a two dimensional touch zone-raster. The raster can include, for example, only rows, only columns, or rows and columns. Thereby, a touch zone can be, for example, line-shaped, rectangular-shaped, circular, oval etc.

According to an embodiment of the sixth aspect of the invention, the method includes, a touch zone having assigned thereto, predetermined movement information for digitally rotating, in particular and scaling, the view, and/or instructing the UAV to move by a rotational movement around at least one of the principle axes, in order to centre the location of the tap point in the view.

Thereby, the predetermined movement information can relate to a predetermined motion pattern.

A touch zone can have assigned thereto a predetermined tap direction.

According to an embodiment of the sixth aspect of the invention, the method includes the view of the physical environment being continuously displayed from a virtual camera position in a view direction assigned to the virtual camera position, the view being digitally rotated by digitally rotating the view direction with respect to the virtual camera position around at least one of the principle axes in order to centre the location of the tap point in the view, and the view of the physical environment being continuously displayed from the virtual camera position in a digitally rotated view direction.

According to an embodiment of the sixth aspect of the invention, the camera system includes a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, the method including, upon receiving the “double tap” touch input, determining, based on the location of the tap point, at least one of the plurality of cameras, based on the image data of which the view is continuously generated and displayed.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the sixth aspect of the invention, the method includes determining a motion pattern based on the location of the tap point, and instructing the UAV, based on the motion pattern, to move by a rotational movement around at least one of the principle axes in order to centre the location of the tap point in the view, and at predetermined amount along a tap direction being derived based on the location of the tap point, while adapting the live-view by digitally rotating the view around at least one of the principle axes in order to centre the location of the tap point in the view, and digitally scaling the view to a predetermined scale-level.

According to an embodiment of the sixth aspect of the invention, the method includes instructing the UAV, based on the motion pattern, to move by a rotational movement around at least one of the principle axes in order to centre the location of the tap point in the view, and at a predetermined amount along a tap direction being derived based on the location of the tap point, after adapting the live-view by digitally rotating the view around at least one of the principle axes in order to centre the location of the tap point in the view, and digitally scaling the view to a predetermined scale-level.

According to an embodiment of the sixth aspect of the invention, the method includes digitally rotating and scaling the view to a digitally rotated and scaled end-view having the location of the tap point centred in the view and being scaled to a predetermined scale-level, and while the UAV is moving by a rotational movement around at least one of the principle axes, and at a predetermined amount along a tap direction, digitally rotating the view from the digitally rotated and scaled end-view smoothly to a digitally un-rotated—with respect to, at least, the at least one of the principle axes—and un-scaled view, and continuously displaying the digitally un-rotated and un-scaled view of the physical environment in the live-view by the touch sensitive display.

Rotating smoothly can relate to rotate from one view to the other slowly but fluently, to create the impression of a smooth transition between the one view and the other view.

According to an embodiment of the sixth aspect of the invention, the method includes while the UAV is moving by a rotational movement around at least one of the principle axes, and at a predetermined amount along a tap direction, the view being a simulated view of the physical environment, and continuously displaying the simulated view by the touch sensitive display.

The simulated view is a view, which is continuously generated and displayed based on image data or environment data, which has been previously recorded.

According to an embodiment of the sixth aspect of the invention, the method includes while the UAV is moving by a rotational movement around at least one of the principle axes, and at a predetermined amount along a tap direction, the view being a freezed view of the physical environment, and continuously displaying the freezed view by the touch sensitive display.

According to an embodiment of the sixth aspect of the invention, the method includes while the UAV is moving by a rotational movement around at least one of the principle axes, and at a predetermined amount along a tap direction, the view being a blank view, and continuously displaying the blank view by the touch sensitive display.

A blank view can relate, for example, to a totally blackened or whitened view, not including any features of the environment.

According to an embodiment of the sixth aspect of the invention, the method includes after a movement of the UAV by a rotational movement around at least one of the principle axes, and at a predetermined amount along a tap direction, passing from the view to a digitally un-rotated—with respect to, at least, the at least one of the principle axes—and un-scaled view of the physical environment and continuously displaying the digitally un-rotated and un-scaled view in the live-view by the touch sensitive display.

According to an embodiment of the sixth aspect of the invention, the method includes receiving environment data from a sensor module of the UAV and amending the movement of the UAV along the tap direction based on the environment data.

Environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV.

For example, a sensor module can be a radar based distance measuring module. The sensing action then relates to sensing a distance to an object/object surface/a surface of the environment. The environment data then includes distance information for determining a distance to the object/object surface/surface of the environment.

As a further example, a sensor module can be a temperature measuring module. The sensing action then relates to sensing a temperature of the environment. The environment data then includes temperature information for determining a temperature of the environment.

As a further example, a sensor module can be a barometer module. The sensing action then relates to sensing air pressure of the environment. The environment data then includes pressure information for determining an air pressure of the environment.

As a further example, the sensor module can be a directional distance measuring module. The sensing action then relates to sensing a distance and direction to an object/object surface/a surface of the environment. The environment data then includes distance and direction information for determining a distance and direction to the object/object surface/surface of the environment. Based on such environment information a representation of the physical environment of the UAV can be generated, for example a 3D point cloud based representation.

The directional distance measuring module can, for example, be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

As a further example, the sensor module can be a camera system. The sensing action then relates to sensing light of the environment. The environment data then includes light information/image information, for example in the form of image data, for generating an image of the environment.

As a further example, the sensor module can be an inertial measurement unit (IMU). The sensing action then relates to sensing an angular rate and/or an acceleration. The environment data then includes angular rate information and/or acceleration information for determining, for example, an orientation and/or directional acceleration of the UAV in the environment.

As a further example, the sensor module can be a global navigation satellite system (GNSS) receiver. The sensing action then relates to sensing/receiving signals from GNSS satellites. The environment data then includes GNSS information, in the form of, for example, global position data, for determining a position of the UAV in a local, regional or global reference coordinate system.

According to an embodiment of the sixth aspect of the invention, the method includes the sensor module having a field of view, wherein amending the movement of the UAV is based on sensing by the sensor module an object within the field of view and along the tap direction.

An object is a physical object of and/or in the physical environment of the UAV. The object can be, for example, a building, a tower, a car, a human being, a tree etc. An object has a surface. The surface can be in different forms. For example, the surface can be flat, curved, kinked etc.

Sensing an object along the tap direction relates to sensing an object in the direction in which the UAV is moving.

According to an embodiment of the sixth aspect of the invention, the method includes the sensor module being a directional distance measuring module, measuring directional distances to objects within the field of view.

The sixth aspect of the invention further relates to a computer program product comprising machine readable program code, which when executed by processing units related to a mobile control device having a touch sensitive display and/or a UAV enables controlling the flight of a UAV including a camera system, according to the method of the sixth aspect of the invention.

According to a specific embodiment of the sixth aspect of the invention, the UAV of the method is a UAV according to the fifteenth aspect of the invention.

### SUMMARY OF A SEVENTH ASPECT OF THE INVENTION

A seventh aspect of the invention relates to a system for controlling the flight of a UAV in a physical environment, wherein the system includes a UAV having a camera system providing image data, the camera system including a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, and a computer program product according to any of the second, third, fourth, fifth, or sixth aspect of the invention.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the seventh aspect of the invention, the system further includes a mobile control device having a touch sensitive display.

According to a specific embodiment of the seventh aspect of the invention, the UAV is a UAV according to the fifteenth aspect of the invention.

According to a further specific embodiment of the seventh aspect of the invention, the system includes a system according to the eleventh aspect of the invention.

### SUMMARY OF AN EIGHTH ASPECT OF THE INVENTION

An eighth aspect of the invention relates to a computer implemented method for controlling the power supply of a battery powered UAV on flight in a physical environment, the method including the steps outlined in the following.

A step of providing battery charge level information of the battery powering the UAV.

Battery charge level information can relate to, for example, a measured battery voltage. Battery charge level information can relate to, for example, a measured battery current, wherein the battery current is measured while the battery is being discharged.

A step of determining a battery charge level based on the battery charge level information.

A battery charge level can relate to, for example, a percentage. The percentage can be, for example, 100%, 75%, 50%, 25%, 5%, 0%. The battery charge level can relate to one of fully charged, medium charged, low charged etc.

A step of displaying by a mobile control device having a touch sensitive display, a charge level notification based on the battery charge level.

The charge level notification typically makes a user of the UAV aware of the actual battery charge level. The charge level notification can be, for example, a visual and/or an acoustical notification.

A step of instructing the UAV to move to a location to replace the battery, based on the battery charge level.

Instructing the UAV to move relates to generating control commands based on the battery charge level, in particular and on environment data, wherein these control commands are received by a control system of the UAV finally guiding the movement of the UAV. Thereby, environment data can relate to any kind of data being generated based on a sensing action performed by a sensor module of the UAV.

Thereby the sensing action relates to sensing at least a part of the environment of the UAV. The environment data includes information for characterizing/determining/defining the environment of the UAV. Environment data can include image data from the camera system of the UAV.

A step of instructing the UAV to resume the flight.

A step of instructing the UAV to land a the location whereby the replacement of the battery within a predetermined time window is enabled, and, while the battery is being replaced within the predetermined time window, to switch between a battery powered and capacitor powered supply mode, and to selectively deactivate predetermined power consuming units of the UAV, such that an uninterrupted power supply is provided, while the battery is being replaced, in particular while switching between the battery powered and capacitor powered supply mode.

The predetermined time window can be, for example, 0.5, 1, 2, 3 etc. minutes. The predetermined time window can be a predefined time window and typically depends on the amount of time during which the UAV can be powered solely by capacitor power.

According to an embodiment of the eighth aspect of the invention, the battery powered UAV is powered by a single battery.

According to an embodiment of the eighth aspect of the invention, the method includes providing an operability of the UAV after replacement of the battery, wherein the operability of the UAV relates to at least one of resuming the flight and transmitting recorded flight data.

Transmitting recorded flight data can relate to transmitting recorded flight data to, for example, the mobile control device, a cloud based storage etc.

Resuming the flight can relate to autonomously move the UAV back to the location, where the UAV has been instructed to move to a location to replace the battery.

Providing an operability can relate to providing a selection for selecting to either resume the flight or transmit recorded flight data or to do both.

According to an embodiment of the eighth aspect of the invention, the location is one of a launch point from where the UAV has been launched and a location from where the UAV is controlled by the mobile control device.

According to an embodiment of the eighth aspect of the invention, the charge level notification is displayed in case the battery charge level is below a threshold value.

According to an embodiment of the eighth aspect of the invention, the UAV is instructed to move to the location in case the battery charge level is below a further threshold value, the further threshold value being equal to the threshold value or different from it.

For example, the charge level notification can be displayed in case the charge level is below 25% and the UAV is instructed to move to the location in case the battery charge level is below 5%.

According to an embodiment of the eighth aspect of the invention, the battery powered UAV having at least one sensor module, at least one camera and at least one propulsion unit, wherein the predetermined power consuming units relate to at least one of the sensor module, the at least one camera and the at least one propulsion unit.

According to an embodiment of the eighth aspect of the invention, the at least one sensor module being a directional distance measuring module.

The directional distance measuring module can, for example, be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

According to a specific embodiment of the eighth aspect of the invention, the UAV is a UAV according to the fifteenth aspect of the invention.

The eighth aspect of the invention further relates to a computer program product comprising machine readable program code, which when executed by processing units related to a mobile control device having a touch sensitive display and/or a UAV enables controlling the power supply of a battery powered UAV, according to the method of the eighth aspect of the invention.

The eighth aspect of the invention further relates to a system for controlling the power supply of a battery powered UAV on flight in a physical environment, the system including: a UAV having a UAV powering system supplying the UAV with power, including a capacitor, and a battery charge level information generator, wherein the powering system is configured to provide battery charge level information of the battery powering the UAV, a switchability between a battery powered and capacitor powered supply mode, and a selective deactivatability to selectively deactivate predetermined power consuming units of the UAV, and alternatively power the UAV both by battery power or by capacitor power, such that an uninterrupted power supply is provided, while the battery is being replaced, in particular while switching between the battery powered and capacitor powered supply mode, and a computer program product according to the eighth aspect of the invention.

A battery charge level information generator can be, for example, a setup measuring a battery voltage or a battery current, wherein the battery current is measured while the battery is being discharged.

A capacitor can include, for example, a plurality of capacitors.

According to a specific embodiment of the eighth aspect of the invention, the UAV is a UAV according to the fifteenth aspect of the invention.

### SUMMARY OF A NINTH ASPECT OF THE INVENTION

A ninth aspect of the invention relates to a UAV for flying in a physical environment including a body, a propulsion system including a first plurality of propulsion units mechanically coupled to the body and located to a left side of the body, and a second plurality of propulsion units mechanically coupled to the body and located to a right side of the body, a first protective frame, mechanically coupled to the body, and at least partly running curved around a portion of an outer edge of the first plurality of propulsion units, a second protective frame, mechanically coupled to the body, and at least partly running curved around a portion of an outer edge of the second plurality of propulsion units, and a UAV indicator light system, wherein the first protective frame forms a front left corner section and a rear left corner section, and the second protective frame forms a front right corner section and a rear right corner section, wherein the UAV indicator light system includes a first linear indicator for emitting light and running curved around a portion of an outer edge of one of the first plurality of propulsion units and along the first protective frame in the front left corner section, a second linear indicator for emitting light and running curved around a portion of an outer edge of a further one of the first plurality of propulsion units and along the first protective frame in the rear left corner section, a third linear indicator for emitting light and running curved around a portion of an outer edge of one of the second plurality of propulsion units and along the second protective frame in the front right corner section, and a fourth linear indicator for emitting light and running curved around a portion of an outer edge of a further one of the second plurality of propulsion units and along the second protective frame in the rear right corner section, wherein each linear indicator is arranged, with the UAV in a flying state, to emit light away from the UAV and towards ground into a confined emission sector, and enables a variable emission of light, such that an orientation-specific user perception of the UAV, and an indicating of a UAV-status to a user is enabled.

A propulsion unit can include, for example, a rotary wing and be configured to drive the rotary wing. The propulsion unit can be, for example, a propeller unit.

The first plurality of propulsion units can relate to, for example, two propulsion units. The second plurality of propulsion units can relate to, for example, further two propulsion units.

The protective frame typically serves the purpose of protecting at least the propulsion units at least partially from colliding with objects.

Running curved along a protective frame, can relate to, for example, being attached to or at least partly integrated into the protective frame.

Enabling a variable emission of light, relates to, for example, enabling an emission of light with variable light properties.

An orientation-specific user perception of the UAV, relates to a user being able to identify the orientation of the flying UAV aiding the UAV indicator light system.

According to an embodiment of the ninth aspect of the invention, the UAV has a fifth linear indicator for emitting light and running curved around an outer section of the body.

For example, if the body has a cylindrically shaped section, the fifth linear indicator can run curved around the cylindrically shaped section, in particular in a circumferential direction.

According to an embodiment of the ninth aspect of the invention, each protective frame is band-shaped and bulged in a first direction transverse to its running direction.

According to an embodiment of the ninth aspect of the invention, each linear indicator is at least partly integrated into the protective frame at a location being offset, in a second direction transverse to the protective frame's running direction and to the first direction, from a maximum bulging of the protective frame.

According to an embodiment of the ninth aspect of the invention, the first and the third linear indicator are configured to emit light with first light properties, and the second and the fourth linear indicator are configured to emit light with second light properties being different to the first light properties.

According to an embodiment of the ninth aspect of the invention, the light properties relate to at least one of color, brightness and mode of emission, the mode of emission relating either to a continuous emission mode or a pulsed emission mode.

According to an embodiment of the ninth aspect of the invention, a linear indicator comprises at least one light source, wherein the linear indicator is configured to linearly guide light, emitted by the at least one light source, curved around a portion of an outer edge of one of a plurality of propulsion units and along a protective frame in a corner section, or around an outer section of the body.

According to an embodiment of the ninth aspect of the invention, a linear indicator comprising a plurality of light sources, wherein the plurality of light sources is arranged to linearly run curved around a portion of an outer edge of one of a plurality of propulsion units and along a protective frame in a corner section, or around an outer section of the body.

According to an embodiment of the ninth aspect of the invention, the linear indicator comprising the plurality of light sources enables a variable emission of light by enabling the variable emission through at least one light source of the plurality of light sources.

According to an embodiment of the ninth aspect of the invention, the UAV includes a light control unit configured for controlling the variable emission of light and light properties of emitted light to enable an orientation-specific user perception of the UAV, and an indicating of a UAV-status to a user.

According to an embodiment of the ninth aspect of the invention, the light control unit is configured for controlling the variable emission of light and light properties of emitted light based on light control instructions received from a user.

According to a specific embodiment of the ninth aspect of the invention, the UAV is a UAV according to the fifteenth aspect of the invention.

The ninth aspect of the invention further relates to a computer implemented method for controlling the flight of a UAV, according to the ninth aspect of the invention, having an indicator light system with linear indicators for enabling a variable emission of light, and a light control unit configured for controlling the variable emission of light and light properties of emitted light, the method including determining a UAV-status based on sensor data generated by at least one sensor module of the UAV, wherein determining light control data based on the UAV-status and/or light control instructions received from a user, receiving, by the light control unit, the light control data, and based thereon controlling the variable emission of light and light properties of emitted light, for providing an orientation-specific user perception of the UAV, and indicating the UAV-status to a user.

For example, a sensor module can be a radar based distance measuring module. The sensing action then relates to sensing a distance to an object/object surface/a surface of the environment. The sensor data then includes distance information for determining a distance to the object/object surface/surface of the environment.

As a further example, a sensor module can be a temperature measuring module. The sensing action then relates to sensing a temperature of the environment. The sensor data then includes temperature information for determining a temperature of the environment.

As a further example, a sensor module can be a barometer module. The sensing action then relates to sensing air pressure of the environment. The sensor data then includes pressure information for determining an air pressure of the environment.

As a further example, the sensor module can be a directional distance measuring module. The sensing action then relates to sensing a distance and direction to an object/object surface/a surface of the environment. The sensor data then includes distance and direction information for determining a distance and direction to the object/object surface/surface of the environment. Based on such environment information a representation of the physical environment of the UAV can be generated, for example a 3D point cloud based representation.

The directional distance measuring module can for example be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

As a further example, the sensor module can be a camera system. The sensing action then relates to sensing light of the environment. The sensor data then includes light information/image information, for example in the form of image data, for generating an image of the environment.

As a further example, the sensor module can be an inertial measurement unit (IMU). The sensing action then relates to sensing an angular rate and/or an acceleration. The sensor data then includes angular rate information and/or acceleration information for determining, for example, an orientation and/or directional acceleration of the UAV.

As a further example, the sensor module can be a global navigation satellite system (GNSS) receiver. The sensing action then relates to sensing/receiving signals from GNSS satellites. The sensor data then includes GNSS information, in the form of, for example, global position data, for determining a position of the UAV in a local, regional or global reference coordinate system.

According to an embodiment of the ninth aspect of the invention, the UAV-status relates to at least one of a “low-battery” status, a “malfunction” status, a “proximity to obstacle” status, a “flight-mode” status, a “mission-state” status, and a “pairing-state” status.

A “low-battery” status typically indicates a status, where the battery of the UAV has a low charging level. A “malfunction” status typically indicates a malfunctioning of the UAV. A “proximity to obstacle” status typically indicates a status, where the UAV is proximate to an object/obstacle. A “flight-mode” status typically indicates a flight mode within which the UAV is flying. A flight mode can relate, for example, to a manual flight mode, to an autonomous flight mode, to a measuring flight mode etc. A “mission-state” status typically indicates a progress of a mission, for example a measurement task, which has to be accomplished by the UAV. A “pairing-state” typically indicates the status of establishing a communicative connection to the UAV.

The ninth aspect of the invention further relates to a computer program product comprising machine readable program code, which when executed by a UAV, according to the ninth aspect of the invention, having an indicator light system with linear indicators for enabling a variable emission of light, and a light control unit configured for controlling the variable emission of light and light properties of emitted light, enables controlling the flight of the UAV, according to the method of the ninth aspect of the invention.

The ninth aspect of the invention further relates to a system for controlling the flight of a UAV in a physical environment, the system including a UAV, according to the ninth aspect of the invention, having an indicator light system with linear indicators for enabling a variable emission of light, and a light control unit configured for controlling the variable emission of light and light properties of emitted light, and a computer program product according to the ninth aspect of the invention.

### SUMMARY OF A TENTH ASPECT OF THE INVENTION

A tenth aspect of the invention relates to a computer implemented method for autonomously navigating a UAV in a physical environment, the method including the steps outlined in the following.

A step of continuously receiving, by an autonomous navigation control unit of the UAV, global navigation satellite system (GNSS) positioning signals from a GNSS receiver module of the UAV, environment data from at least one sensor module of the UAV, the environment data providing information on the spatial appearance of objects in the physical environment, and local navigation sensor signals from a local navigation sensor module of the UAV.

Continuously receiving signals and data relates to steadily receiving the signals and data. Thereby, the signals and data can be steadily/continuously received at a given frequency. The frequency can be variable. For example, the signals and data can be received 10, 20, 50, 100 etc. times per second.

GNSS positioning signals are received by the GNSS receiver module, wherein a GNSS positioning signal can be assigned to a GNSS satellite from which the GNSS positioning signal is received.

Environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV.

An object is a physical object of and/or in the physical environment of the UAV. The object can be, for example, a building, a tower, a car, a human being, a tree etc. An object has a surface. The surface can be in different forms. For example, the surface can be flat, curved, kinked etc.

The spatial appearance of objects can relate to, for example, the geometry of an object, including the geometry of the object surface.

For example, a sensor module can be a radar based distance measuring module. The sensing action then relates to sensing a distance to an object/object surface/a surface of the environment. The environment data then includes distance information for determining a distance to the object/object surface/surface of the environment.

As a further example, a sensor module can be a temperature measuring module. The sensing action then relates to sensing a temperature of the environment. The environment data then includes temperature information for determining a temperature of the environment.

As a further example, a sensor module can be a barometer module. The sensing action then relates to sensing air pressure of the environment. The environment data then includes pressure information for determining an air pressure of the environment.

As a further example, the sensor module can be a directional distance measuring module. The sensing action then relates to sensing a distance and direction to an object/object surface/a surface of the environment. The environment data then includes distance and direction information for determining a distance and direction to the object/object surface/surface of the environment. Based on such environment information a representation of the physical environment of the UAV can be generated, for example a 3D point cloud based representation.

The directional distance measuring module can, for example, be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

As a further example, the sensor module can be a camera system. The sensing action then relates to sensing light of the environment. The environment data then includes light information/image information, for example in the form of image data, for generating an image of the environment.

As a further example, the sensor module can be an inertial measurement unit (IMU). The sensing action then relates to sensing an angular rate and/or an acceleration. The environment data then includes angular rate information and/or acceleration information for determining, for example, an orientation and/or directional acceleration of the UAV in the environment.

As a further example, the sensor module can be a global navigation satellite system (GNSS) receiver. The sensing action then relates to sensing/receiving signals from GNSS satellites. The environment data then includes GNSS information, in the form of, for example, global position data, for determining a position of the UAV in a local, regional or global reference coordinate system.

A step of continuously determining, by the autonomous navigation control unit, based on the GNSS positioning signals having a weight, the environment data and the local navigation sensor signals the UAV's position, flight-velocity and orientation in relation to a reference coordinate system.

The weight of the GNSS positioning signals can relate, for example, to a weight-factor, wherein the weight-factor can range from, for example, 0 to 1, 0 to 2 etc.

A reference coordinate system can be, for example, a local, a regional or a global coordinate system, which can be used for geographical localization.

A step of, based thereon, in particular based on continuously receiving the data and signals and continuously determining position, velocity and orientation, autonomously navigating the UAV, by the autonomous navigation control unit, in the physical environment.

A step of adapting the weight of the GNSS positioning signals in determining the UAV's position, flight-velocity and orientation based on the environment data.

For example, the weight of the GNSS positioning signals can be adapted by decreasing or increasing the weight. As another example, the weight of the GNSS positioning signals can be adapted by decreasing the weight to zero, meaning the GNSS positioning signals are not included in determining the UAV's position, flight-velocity and orientation.

According to an embodiment of the tenth aspect of the invention, the method includes disregarding GNSS positioning signals of a selected GNSS satellite in determining the UAV's position, flight-velocity and orientation, wherein the GNSS satellite is selected based on the environment data.

Disregarding can relate, for example, to adapting the weight of a GNSS positioning signal to zero.

According to an embodiment of the tenth aspect of the invention, the method includes disregarding all GNSS positioning signals in determining the UAV's position, flight-velocity and orientation, based on the environment data.

According to an embodiment of the tenth aspect of the invention, the environment data includes directional distance information relating to measured distances and directions to an object in the physical environment, and the method including determining a geometric appearance of the object, wherein adapting the weight and/or disregarding GNSS positioning signals is based on the geometric appearance of the object.

Thereby, distances and directions to an object typically relate to distances and directions to points of the object surfaces. Measuring distances and directions to object surfaces can relate to measuring a horizontal angle, a vertical angle and a distance to the object surface and/or a point of the object surface.

According to an embodiment of the tenth aspect of the invention, the environment data is received from at least one of a directional distance measuring module and a radar based distance measuring module.

The directional distance measuring module can, for example, be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

The lidar principle relates to measuring a distance based on the time of flight of a distance measurement radiation pulse hitting an object surface and being reflected to be detected by the directional distance measuring module.

For example, a radar based distance measuring module can include a radar sensor. The sensing action then relates to sensing a distance to an object/object surface/a surface of the environment. The environment data then includes distance information for determining a distance to the object/object surface/surface of the environment.

According to an embodiment of the tenth aspect of the invention, the local navigation sensor module includes at least one of an inertial measurement unit (IMU), a barometer, a magnetometer, and a visual inertial system (VIS), wherein the local navigation sensor signals relate to IMU-signals, barometer-signals, magnetometer-signals and VIS-signals.

The VIS is using image data of a camera system of the UAV to derive motion data related to the movement/motion of the UAV based on tracking predetermined features in the image data.

According to a specific embodiment of the tenth aspect of the invention, the UAV is a UAV according to the fifteenth aspect of the invention.

The tenth aspect of the invention further relates to a computer program product comprising machine readable program code, which when executed by processing units related to a UAV having an autonomous navigation control unit, a GNSS receiver module, a sensor module and a local navigation sensor module, enables autonomously navigating the UAV in a physical environment according to the method of the tenth aspect of the invention.

The tenth aspect of the invention further relates to a system for autonomously navigating in a physical environment, the system including a UAV with a GNSS receiver module for receiving GNSS positioning signals, at least one sensor module generating environment data, a local navigation sensor module generating local navigation sensor signals, and an autonomous navigation control unit, communicatively connected to the GNSS receiver module, the at least one sensor module and the local navigation sensor module, and being configured to continuously receive GNSS positioning signals, environment data, and local navigation sensor signals, and based thereon, autonomously navigate the UAV, and a computer program product according to the tenth aspect of the invention.

According to a specific embodiment of the tenth aspect of the invention, the UAV is a UAV according to the fifteenth aspect of the invention.

### SUMMARY OF AN ELEVENTH ASPECT OF THE INVENTION

An eleventh aspect of the invention relates to a computer implemented method for providing a live-view of a UAV's physical environment, the method including the steps outlined in the following.

A step of continuously generating a view of the physical environment of the UAV based on image data from a camera system of the UAV, the camera system including a plurality of cameras arranged peripherally at the UAV, the cameras having a field of view with a fixed orientation in relation to the UAV and directed away from the UAV, and the camera system providing available image data of the plurality of cameras for generating an all-round view to the physical environment.

The view relates to a representation of at least a part of the physical environment. The representation can be for example an image of at least a part of the physical environment, the image being based on image data from the camera system.

Continuously generating a view relates to steadily generating the view. Thereby, the view can be steadily/continuously generated at a given frequency/frame rate. The frequency can be variable. For example, the view can be generated 50 times per second, relating to generating 50 views per second. The view can be generated, for example, between 50 to 250 times per second, relating to generating 50 to 250 views per second.

The cameras having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

A step of continuously displaying the view of the physical environment in a live-view by a touch sensitive display.

Displaying relates to presenting the view aiding a display device/display functionality such that the view is perceptible by, for example, a user of the UAV. For example, if the touch sensitive display is part of a mobile control device being a tablet pc with a touch sensitive display the view is displayed by displaying the view on the touch sensitive display. The touch sensitive display can be part of a tablet pc, a mobile phone, a smart watch, a laptop etc.

The touch sensitive display is further configured to receive touch inputs. The touch sensitive display can also be realized as part of an augmented reality (AR) and/or virtual reality (VR) system. Then the touch sensitive display is realized by a display functionality of the AR and/or VR system interacting with a touch sensitive controller, which is configured to receive touch inputs.

The touch sensitive display can be, for example, part of a tablet pc, a mobile phone, a smart watch, a laptop etc.

Continuously displaying the view is performed in analogy to continuously generating the view. Nevertheless, continuously displaying the view can be performed at a given frequency/frame rate. This given frequency/frame rate can be different to the frequency of continuously generating a view.

The live-view relates to displaying a view, which is typically based on most recent image data. It can relate to displaying the view at a predefined frequency/frame rate, wherein the view is generated at least at the predefined frequency/frame rate. Each generation of the view is typically based on most recent image data.

A step of receiving and identifying a touch input, indicative of a desired viewing direction in which the view of the physical environment is to be generated.

The touch input is a touch input, which indicates a desired viewing direction in which to generate and display a view of the physical environment.

The touch input can relate to, for example, a “two-finger pinch” touch input, a “stroke” based touch input, a “two-finger stroke” touch input a “one-finger stroke” touch input, a “single tap” touch input, a “double tap” touch input etc.

The desired viewing direction is derivable based on the touch input.

A step of, based thereon, generating and displaying in the live-view a view of the physical environment in the desired viewing direction.

A step of selecting the image data from the available image data based on the desired viewing direction.

Thereby, the available image data is image data provided by the plurality of cameras. This available image data can be used for generating the all-round view to the physical environment. For generating a view in the desired viewing direction image data is selected, based on the desired viewing direction, from the available image data, wherein the selected image data can be image data, which is provided by more than one of the plurality of cameras.

A step of generating and displaying in the live-view the view of the physical environment in the desired viewing direction based on the selected image data.

According to an embodiment of the eleventh aspect of the invention, the method includes receiving the touch input by the touch sensitive display, the touch sensitive display comprising a plurality of touch zones spread to the live-view, wherein the desired viewing direction is determined based on identifying the touch zone, where the touch input is received, and a touch zone having assigned thereto, predetermined image data selection information based on which the image data is selected from the available image data.

The touch zones can be spread to the live-view, for example, in the form of a two dimensional touch zone-raster. The raster can include, for example, only rows, only columns, or rows and columns. Thereby, a touch zone can be, for example, line-shaped, rectangular-shaped, circular, oval etc.

According to an embodiment of the eleventh aspect of the invention, the method includes stitching the selected image data using an image stitching algorithm and based thereon generating and displaying in the live-view the view of the physical environment in the desired viewing direction.

For example, if the selected image data is image data, which is provided by more than one of the plurality of cameras the image data is stitched with the intention to provide seamless selected image data.

According to an embodiment of the eleventh aspect of the invention, the method includes correlating directional distance information, recorded by a directional distance measuring module of the UAV by measuring the physical environment, with the selected image data such that selected image data with depth information is generated, wherein the image stitching algorithm is stitching the selected image data based on the depth information.

The directional distance measuring module can for example be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

According to an embodiment of the eleventh aspect of the invention, the method includes correcting a parallax-offset between cameras of the camera system based on the depth information and, based thereon, generating and displaying in the live-view the view of the physical environment in the desired viewing direction.

According to an embodiment of the eleventh aspect of the invention, the method includes by selecting the image data from the available image data based on the desired viewing direction, and generating and displaying in the live-view the view of the physical environment in the desired viewing direction based on the selected image data, providing a virtual gimbal functionality, which enables to virtually gimbal the view, by the touch input, wherein virtually gimbal the view is decoupled from the movement of the UAV.

Virtually gimbal relates to providing a functionality, which is similar to the functionality provided by a camera with a mechanical gimbal, but not including a mechanical gimbal.

According to an embodiment of the eleventh aspect of the invention, the live-view in the method of any of the first, second, third, fourth, fifth and sixth aspects of the invention is provided according to the method of the eleventh aspect of the invention.

According to a specific embodiment of the eleventh aspect of the invention, the UAV is a UAV according to the fifteenth aspect of the invention.

The eleventh aspect of the invention further relates to a computer program product comprising machine readable program code, which when executed by processing units related to a mobile control device having a touch sensitive display and/or a UAV enables providing a live-view of a UAV's physical environment according to the method of the eleventh aspect of the invention.

The eleventh aspect of the invention further relates to a system for controlling the flight of a UAV in a physical environment, the system including a UAV having a camera system including a plurality of cameras arranged peripherally at the UAV, the cameras having a field of view with a fixed orientation in relation to the UAV and directed away from the UAV, and the camera system providing available image data of the plurality of cameras for generating an all-round view to the physical environment, and a computer program product according to the eleventh aspect of the invention.

According to an embodiment of the eleventh aspect of the invention, the UAV has a directional distance measuring module recording directional distance information by measuring the physical environment.

According to an embodiment of the eleventh aspect of the invention, the system further includes a mobile control device having a touch sensitive display.

The mobile control device can be for example a tablet pc, a mobile phone, a smart watch, a laptop with touchscreen etc. The mobile control device is further configured to receive touch inputs. The mobile control device can further be realized as part of an augmented reality (AR) and/or virtual reality (VR) system. Then the touch sensitive display is realized by the display functionality of the AR and/or VR system interacting with a touch sensitive controller, which is configured to receive touch inputs.

According to an embodiment of the eleventh aspect of the invention, the camera system including a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment, and the camera system provides available image data of the plurality of cameras for generating an all-round view to the physical environment.

### SUMMARY OF A TWELFTH ASPECT OF THE INVENTION

A twelfth aspect of the invention relates to a computer implemented method for conditioning sensor raw data generated by a multipurpose sensor system of a UAV flying in a physical environment, the method including the steps outlined in the following.

A step of generating sensor raw data by the multipurpose sensor system in the form of image data from a camera system of the UAV, motion data from an inertial measurement unit (IMU) of the UAV, measurement data, in particular 3D point data, from a directional distance measuring module of the UAV, in particular wherein the directional distance measuring module measures distances and directions to object surfaces based on the light detection and ranging (lidar) principle, and global position data from a global navigation satellite system (GNSS) receiver module of the UAV.

The multipurpose sensor system can include a plurality of sensor modules.

For example, a sensor module can be a radar based distance measuring module. The sensing action then relates to sensing a distance to an object/object surface/a surface of the environment. The sensor raw data then includes distance information for determining a distance to the object/object surface/surface of the environment.

As a further example, a sensor module can be a temperature measuring module. The sensing action then relates to sensing a temperature of the environment. The sensor raw data then includes temperature information for determining a temperature of the environment.

As a further example, a sensor module can be a barometer module. The sensing action then relates to sensing air pressure of the environment. The sensor raw data then includes pressure information for determining an air pressure of the environment.

As a further example, the sensor module can be a directional distance measuring module. The sensing action then relates to sensing a distance and direction to an object/object surface/a surface of the environment. The sensor raw data then includes distance and direction information for determining a distance and direction to the object/object surface/surface of the environment. Based on such environment information a representation of the physical environment of the UAV can be generated, for example a 3D point cloud based representation.

The directional distance measuring module can, for example, be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

Thereby, distances and directions to object surfaces typically relate to distances and directions to points of the object surfaces. Measuring distances and directions to object surfaces can relate to measuring a horizontal angle, a vertical angle and a distance to the object surface and/or a point of the object surface.

The lidar principle relates to measuring a distance based on the time of flight of a distance measurement radiation pulse hitting an object surface and being reflected to be detected by the directional distance measuring module.

As a further example, the sensor module can be a camera system. The sensing action then relates to sensing light of the environment. The sensor raw data then includes light information/image information, for example in the form of image data, for generating an image of the environment.

As a further example, the sensor module can be an inertial measurement unit (IMU). The sensing action then relates to sensing an angular rate and/or an acceleration. The sensor raw data then includes angular rate information and/or acceleration information for determining, for example, an orientation and/or directional acceleration of the UAV.

As a further example, the sensor module can be a global navigation satellite system (GNSS) receiver. The sensing action then relates to sensing/receiving signals from GNSS satellites. The sensor raw data then includes GNSS information, in the form of, for example, global position data, for determining a position of the UAV in a local, regional or global reference coordinate system.

A step of providing a flight control support functionality using support data for supporting the flight control, and a sensor data recording functionality for recording sensor data, which enable a generation of a representation of the physical environment of the UAV.

The representation of the physical environment of the UAV can relate to, for example, a point cloud based representation, an image data based representation or a combination of both. The representation can be generated based on the recorded sensor data, for example, in a post-processing step. Furthermore, the recorded sensor data can enable, for example, the generation and display of a view to the environment of the UAV, which view can be displayed in a live-view to a user of the UAV. Furthermore, the recorded sensor data can enable, for example, the reconstruction of a physical environment of the UAV for generating a surveyed/measured model of the physical environment.

Thereby, recorded sensor data enable the generation of a representation of the physical environment of the UAV, which can be, for example, perceived by a user while controlling the UAV, or, which can relate to a surveyed/measured model of the environment.

Supporting the flight of the UAV can relate to, for example, autonomously avoid collisions/obstacles, stabilize the flight of the UAV, etc.

A step of autonomously supporting, by the flight control support functionality, the control of the flight of the UAV.

A step of recording, by the sensor data recording functionality, sensor data, which enable the generation of a representation of the physical environment of the UAV.

A step of receiving the sensor raw data, by a sensor raw data conditioning unit of the UAV.

A step of conditioning, by the sensor raw data conditioning unit, the sensor raw data to generate the support data and the sensor data, wherein at least one of the image data, the motion data, the measurement data, and the global position data is used for both to generate the support data and the sensor data.

The sensor raw data conditioning unit, conditions the sensor raw data based on whether the data is used by the flight control support functionality or by the sensor data recording functionality. Furthermore, the sensor raw data conditioning unit, conditions the sensor raw data based on an intended use of either the support data or the sensor data.

Thereby sensor raw data serves a dual purpose, for example, image data, motion data, measurement data and global position data, can be used for generating support data as well as for generating sensor data. Depending on whether the image data, motion data, measurement data and global position data, is used for generating support data or for generating sensor data, the data is specifically conditioned.

According to an embodiment of the twelfth aspect of the invention, the flight control support functionality includes a visual inertial system (VIS), the visual inertial system using support data in the form of conditioned image data to derive motion data related to the movement/motion of the UAV based on tracking predetermined features in the image data.

According to an embodiment of the twelfth aspect of the invention, conditioning includes conditioning the image data based on a criterion relating to using the image data by the VIS.

The criterion is a criterion, which has to be met in order that the image data/conditioned image data can efficiently be used by the VIS. The criterion can relate to, for example, the resolution of the image data, the brightness of the image data, the color information of the image data, the frequency with which the image data is provided to the VIS, etc.

According to an embodiment of the twelfth aspect of the invention, the sensor data enable a generation and display of a view of the physical environment of the UAV to a user, and the generation and display is based on sensor data in the form of conditioned image data.

According to an embodiment of the twelfth aspect of the invention, conditioning includes conditioning the image data based on a criterion relating to generating sensor data based on the image data to enable a generation and display of a view of the physical environment of the UAV to a user.

The criterion is a criterion, which has to be met in order that the image data/conditioned image data can efficiently be used to generate and display a view of the physical environment of the UAV to a user. The criterion can relate to, for example, the resolution of the image data, the brightness of the image data, the color information of the image data, the frequency with which the image data is provided to the sensor data recording functionality, etc.

According to an embodiment of the twelfth aspect of the invention, the flight control support functionality includes a collision/obstacle avoidance functionality, the collision avoidance functionality using support data in the form of conditioned measurement data to detect obstacles in the physical environment and avoid the obstacles.

According to an embodiment of the twelfth aspect of the invention, conditioning includes conditioning the measurement data based on a criterion relating to using the measurement data by the collision/obstacle avoidance functionality.

The criterion is a criterion, which has to be met in order that the measurement data/conditioned measurement data can efficiently be used by the collision/obstacle avoidance functionality. The criterion can relate to, for example, the resolution of the measurement data, the frequency with which the measurement data is provided to the collision/obstacle avoidance functionality, etc.

According to an embodiment of the twelfth aspect of the invention, the sensor data enable the generation and display of a view of the physical environment of the UAV to a user, and the generation and display is based on sensor data in the form of conditioned measurement data.

According to an embodiment of the twelfth aspect of the invention, the conditioned measurement data is used for supporting a stitching of conditioned image data.

According to an embodiment of the twelfth aspect of the invention, conditioning includes conditioning the measurement data based on a criterion relating to generating sensor data based on the measurement data to enable the generation and display of a view of the physical environment of the UAV to a user.

The criterion is a criterion, which has to be met in order that the measurement data/conditioned measurement data can efficiently be used to generate and display a view of the physical environment of the UAV to a user. The criterion can relate to, for example, the resolution of the measurement data, the frequency with which the measurement data is provided to the sensor data recording functionality, etc.

According to an embodiment of the twelfth aspect of the invention, the sensor data enable a display of the representation of the physical environment of the UAV to a user, and the display is based on sensor data in the form of conditioned measurement data.

According to an embodiment of the twelfth aspect of the invention, the conditioned measurement data includes 3D point data.

According to an embodiment of the twelfth aspect of the invention, conditioning includes conditioning the measurement data based on a criterion relating to generating sensor data based on the measurement data to enable a display of the representation of the physical environment of the UAV to a user, in particular in form of a 3D point cloud.

The criterion is a criterion, which has to be met in order that the measurement data/conditioned measurement data can efficiently be used to display a representation of the physical environment of the UAV to a user, in particular in form of a 3D point cloud. The criterion can relate to, for example, the resolution of the measurement data.

According to an embodiment of the twelfth aspect of the invention, the flight control support functionality uses support data in the form of conditioned global position data for controlling the flight of the UAV in the physical environment.

According to an embodiment of the twelfth aspect of the invention, conditioning includes conditioning the global position data based on a criterion relating to using the global position data by the flight control support functionality.

The criterion is a criterion, which has to be met in order that the global position data/conditioned global position data can efficiently be used for controlling the flight of the UAV in the physical environment. The criterion can relate to, for example, the resolution of the global position data, the frequency with which the global position data is provided to the flight control support functionality, etc.

According to an embodiment of the twelfth aspect of the invention, the sensor data enable a display of the representation of the physical environment of the UAV to a user, and the display is based on sensor data in the form of conditioned global position data by using the conditioned global position data to assign a global position to the representation.

According to an embodiment of the twelfth aspect of the invention, conditioning includes conditioning the global position data based on a criterion relating to generating sensor data based on the global position data to enable a display of the representation of the physical environment of the UAV to a user with the representation having assigned thereto a global position.

The criterion is a criterion, which has to be met in order that the global position data/conditioned global position data can efficiently be used to display a representation of the physical environment of the UAV to a user with the representation having assigned thereto a global position. The criterion can relate to, for example, the resolution of the global position data, the frequency with which the global position data is provided to the sensor data recording functionality, etc.

According to an embodiment of the twelfth aspect of the invention, the support data and the sensor data each include a combination of at least two of image data, motion data, measurement data, and global position data.

According to an embodiment of the twelfth aspect of the invention, the sensor raw data are generated at a predefined maximum rate and at a predefined maximum resolution, wherein conditioning the sensor raw data includes providing the sensor raw data at a predefined resolution and/or at a predefined rate based on a criterion relating to generating support data and/or sensor data from the sensor raw data.

According to a specific embodiment of the twelfth aspect of the invention, the UAV is a UAV according to the fifteenth aspect of the invention.

The twelfth aspect of the invention further relates to a computer program product comprising machine readable program code, which when executed by processing units related to a mobile control device having a touch sensitive display and/or a UAV enables conditioning of sensor raw data according to the method of the twelfth aspect of the invention.

### SUMMARY OF A THIRTEENTH ASPECT OF THE INVENTION

A thirteenth aspect of the invention relates to a computer implemented method for tracking the position and orientation of a UAV in a physical environment, the method including the steps outlined in the following.

A step of receiving sensor data from a multipurpose sensor system of the UAV being configured to generate sensor data in the form of image data from a camera system of the UAV motion data from an inertial measurement unit (IMU) of the UAV, measurement data, in particular 3D point data, from a directional distance measuring module of the UAV, in particular wherein the directional distance measuring module measures distances and directions to object surfaces based on the light detection and ranging (lidar) principle, and global position data from a global navigation satellite system (GNSS) receiver module of the UAV.

The multipurpose sensor system can include a plurality of sensor modules.

For example, a sensor module can be a radar based distance measuring module. The sensing action then relates to sensing a distance to an object/object surface/a surface of the environment. The sensor data then includes distance information for determining a distance to the object/object surface/surface of the environment.

As a further example, a sensor module can be a temperature measuring module. The sensing action then relates to sensing a temperature of the environment. The sensor data then includes temperature information for determining a temperature of the environment.

As a further example, a sensor module can be a barometer module. The sensing action then relates to sensing air pressure of the environment. The sensor data then includes pressure information for determining an air pressure of the environment.

As a further example, the sensor module can be a directional distance measuring module. The sensing action then relates to sensing a distance and direction to an object/object surface/a surface of the environment. The sensor data then includes distance and direction information for determining a distance and direction to the object/object surface/surface of the environment. Based on such environment information a representation of the physical environment of the UAV can be generated, for example a 3D point cloud based representation.

The directional distance measuring module can for example be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

Thereby, distances and directions to object surfaces typically relate to distances and directions to points of the object surfaces. Measuring distances and directions to object surfaces can relate to measuring a horizontal angle, a vertical angle and a distance to the object surface and/or a point of the object surface. The lidar principle relates to measuring a distance based on the time of flight of a distance measurement radiation pulse hitting an object surface and being reflected to be detected by the directional distance measuring module.

As a further example, the sensor module can be a camera system. The sensing action then relates to sensing light of the environment. The sensor data then includes light information/image information, for example in the form of image data, for generating an image of the environment.

As a further example, the sensor module can be an inertial measurement unit (IMU). The sensing action then relates to sensing an angular rate and/or an acceleration. The sensor data then includes angular rate information and/or acceleration information for determining, for example, an orientation and/or directional acceleration of the UAV.

As a further example, the sensor module can be a global navigation satellite system (GNSS) receiver. The sensing action then relates to sensing/receiving signals from GNSS satellites. The sensor data then includes GNSS information, in the form of, for example, global position data, for determining a position of the UAV in a local, regional or global reference coordinate system.

A step of providing a referencing and tracking functionality using data based on at least one of image data, motion data, measurement data, and global position data, as input data for referencing and tracking the position and orientation of the UAV.

A step of tracking the position and orientation of the UAV in the physical environment.

A step of the referencing and tracking functionality referencing the position and orientation of the UAV to a reference coordinate system.

A reference coordinate system can be, for example, a local, a regional or a global coordinate system, which can be used for geographical localization.

A step of the referencing and tracking functionality, in a first mode and while the UAV is flying, tracking the UAV in the reference coordinate system, using data based on at least one of image data, motion data, measurement data, global position data, as input data.

A step of the referencing and tracking functionality, in a second mode and while the UAV is propulsion-free, tracking the UAV in the reference coordinate system using data based on motion data as input data.

The method allows, for example, to track the UAV in the first mode, while the UAV is flying, based on using specific data as input data, wherein the specific data is selected based on a predetermined criterion. The predetermined criterion can relate to, for example, a tracking precision. The method further allows, to track the UAV in the second mode, while the UAV is propulsion-free/not flying, based on using specific data as input data, wherein the specific data is selected based on a further predetermined criterion. The further predetermined criterion can relate to, for example, a data reliability of the data used as input data.

According to an embodiment of the thirteenth aspect of the invention, the method includes in the second mode and while the UAV is propulsion-free, tracking the UAV in the reference coordinate system using data based on at least one of image data, measurement data, and global position data as input data.

According to an embodiment of the thirteenth aspect of the invention, the second mode is triggered by a turning off of the propulsion units.

According to an embodiment of the thirteenth aspect of the invention, the multipurpose sensor system being configured to generate sensor data in the form of barometer data from a barometer of the UAV and magnetometer data from a magnetometer of the UAV.

According to an embodiment of the thirteenth aspect of the invention, the referencing and tracking functionality using data based on at least one of barometer data and magnetometer data.

According to an embodiment of the thirteenth aspect of the invention, the method includes in the second mode and while the UAV is propulsion-free, tracking the UAV in the reference coordinate system such that measurement data is generatable based on related tracking data, wherein the as generated measurement data fits into the measurement data generated while the UAV is flying.

According to an embodiment of the thirteenth aspect of the invention, the method includes generating a 3D point cloud based on the generated measurement data.

According to a specific embodiment of the thirteenth aspect of the invention, the UAV is a UAV according to the fifteenth aspect of the invention.

The thirteenth aspect of the invention further relates to a computer program product comprising machine readable program code, which when executed by processing units related to a mobile control device and/or a UAV enables tracking the position and orientation of a UAV according to the method of the thirteenth aspect of the invention.

### SUMMARY OF A FOURTEENTH ASPECT OF THE INVENTION

A fourteenth aspect of the invention relates to a system for managing a set of UAV-batteries used for powering a UAV, the system includes a mobile battery charger unit designed for receiving at least one UAV-battery, and having a transceiver unit configured for communicatively connecting to a battery management terminal, and transceiving battery management data related to a UAV-battery, and a battery management terminal having a display functionality, wherein the battery management terminal is configured to communicatively connect alternatively as well to the mobile battery charger unit, the UAV, and the mobile battery charger unit and the UAV, receive battery management data from the mobile battery charger unit and the UAV, synchronize the battery management data, determine a charge state of the UAV-batteries battery based on the battery management data, and display the determined charge state.

Transceiving relates to the action of transmitting and receiving.

Communicatively connecting relates to establishing a communicative connection for transmitting and receiving (transceiving) data.

The communicative connection can be provided based on using any of the established technologies enabling a wireless communicative connection. The communicative connection can be provided based on using for example Wi-Fi/WLAN standards, Bluetooth standards, LTE standards, satellite communication standards, radio standards, NFC standards, infrared standards etc. Furthermore, the communicative connection can be provided based on using one or a plurality of the established technologies enabling a wireless communicative connection. In case more than one of the established technologies is used, the usage of one of the technologies can be based on a criterion relating to, for example, the availability of needed infrastructure/signal strength for establishing the communicative connection or a distance between the battery management terminal and the mobile battery charger unit and/or the UAV.

The battery management terminal can be, for example, a software providing a graphical user interface. The software and/or the graphical user interface can be realized as web-application, as application (app) for a mobile device, in particular a mobile control device.

The mobile device, in particular the mobile control device, can be for example a tablet pc, a mobile phone, a smart watch, a laptop with touchscreen etc. The mobile device, in particular the mobile control device, can further be configured to receive touch inputs. The mobile device, in particular the mobile control device, can further be realized as part of an augmented reality (AR) and/or virtual reality (VR) system.

Synchronize can relate to using the battery management data to generate a most recent charge state of the UAV-battery.

A battery charge state can relate to, for example, a percentage. The percentage can be, for example, 100%, 75%, 50%, 25%, 5%, 0%. The battery charge state can relate to one of fully charged, medium charged, low charged etc.

According to an embodiment of the fourteenth aspect of the invention, the battery management terminal is configured to estimate a charge state of the UAV-battery at a defined point in time, based on the battery management data, and display the estimated charge state.

A defined point in time can be, for example, a point in time in the future. Thereby, an estimated charge state of the UAV-battery, at a point in time in the future, can be displayed.

According to an embodiment of the fourteenth aspect of the invention, the battery management terminal is configured to receive flight mission data from a flight mission planner module, and determine and/or estimate a charge state of the UAV-battery based on the flight mission data and the battery management data and/or the determined charge state and/or the estimated charge state.

A flight mission planner module can be a module of, for example, a flight mission planner software. The flight mission planner software can be used for planning flight missions. Planning flight missions can relate to defining a location, where a flight mission is taking place, determining the duration of a flight of the UAV, task to be performed by the UAV during the flight mission etc. Based thereon flight mission data can be generated, which characterizes a flight mission. Such flight mission data can then be used by the battery management terminal to determine and/or estimate a charge state of the UAV-battery.

According to an embodiment of the fourteenth aspect of the invention, the mobile battery charger unit has a control unit being configured for controlling charging and discharging of a UAV-battery, and the system includes the battery management terminal being configured to initiate charging and/or discharging based on the battery management data and/or determined charge state and/or estimated charge state

Thereby, it can be enabled, that a specific charge state of a UAV-battery can be provided at a given point in time. Furthermore, it can be enabled, that a UAV-battery is automatically maintained with the goal to prolong its service life.

According to an embodiment of the fourteenth aspect of the invention, the system includes a UAV, the UAV being configured to communicatively connect to the battery management terminal, and transmit battery management data to the battery management terminal, the battery management data being related to a UAV-battery on board the UAV.

According to a specific embodiment of the fourteenth aspect of the invention, the UAV is a UAV according to the fifteenth aspect of the invention.

The fourteenth aspect of the invention further relates to a computer implemented method for managing a set of UAV-batteries used for powering a UAV, the method including the steps outlined in the following.

A step of providing a battery management terminal.

A step of communicatively connecting the battery management terminal alternatively as well to a mobile battery charger unit, a UAV, and the mobile battery charger unit and the UAV.

A step of receiving battery management data from the mobile battery charger unit and the UAV.

A step of synchronizing battery management data of a UAV-battery.

A step of determining a charge state of the UAV-battery based on battery management data.

A step of displaying the determined charge state.

According to an embodiment of the fourteenth aspect of the invention, the method includes estimating a charge state of the UAV-battery at a defined point in time, based on the battery management data, and displaying the estimated charge state.

According to an embodiment of the fourteenth aspect of the invention, the method includes receiving flight mission data from a flight mission planner module, and determining and/or estimating a charge state of the UAV-battery based on the flight mission data and the battery management data and/or the determined charge state and/or the estimated charge state.

According to an embodiment of the fourteenth aspect of the invention, the method includes initiating charging and/or discharging of the UAV-battery based on the battery management data and/or determined charge state and/or estimated charge state.

According to a specific embodiment of the fourteenth aspect of the invention, the UAV is a UAV according to the fifteenth aspect of the invention.

The fourteenth aspect of the invention further relates to a computer program product comprising machine readable program code, which when executed by processing units related to a battery management terminal having a display functionality and/or UAV enables managing a set of UAV-batteries used for powering a UAV according to the method of the fourteenth aspect of the invention.

### SUMMARY OF A FIFTEENTH ASPECT OF THE INVENTION

A fifteenth aspect of the invention relates to a UAV for flying in a physical environment including a body extending along an axis from a front end to a back end and having a housing, a first mounting structure attached to the body and extending away from the body in a direction to a left side of the axis, a second mounting structure attached to the body and extending away from the body in a direction to a right side of the axis being an opposite direction to the direction to the left side, four propulsion units, in particular rotor assemblies, two of which are mounted to the first mounting structure and two of which are mounted to the second mounting structure, a directional distance measuring module including a measuring field of view with a main view direction, within which measuring field of view directions and distances to surfaces in the physical environment are measurable by directionally emitting distance measurement radiation into the field of view, a detector unit for detecting distance measurement radiation reflected from a surface, and a distance measurement radiation source, wherein the directional distance measuring module is integrated in the front end of the body inside the housing, and the distance measurement radiation is directionally emittable by the directional distance measuring module through the housing out of the front end of the body.

A propulsion unit can include, for example, a rotary wing and be configured to drive the rotary wing. The propulsion unit can be, for example, a propeller unit.

The directional distance measuring module can have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

A distance measurement radiation source can be, for example, a light radiation source, a laser radiation source etc.

The part of the housing, where the distance measurement radiation is emitted through can include different material than other parts of the housing. The part can include, for example a material which is transparent to the distance measurement radiation but, at least to a large extent, non-transparent to visible light.

According to an embodiment of the fifteenth aspect of the invention, the directional distance measuring module has a deflector unit deflecting distance measurement radiation from the distance measurement radiation source through the housing into the field of view.

For example, the deflector unit can be arranged such, that the distance measurement radiation, which is coming from the distance measurement radiation source along a first direction, is deflected into a second direction which is transverse, for example, orthogonal, to the first direction.

The deflector unit can include a mirror as optical element, which is deflecting the distance measurement radiation.

According to an embodiment of the fifteenth aspect of the invention, the deflector unit deflects distance measurement radiation, reflected from a surface through the housing, to the detector unit.

Thereby, the deflector unit deflects distance measurement radiation, which is coming from the distance measurement radiation source, into the field of view, and distance measurement radiation, which is reflected from surfaces of the environment towards the deflecting unit, towards the detector unit.

According to an embodiment of the fifteenth aspect of the invention, the deflector unit is mounted to rotate around a first rotation axis and a second rotation axis being transverse to the first rotation axis.

According to an embodiment of the fifteenth aspect of the invention, the first rotation axis is aligned, in particular parallel, to the axis along which the body extends.

According to an embodiment of the fifteenth aspect of the invention, the radiation source includes an array of single emitting radiation sources.

According to an embodiment of the fifteenth aspect of the invention, the radiation source is configured to emit by the single emitting radiation sources radiation combining into the distance measurement radiation according to the phased array principle.

According to an embodiment of the fifteenth aspect of the invention, the UAV includes at least one sensor module generating and/or providing environment data, and/or the directional distance measuring module is configured to provide directional distance information relating to measured distances and directions to an object in the physical environment.

Environment data can relate to any kind of data being generated based on a sensing action performed by a sensor module of the UAV. Thereby the sensing action relates to sensing at least a part of the environment of the UAV. The environment data includes information for characterizing/determining/defining the environment of the UAV.

For example, a sensor module can be a radar based distance measuring module. The sensing action then relates to sensing a distance to an object/object surface/a surface of the environment. The environment data then includes distance information for determining a distance to the object/object surface/surface of the environment.

As a further example, a sensor module can be a temperature measuring module. The sensing action then relates to sensing a temperature of the environment. The environment data then includes temperature information for determining a temperature of the environment.

As a further example, a sensor module can be a barometer module. The sensing action then relates to sensing air pressure of the environment. The environment data then includes pressure information for determining an air pressure of the environment.

As a further example, the sensor module can be a directional distance measuring module. The sensing action then relates to sensing a distance and direction to an object/object surface/a surface of the environment. The environment data then includes distance and direction information for determining a distance and direction to the object/object surface/surface of the environment. Based on such environment information a representation of the physical environment of the UAV can be generated, for example a 3D point cloud based representation.

The directional distance measuring module can for example be arranged in the front section of the UAV and have the task to sense/inspect/survey/digitize the physical environment of the UAV. The directional distance measuring module can be a light detection and ranging (lidar) module and enable the measurement of point information used to determine the location of a point in a coordinate system, for example 3D-point information, of points of the physical environment, by determining a distance and direction to the points. The distance measuring module can be, for example, a laser scanner module.

Thereby, distances and directions to object surfaces typically relate to distances and directions to points of the object surfaces. Measuring distances and directions to object surfaces can relate to measuring a horizontal angle, a vertical angle and a distance to the object surface and/or a point of the object surface. The lidar principle relates to measuring a distance based on the time of flight of a distance measurement radiation pulse hitting an object surface and being reflected to be detected by the directional distance measuring module.

As a further example, the sensor module can be a camera system. The sensing action then relates to sensing light of the environment. The environment data then includes light information/image information, for example in the form of image data, for generating an image of the environment.

As a further example, the sensor module can be an inertial measurement unit (IMU). The sensing action then relates to sensing an angular rate and/or an acceleration. The environment data then includes angular rate information and/or acceleration information for determining, for example, an orientation and/or directional acceleration of the UAV in the environment.

As a further example, the sensor module can be a global navigation satellite system (GNSS) receiver. The sensing action then relates to sensing/receiving signals from GNSS satellites. The environment data then includes GNSS information, in the form of, for example, global position data, for determining a position of the UAV in a local, regional or global reference coordinate system.

According to an embodiment of the fifteenth aspect of the invention, the directional distance measuring module measures distances and directions based on the light detection and ranging (lidar) principle.

According to an embodiment of the fifteenth aspect of the invention, the first mounting structure includes a mounting part to which the propulsion units, in particular the rotor assemblies, are mounted, a first protective frame at least partly running curved around a portion of an outer edge of the propulsion units, in particular of the rotor assemblies, is attached to the first mounting structure, the second mounting structure includes a mounting part to which the propulsion units, in particular the rotor assemblies, are mounted, and a second protective frame at least partly running curved around a portion of an outer edge of the propulsion units, in particular of the rotor assemblies, is attached to the second mounting structure.

The protective frame typically serves the purpose of protecting at least the propulsion units at least partially from colliding with objects.

According to an embodiment of the fifteenth aspect of the invention, the mounting parts include at least one strut element having a hollow interior, wherein the hollow interior forms a hidden cable routing from a propulsion unit to the body.

According to an embodiment of the fifteenth aspect of the invention, each of the propulsion units, in particular the rotor assemblies, is mounted to the mounting structure where three strut elements are connecting.

According to an embodiment of the fifteenth aspect of the invention, a protective frame includes a foamed core being surrounded by a fiber-reinforced shell.

According to an embodiment of the fifteenth aspect of the invention, at least one of the protective frames includes a therein integrated antenna, wherein the antenna is embedded between the foamed core and the fiber-reinforced shell.

According to an embodiment of the fifteenth aspect of the invention, at least one of the protective frames includes a therein integrated radar sensor, in particular wherein the radar sensor is joined with the fiber-reinforced shell.

According to an embodiment of the fifteenth aspect of the invention, a protective frame provides a hidden cable routing inside the protective frame by embedding a cable in the foamed core.

According to an embodiment of the fifteenth aspect of the invention, a mounting structure includes a shell forming an outer surface of the mounting structure, wherein the shell is formed as a monolithic part.

According to an embodiment of the fifteenth aspect of the invention, the shell is formed by a fiber reinforced polymer, in particular a carbon fiber reinforced polymer.

According to an embodiment of the fifteenth aspect of the invention, each of the mounting structures is attached to the body such that the mounting structure is rotatable around the axis along which the body extends, from a first snap-in position to a second position, in particular to a second snap-in position.

A snap-in position relates to a position where the mounting structures are lockable, such that a release torque needs to be applied to rotate the mounting structures from the first snap-in position to another position.

According to an embodiment of the fifteenth aspect of the invention, with the mounting structures in the first snap-in position, the first mounting structure is extending away from the body in a direction to the left side of the axis, the second mounting structure is extending away from the body in a direction to the right side of the axis being an opposite direction to the direction to the left side, and with the mounting structures in the second position, in particular second snap-in position, both mounting structures are extending away from the body in a same direction.

According to an embodiment of the fifteenth aspect of the invention, landing support structures are located at the mounting structures and/or the protective frames, and protruding from the mounting structures and/or protective frames in a direction transverse to a plane in which a mounting structure mainly extends, wherein the landing support structures are located such that with the mounting structures in the second position, the landing support structures intertwine.

The landing support structures are designed and located such, that the UAV is placeable on ground, meanwhile only the support structures are touching the ground and keep the other parts of the UAV distant from the ground.

Intertwine relates to a placement of the landing support structures such, that the mounting structures can be approached to each other without the landing support structures preventing an approaching of the mounting structures below a certain proximity. The certain proximity relating to, for example, once or twice the dimension of the landing support structure along its main extension direction.

According to an embodiment of the fifteenth aspect of the invention, the UAV includes a camera system.

According to an embodiment of the fifteenth aspect of the invention, the camera system includes a plurality of cameras arranged peripherally at the UAV, with each camera having a field of view with a fixed orientation in relation to the UAV and directed away from the UAV, one front camera facing forward, one top camera facing up, one bottom camera facing down, and at least one side camera facing sideways, wherein the cameras are arranged such that each field of view overlaps to a predefined degree at least one adjacent field of view, and the camera system provides an all-round view to the physical environment.

Each camera having a field of view with a fixed orientation in relation to the UAV relates to the cameras being arranged at the UAV such that for each camera its position at the UAV and its orientation relative to the UAV is not variable but fix and predefined.

The all-round view relates to a view to the physical environment, which covers, to a large extent, the view to the physical environment surrounding the UAV. The all-round view includes at least one side view, a forward view, an up view and a down view. The all-round view provided by the camera system does not rely on using a camera, which can be mechanically gimbaled.

According to an embodiment of the fifteenth aspect of the invention, the front camera is mounted to one of the mounting structures, and the at least one side camera is mounted to one of the mounting structures of the UAV.

According to an embodiment of the fifteenth aspect of the invention, at least one of the cameras is mounted at a mounting structure and a protective frame at a location where the protective frame is attached to the mounting structure.

According to an embodiment of the fifteenth aspect of the invention, the directional distance measuring module is configured to measure a distance and direction to an object surface of the physical environment of the UAV, and at least part of which is within at least one field of view of a camera.

According to an embodiment of the fifteenth aspect of the invention, the UAV includes a UAV powering system supplying the UAV with power, the UAV powering system being configured to provide battery charge level information of a battery powering the UAV, a switchability between a battery powered and capacitor powered supply mode, and a selective deactivatability to selectively deactivate predetermined power consuming units of the UAV, and alternatively power the UAV both by battery power or by capacitor power, such that an uninterrupted power supply is provided, while the battery is being replaced, in particular while switching between the battery powered and capacitor powered supply mode, and the UAV powering system including a capacitor for enabling to alternatively power the UAV both by battery power or by capacitor power, and a battery charge level information generator.

A battery charge level information generator can be, for example, a setup measuring a battery voltage or a battery current, wherein the battery current is measured while the battery is being discharged.

A capacitor can include, for example, a plurality of capacitors.

According to an embodiment of the fifteenth aspect of the invention, the UAV includes a UAV indicator light system, wherein the first protective frame forms a front left corner section and a rear left corner section, and the second protective frame forms a front right corner section and a rear right corner section, wherein the indicator light system includes a first linear indicator for emitting light and running curved around a portion of an outer edge of the propulsion units and along the first protective frame in the front left corner section, a second linear indicator for emitting light and running curved around a portion of an outer edge of the propulsion units and along the first protective frame in the rear left corner section, a third linear indicator for emitting light and running curved around a portion of an outer edge of the propulsion units and along the second protective frame in the front right corner section, and a fourth linear indicator for emitting light and running curved around a portion of an outer edge of the propulsion units and along the second protective frame in the rear right corner section, wherein each linear indicator is arranged, with the UAV in a flying state, to emit light away from the UAV and towards ground into a confined emission sector, and enables a variable emission of light, such that an orientation-specific user perception of the UAV, and an indicating of a UAV-status to a user is enabled.

Running curved along a protective frame, can relate to, for example, being attached to or at least partly integrated into the protective frame.

Enabling a variable emission of light, relates to, for example, enabling an emission of light with variable light properties.

An orientation-specific user perception of the UAV, relates to a user being able to identify the orientation of the flying UAV aiding the UAV indicator light system.

According to an embodiment of the fifteenth aspect of the invention, the UAV includes a GNSS receiver module for receiving GNSS positioning signals, a local navigation sensor module generating local navigation sensor signals, and an autonomous navigation control unit, communicatively connected to the GNSS receiver module, at least one sensor module and the local navigation sensor module, and being configured to continuously receive GNSS positioning signals, environment data, and local navigation sensor signals, and based thereon, autonomously navigate the UAV.

GNSS positioning signals are received by the GNSS receiver module, wherein a GNSS positioning signal can be assigned to a GNSS satellite from which the GNSS positioning signal is received.

The local navigation sensor module include, for example, at least one of an inertial measurement unit (IMU), a barometer, a magnetometer, and a visual inertial system (VIS), wherein the local navigation sensor signals relate to IMU-signals, barometer-signals, magnetometer-signals and VIS-signals.

The VIS is using image data of a camera system of the UAV to derive motion data related to the movement/motion of the UAV based on tracking predetermined features in the image data.

According to an embodiment of the fifteenth aspect of the invention, the camera system is configured to provide image data, and the directional distance measuring module is configured to provide directional distance information.

Directional distance information can include, for example, distance information relating to a distance to an object surface/a point of an object surface and/or direction information relating to a direction to an object surface/a point of an object surface.

According to an embodiment of the fifteenth aspect of the invention, the UAV includes a multipurpose sensor system including the camera system, an inertial measurement unit (IMU), and a GNSS receiver module, wherein the multipurpose sensor system is configured to generate sensor raw data in the form of image data from the camera system, motion data from the inertial measurement unit, measurement data, in particular 3D point data, from the directional distance measuring module of the UAV, in particular wherein the directional distance measuring module measures distances and directions to object surfaces based on the light detection and ranging (lidar) principle, and global position data from the GNSS receiver module of the UAV.

The multipurpose sensor system can include a plurality of sensor modules.

According to an embodiment of the fifteenth aspect of the invention, the UAV is configured to communicatively connect to a battery management terminal, and transmit battery management data related to a UAV-battery on board the UAV to the battery management terminal.

According to an embodiment of the fifteenth aspect of the invention, the UAV is configured to receive instructions related to performing a measurement task, autonomously fly, supported by an autonomous navigation control unit, in a physical environment based on the instructions, while autonomously flying scan and thereby measure the physical environment by the directional distance measuring module, generate measurement data in the form of 3D point data, view the physical environment by the camera system and generate image data, sense the physical environment by at least one sensor module and/or by a multipurpose sensor system of the UAV and generate sensor data, and provide measurement data, image data and sensor data for generating 3D point cloud data representing the physical environment of the UAV, and to the autonomous navigation control unit for supporting the autonomous flying of the UAV.

According to an embodiment of the fifteenth aspect of the invention, the UAV is a rotary wing drone.

As can be understood by a person skilled in the art, although the fifteen aspects of the invention each are implementable individually, they may relate to and can be realized in one common UAV. Hence, the aspects of the invention are working together where applicable, and can be realized accumulatively and in combination with each other, so that combinations of said aspects may constitute further aspects of the invention.

### BRIEF DESCRIPTION OF THE FIGURES OF THE INVENTION

The first to fifteenth aspects of the invention are described below in more detail purely by way of example with the aid of concrete exemplary embodiments of the first to fifteenth aspect of the invention illustrated schematically in the figures, further advantages of the first to fifteenth aspects of the invention also being examined. In detail:

FIG. 1 shows a mobile control device and a “stroke”-based touch input, and in a top view a UAV, an environment, and an object surface,

FIG. 2 shows a top view to an object surface and a movement of the UAV;

FIG. 3 relates to a “stroke”-based touch input;

FIG. 4 shows a top view to a UAV;

FIG. 5 shows a touch sensitive display and a “two-finger pinch” touch input and in a top view a UAV, an environment, and an object;

FIG. 6 shows a digitally scaled view in a live-view;

FIG. 7 shows an un-scaled view;

FIG. 8 shows a touch sensitive display and a “two-finger pinch” touch input and in a top view a UAV, an environment, and an object;

FIG. 9 shows a digitally scaled view in a live-view;

FIG. 10 shows an un-scaled view;

FIG. 11 relates to a “two-finger pinch” touch input;

FIG. 12 relates to a “two-finger stroke” touch input;

FIG. 13 shows in a top view a UAV, an environment and an object in the environment;

FIG. 14 shows a touch sensitive display and a “single tap” touch input and in a top view a UAV, an environment, and an object;

FIG. 15 shows a digitally rotated view in a live-view;

FIG. 16 shows a view after a rotational movement of a UAV;

FIG. 17 shows a UAV with its principle axes;

FIG. 18 shows a touch sensitive display including a plurality of touch zones;

FIG. 19 shows a touch sensitive display including a plurality of touch zones;

FIG. 20 shows a virtual camera position with view directions;

FIG. 21 shows a touch sensitive display receiving a “one-finger stroke” touch input;

FIG. 22 shows an adapted live-view;

FIG. 23 shows in a live-view, a view to the physical environment;

FIG. 24 relates to a “one-finger stroke” touch input;

FIG. 25 shows a virtual camera position with view directions;

FIG. 26 shows a touch sensitive display receiving a “double tap” touch input;

FIG. 27 shows an adapted live-view;

FIG. 28 shows a flying UAV with a mobile control device;

FIG. 29 shows a UAV flying in a physical environment;

FIG. 30 shows a UAV with an indicator light system;

FIG. 31 shows a cross section of a band-shaped protective frame;

FIG. 32 shows a linear indicator comprising a light source;

FIG. 33 shows a linear indicator comprising a plurality of light sources;

FIG. 34 shows a schematic of a workflow related to an autonomous navigation control unit;

FIG. 35 shows a top view to a UAV in a physical environment and different views, which can be generated and displayed in a live-view;

FIG. 36 shows a front view to a UAV in a physical environment and different views, which can be generated and displayed in a live-view

FIG. 37 shows a schematic of a workflow related to displaying a view in a live-view;

FIG. 38 shows a schematic of a workflow related to the raw data conditioning unit;

FIG. 39 shows a schematic of a workflow related to the tracking functionality;

FIG. 40 shows a situation with a UAV scanning a façade of a building and being referenced to a reference coordinate system;

FIG. 41 shows a situation with a UAV moving propulsion free around a corner of a building and being referenced to a reference coordinate system;

FIG. 42 shows a situation with a UAV scanning a façade of a building and being referenced to a reference coordinate system;

FIG. 43 shows a system for managing a set of UAV batteries;

FIG. 44 shows a UAV having a body, propulsion units and mounting structures;

FIG. 45 shows a schematic of a directional distance measuring module;

FIG. 46 shows a UAV with mounting structures having mounting parts with strut elements; and

FIG. 47 shows a UAV with rotatable mounting structures.

### DETAILED DESCRIPTION OF THE FIGURES ACCORDING TO THE FIRST ASPECT OF THE INVENTION

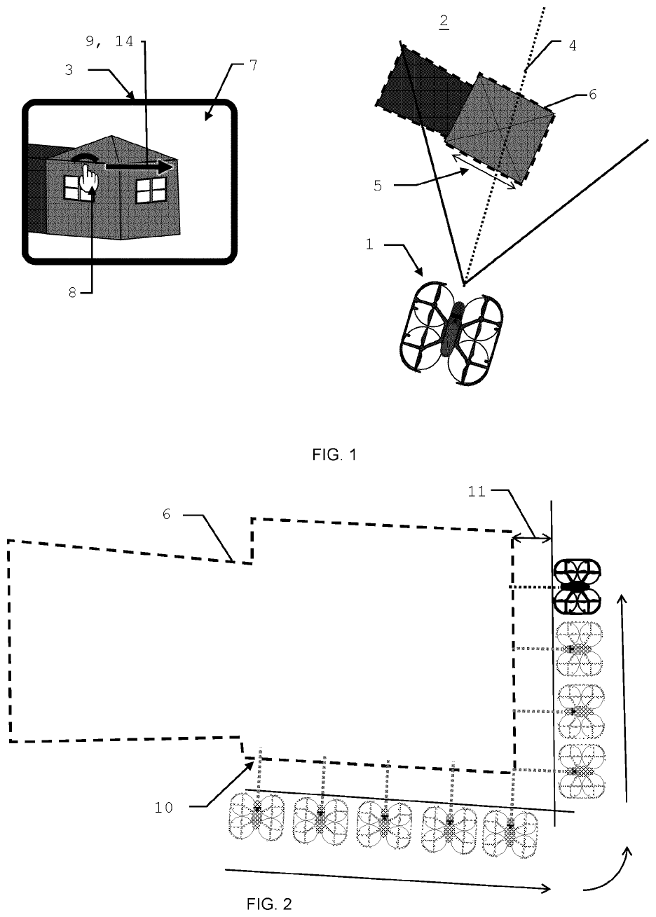

FIG. 1 shows on the left side a typical mobile control device 3 having a touch sensitive display. The touch sensitive display is configured to receive touch inputs, for example, “stroke” based touch inputs 8 and to display a view of the physical environment 2 in a live view 7. Thereby, the view of the physical environment 2 is generated based on environment data, which are received from at least one sensor module of the UAV 1. The sensor module typically relates to a camera of a camera system of the UAV 1.

The mobile control device 3 is configured to control the flight and operation of a UAV 1. Therefore, a communicative connection between the mobile control device and the UAV is established. Touch inputs, which are received by the touch sensitive display, are typically indicative of moving the UAV 1 in the physical environment 2.

The UAV 1 includes a directional distance measuring module as sensor module. The directional distance measuring module is configured to measure distances and directions to surfaces/points on surfaces of the physical environment 2. Directions can be measured, for example, by determining a horizontal and vertical angle under which a distance measurement radiation is emitted towards a surface/point on a surface of the physical environment 2. A distance can be measured, for example, based on the time-of-flight principle using the emitted distance measurement radiation.

Measuring surfaces/point of surfaces of the physical environment 2 enables measuring/surveying physical environments and objects in the physical environments. Physical environments 2 can relate, for example, to landscapes, acres, fields, forests, hillsides etc. Objects can relate, for example, to buildings, roads, bridges, humans, airplanes, objects of a construction site, tunnels etc.

Measuring/surveying physical environments 2 and objects in the physical environments relates to generating and recording measurement data, which enable a digital reconstruction of the measured/surveyed physical environment and/or objects. Such measurement data typically relate to 3D point cloud data, which enable the reconstruction in the form of a 3D point cloud.

The distance measuring module has a field of view, wherein physical environments 2 and objects, which are within the field of view, are measurable. The field of view has a main view direction 4. For a specific, for example optimized, measuring/surveying of physical environments 2 and objects, the field of view with its main view direction is aligned in a predefined way to the physical environment 2 or to an object, which is to be measured/surveyed. Thereby the alignment of the field of view of the distance measuring module is controlled by controlling the movement of the UAV 1.

FIG. 1 shows on the right side the UAV 1, which is flying in the physical environment 2. The UAV 1 is in front of a building with its distance measuring module facing the building. Thereby, the building is the object to be measured/surveyed. The façade of the building is the object surface 6. At least a part of the façade 5 is within the field of view of the distance measuring module. This at least a part of the façade 5 can be determined by measuring/surveying.

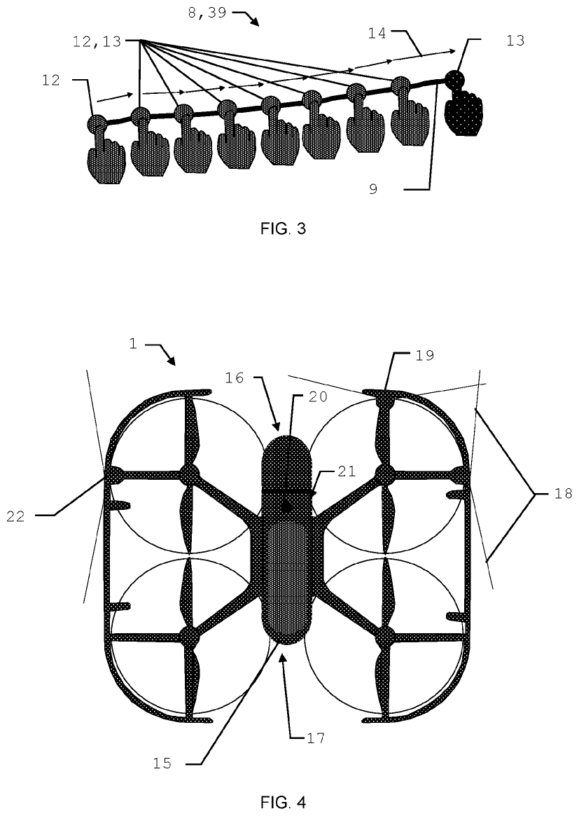

As shown in FIG. 2, if the touch sensitive display receives, within the constant distance mode/the constant distance mode being activated, a “stroke”-based touch input 8, the UAV 1 is positioning and orienting itself such, that the main view direction 4 of the distance measuring unit is aligned in a specific/predetermined way 10 with respect to the at least a part of the façade. Furthermore, the UAV 1 moves along the façade and maintains during moving a constant distance 11 to the façade and the specific/predetermined alignment with respect to the façade.

It can be provided that the UAV 1 is moving only as long as the “stroke”-based touch input 8 is being received. With other words, as soon as a touching, related to the “stroke”-based touch input 8, of the touch sensitive display is interrupted or terminated the UAV 1 is stopped.

FIG. 3 shows a “stroke”-based touch input 8. The touch sensitive display is touched by a finger, wherein—while maintaining touching the touch sensitive display with the finger—the finger is stroked across the touch sensitive display. Stroking across the touch sensitive display relates to generating the stroke progression 9.

The “stroke”-based touch input 8 can also relate to touching the touch sensitive display with two fingers in analogy to touching the touch sensitive display with one finger.

The movement of UAV 1 along the façade—while maintaining during moving a constant distance 11 to the façade and the specific/predetermined alignment with respect to the façade—is further based on the stroke progression 9. Based on the stroke progression 9 control commands can be derived for controlling the movement of the UAV 1. A control command can relate to, for example, a stroke direction 14, in which the UAV 1 moves along the façade, a velocity with which the UAV 1 moves along the façade etc.

The “stroke”-based touch input 8, shown in FIG. 3, includes a stroke progression start state 12 and a stroke progression end state 13. It can be provided that between the stroke progression start state 12 and the stroke progression end state 13 a plurality of further stroke progression start states 12 and stroke progression end states 13 are included, which ad up to the “stroke”-based touch input 8 and can be used to derive, for example, the stroke progression 9 and, based thereon, control commands for controlling the movement of the UAV 1 during receiving the “stroke”-based touch input 8.

It can be provided, that a selectability of the constant distance mode is provided to a user. The selectability of the constant distance mode can be based on a selectability of the at least a part of the façade 5 which is determined by the UAV 1. For example, the at least a part of the façade is captured by the distance measuring module of the UAV 1. As soon as the at least a part of the façade is determined its selectability by touching the determined at least a part of the façade can be provided. If the determined at least a part of the façade is selected/touched, the constant distance mode can automatically be activated or a selectability of the constant distance mode can be provided to a user.

A selectability of the constant distance mode can also be triggered by, for example, geometric properties of the at least a part of the façade 5. For example, if the façade is the façade of a lighthouse, the façade is curved. Without moving, only a small part of the façade will be capturable by the distance measuring module. Based on a determined curvature of the at least a part of the façade the constant distance mode can be selectable or automatically activated.

A geometric property of the façade can also relate to a discontinuity along the façade. A discontinuity can relate, for example, to a corner, which includes an abrupt direction-change in the course of the façade.

A selectability of the constant distance mode can be provided, for example, by overlaying a symbol such as a ruler or distance indicator to the determined at least a part of the façade 5.

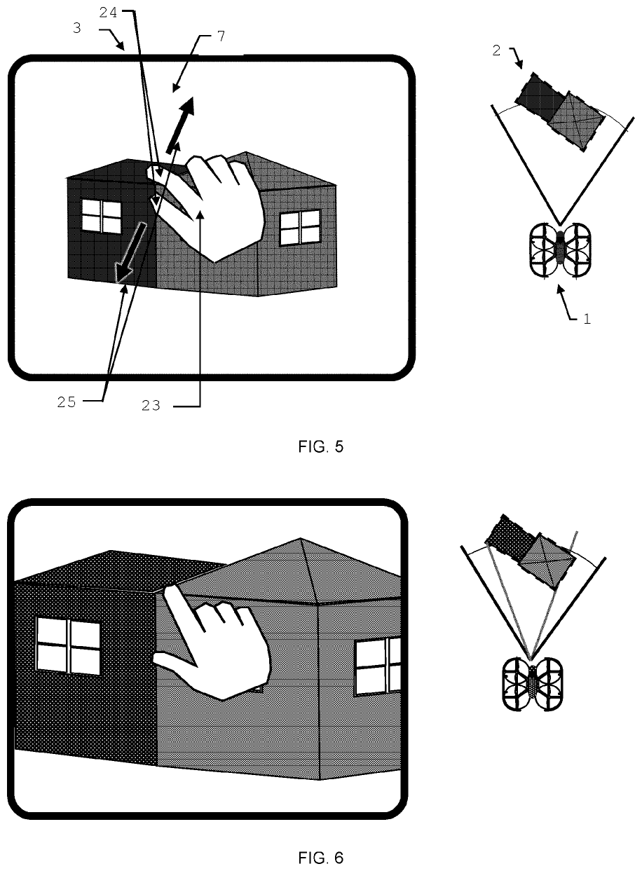

FIG. 4 shows a top view to a UAV 1, having a body 15 with a front end 16 and a back end 17. The directional distance measuring module is integrated in the front end 16 of the UAV 1. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE SECOND ASPECT OF THE INVENTION

FIG. 5 shows on the left side a typical mobile control device 3 having a touch sensitive display. The touch sensitive display is configured to receive touch inputs, for example, a “two-finger pinch” touch input 23, a “stroke” based touch input, a “two-finger stroke” touch input a “one-finger stroke” touch input, a “single tap” touch input, a “double tap” touch input etc., and to display a view of the physical environment 2 in a live view 7. Thereby, the view of the physical environment 2 is generated based on image data, which are received from a camera system of the UAV 1.

The mobile control device 3 is configured to control the flight and operation of a UAV 1. Therefore, a communicative connection between the mobile control device and the UAV is established. Touch inputs, which are received by the touch sensitive display are typically indicative of moving the UAV 1 in the physical environment 2.

The touch sensitive display shown in FIG. 5 is receiving a “two-finger pinch” touch input 23 with two pitch points 24. While receiving the “two-finger pinch” touch input 23 the two pitch points 24 are moving across the touch sensitive display away from each other, which relates to generating a pitch point progression 25.

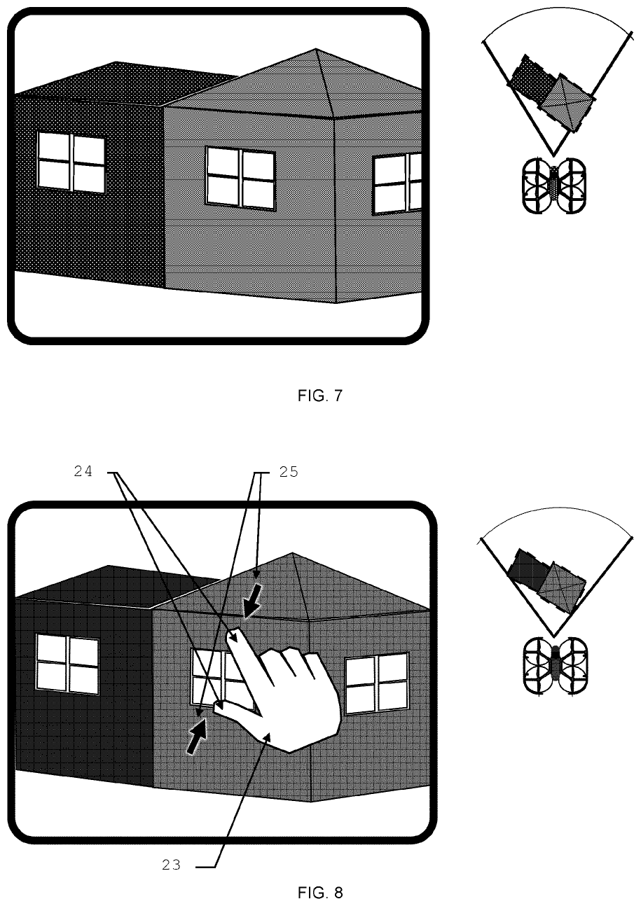

FIG. 6 shows an adapted live-view in comparison to the live-view 7 shown in FIG. 5. The live-view in FIG. 6 results from adapting by digitally scaling based on the pitch point progression 25 the live-view of FIG. 5.

FIG. 7 shows in a live-view, a view, which is generated by the UAV after the UAV has moved towards the object in the physical environment, wherein the movement is based on the pitch point progression 25 and the pinch direction.

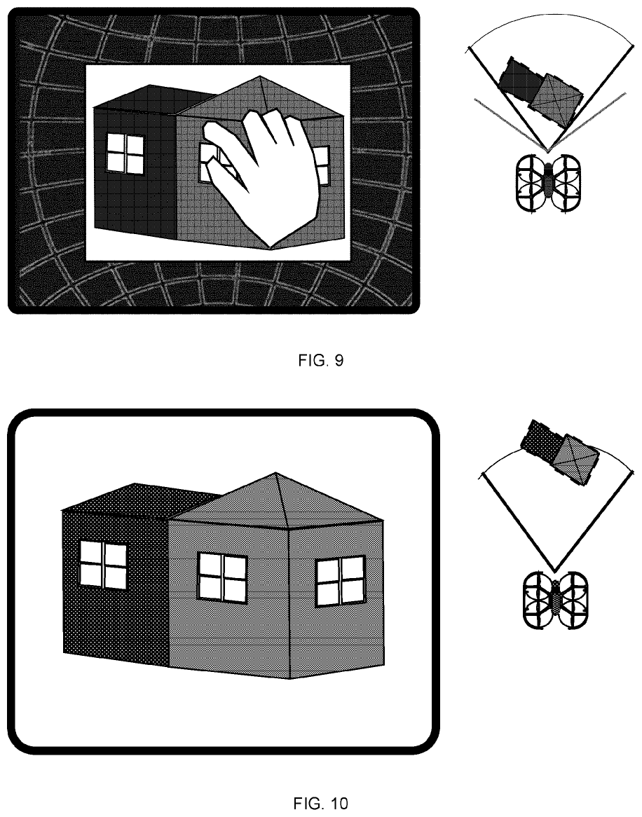

The touch sensitive display shown in FIG. 8 is receiving a “two-finger pinch” touch input 23 with two pitch points 24. While receiving the “two-finger pinch” touch input 23 the two pitch points 24 are moving across the touch sensitive display towards each other, which relates to generating a pitch point progression 25.

FIG. 9 shows an adapted live-view in comparison to the live-view 7 shown in FIG. 8. The live-view in FIG. 9 results from adapting by digitally scaling based on the pitch point progression 25 the live-view of FIG. 8.

FIG. 10 shows in a live-view, a view, which is generated by the UAV after the UAV has moved away from the object in the physical environment, wherein the movement is based on the pitch point progression 25 and the pinch direction.

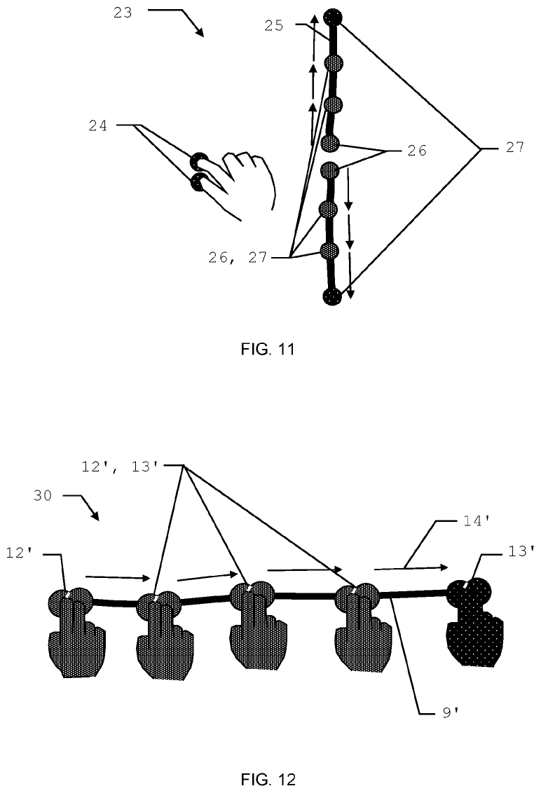

FIG. 11 relates to a “two-finger pinch” touch input 23. The touch sensitive display is touched by two fingers, wherein—while maintaining touching the touch sensitive display with the two fingers—the two fingers are moved across the touch sensitive display away from each other.

The movement of UAV 1 towards or away from an object is based on the pitch point progression 25. Based on the pitch point progression 25 control commands can be derived for controlling the movement of the UAV 1. A control command can relate to, for example, a pinch direction, in which the UAV 1 moves towards or away from an object, a velocity with which the UAV 1 moves towards or away from an object etc.

The “two-finger pinch” touch input 23, to which FIG. 11 is relating, includes a pitch point progression start state 26 and a pitch point progression end state 27. It can be provided that between the pitch point progression start state 26 and the pitch point progression end state 27 a plurality of further pitch point progression start states 26 and pitch point progression end states 27 are included, which ad up to the “two-finger pinch” touch input 23 and can be used to derive, for example, the pitch point progression 25 and, based thereon, control commands for controlling the movement of the UAV 1 during receiving the “two-finger pinch” touch input 23.

FIG. 4 shows a top view to a UAV 1, having a body 15 with a front end 16 and a back end 17. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE THIRD ASPECT OF THE INVENTION

FIG. 5 shows on the left side a typical mobile control device 3 having a touch sensitive display. The touch sensitive display is configured to receive touch inputs, for example, a “two-finger pinch” touch input 23, a “stroke” based touch input 8, a “two-finger stroke” touch input 30, a “one-finger stroke” touch input, a “single tap” touch input, a “double tap” touch input etc., and to display a view of the physical environment 2 in a live view 7. Thereby, the view of the physical environment 2 is generated based on image data, which are received from a camera system of the UAV 1.

The mobile control device 3 is configured to control the flight and operation of a UAV 1. Therefore, a communicative connection between the mobile control device and the UAV is established. Touch inputs, which are received by the touch sensitive display, are typically indicative of moving the UAV 1 in the physical environment 2.

The touch sensitive display shown in FIG. 5 is receiving a “two-finger stroke” touch input 30.

FIG. 12 relates to a “two-finger stroke” touch input 30. The touch sensitive display is touched by two fingers, wherein—while maintaining touching the touch sensitive display with the two fingers—the fingers are stroked across the touch sensitive display. Stroking across the touch sensitive display relates to generating the stroke progression 9′.

The “two-finger stroke” touch input 30, of FIG. 12, includes a stroke progression start state 12′ and a stroke progression end state 13′. It can be provided that between the stroke progression start state 12′ and the stroke progression end state 13′ a plurality of further stroke progression start states 12′ and stroke progression end states 13′ are included, which ad up to the “two-finger stroke” touch input 30 and can be used to derive, for example, the stroke progression 9′ and, based thereon, control commands for controlling the movement of the UAV 1 during receiving the “two-finger stroke” touch input 30.

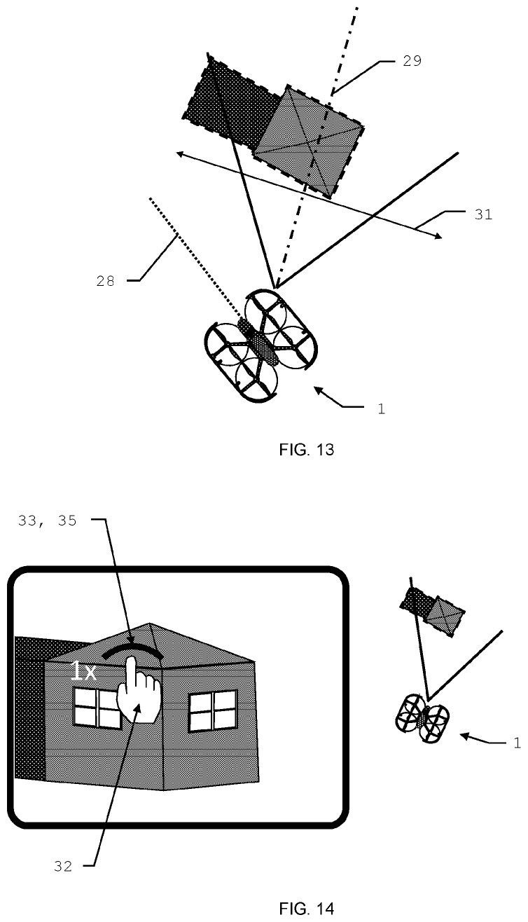

FIG. 13 shows a top view to a UAV 1 having a main view direction 28. Thereby, the view of the physical environment is displayed in a first view direction 29. Furthermore, FIG. 13 shows a direction 31 transverse to the first view direction.

FIG. 4 shows a top view to a UAV 1, having a body 15 with a front end 16 and a back end 17. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE FOURTH ASPECT OF THE INVENTION

FIG. 5 shows on the left side a typical mobile control device 3 having a touch sensitive display. The touch sensitive display is configured to receive touch inputs, for example, a “two-finger pinch” touch input 23, a “stroke” based touch input 8, a “two-finger stroke” touch input 30, a “one-finger stroke” touch input, a “single tap” touch input 32, a “double tap” touch input etc., and to display a view of the physical environment 2 in a live view 7. Thereby, the view of the physical environment 2 is generated based on image data, which are received from a camera system of the UAV 1.

The mobile control device 3 is configured to control the flight and operation of a UAV 1. Therefore, a communicative connection between the mobile control device and the UAV is established. Touch inputs, which are received by the touch sensitive display, are typically indicative of moving the UAV 1 in the physical environment 2.

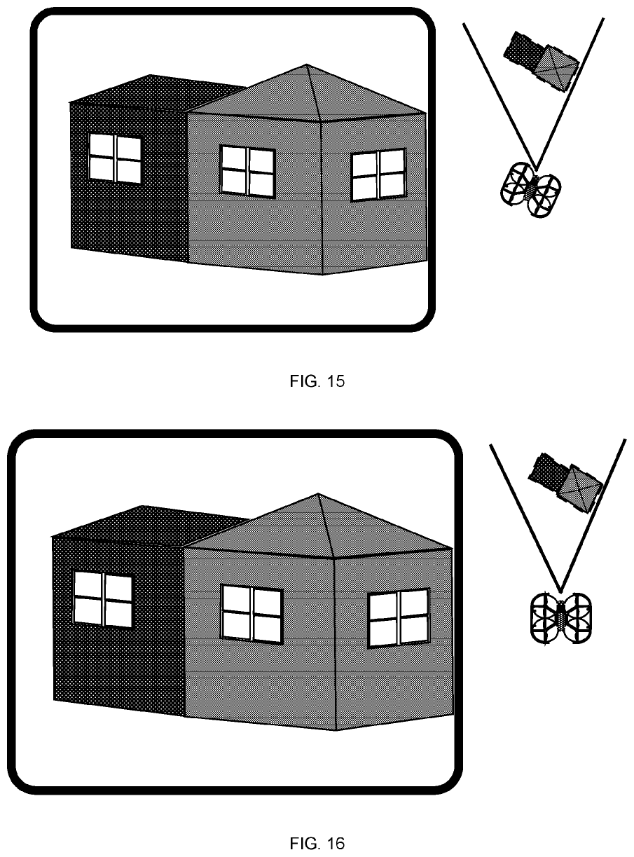

The touch sensitive display shown in FIG. 14 is receiving a “single tap” touch input 32 with a tap point 33 at a location 35.

FIG. 15 shows an adapted live-view in comparison to the live-view 7 shown in FIG. 14. The live-view in FIG. 15 results from adapting by digitally rotating the live-view of FIG. 14 around at least one of the principle axes in order to centre the location of the tap point 35 in the view.

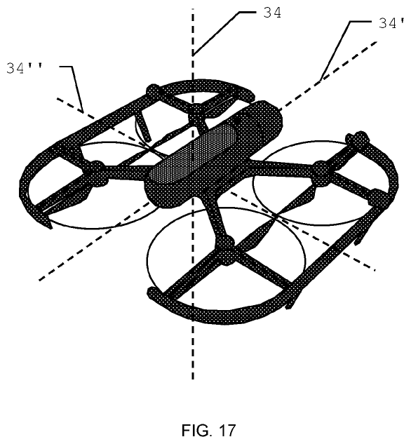

FIG. 16 shows in a live-view, a view, which is generated by the UAV after the UAV has moved based on a rotational motion pattern, by a rotational movement around the UAV's yaw axis, and based on digitally rotating the live-view of FIG. 14, in order to centre the location of the tap point 35 in the view.

FIG. 17 shows a UAV 1 with its principle axes 34, 34′, and 34″. More specifically a UAV 1 with its yaw axis 34, roll axis 34′ and pitch axis 34″.

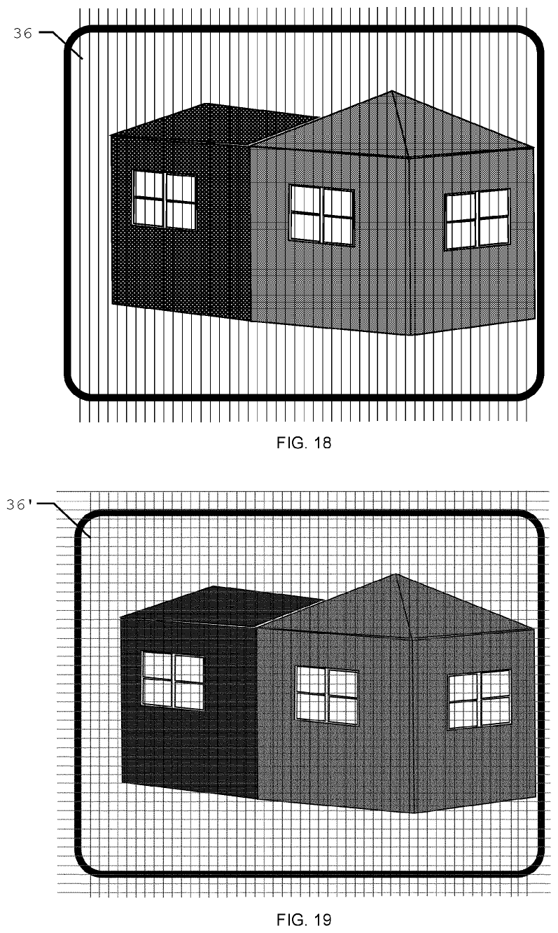

FIG. 18 shows a touch sensitive display including a plurality of touch zones 36 spread to the live-view. The touch zones are strip shaped.

FIG. 19 shows a touch sensitive display including a plurality of touch zones 36′ spread to the live-view. The touch zones are square shaped.

FIG. 20 shows a virtual camera position 37 from which the view of the physical environment is continuously displayed in the view direction 38. Upon receiving a “single tap” touch input, the view is digitally rotated around the UAV's yaw axis 34. Then the view is continuously displayed from the virtual camera position 37 in the digitally rotated view direction 38′.

FIG. 4 shows a top view to a UAV 1, having a body 15 with a front end 16 and a back end 17. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE FIFTH ASPECT OF THE INVENTION

FIG. 5 shows on the left side a typical mobile control device 3 having a touch sensitive display. The touch sensitive display is configured to receive touch inputs, for example, a “two-finger pinch” touch input 23, a “stroke” based touch input 8, a “two-finger stroke” touch input 30, a “one-finger stroke” touch input 39, a “single tap” touch input 32, a “double tap” touch input etc., and to display a view of the physical environment 2 in a live view 7. Thereby, the view of the physical environment 2 is generated based on image data, which are received from a camera system of the UAV 1.

The mobile control device 3 is configured to control the flight and operation of a UAV 1. Therefore, a communicative connection between the mobile control device and the UAV is established. Touch inputs, which are received by the touch sensitive display, are typically indicative of moving the UAV 1 in the physical environment 2.

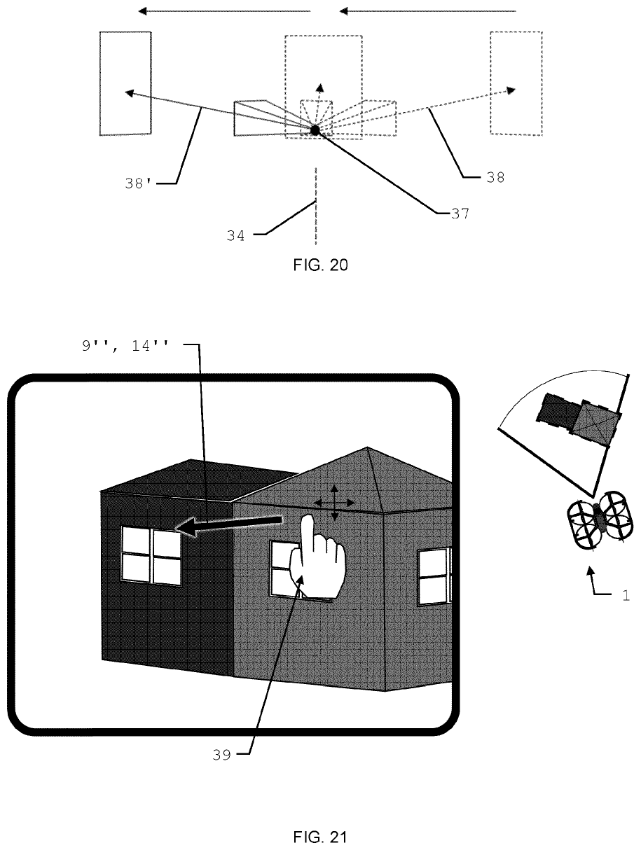

The touch sensitive display shown in FIG. 5 or FIG. 21 is receiving a “one-finger stroke” touch input 39, with a stroke progression 9″ and a stroke direction 14″.

FIG. 22 shows an adapted live-view in comparison to the live-view 7 shown in FIG. 21. The live-view in FIG. 22 results from adapting by digitally rotating the live-view of FIG. 21 around at least one of the principle axes and along a stroke direction (14″) based on the stroke progression (9″).

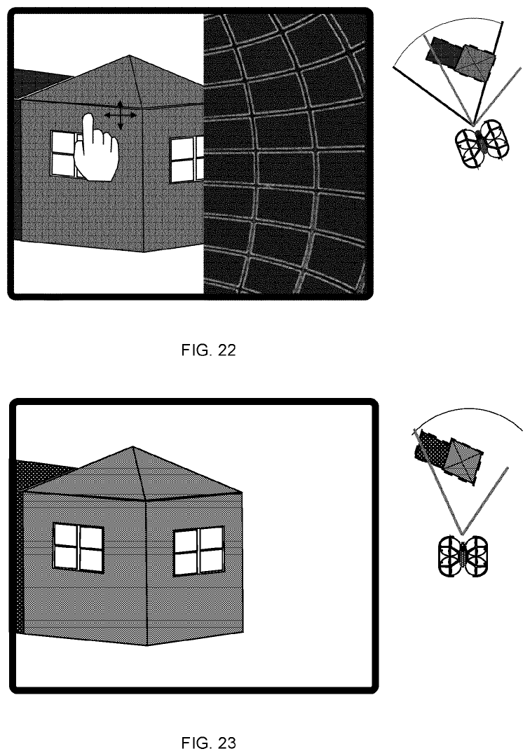

FIG. 23 shows in a live-view, a view, which is generated by the UAV after the UAV has moved around at least one of the principle axes, in particular around the UAV's yaw axis, and along the stroke direction (14″), and based on digitally rotating the live-view of FIG. 21.

FIG. 17 shows a UAV 1 with its principle axes 34, 34′, and 34″. More specifically a UAV 1 with its yaw axis 34, roll axis 34′ and pitch axis 34″.

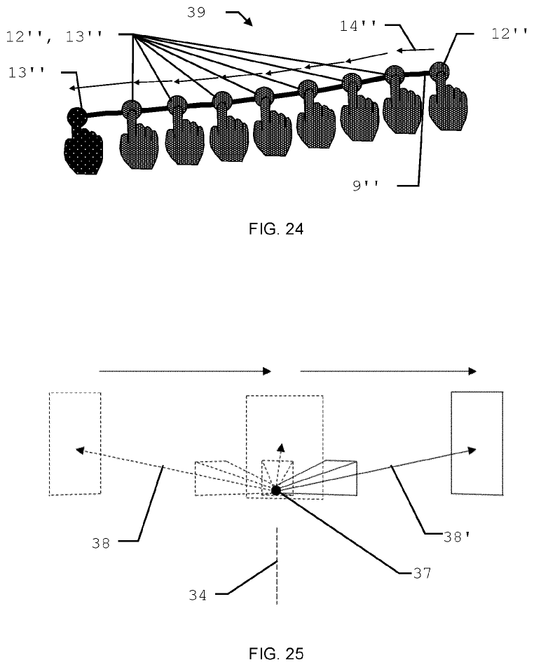

FIG. 24 relates to a “one-finger stroke” touch input 39. The touch sensitive display is touched by one finger, wherein—while maintaining touching the touch sensitive display with the one finger—the finger is stroked across the touch sensitive display. Stroking across the touch sensitive display relates to generating the stroke progression 9″.

The “one-finger stroke” touch input 39, of FIG. 24, includes a stroke progression start state 12″ and a stroke progression end state 13″. It can be provided that between the stroke progression start state 12″ and the stroke progression end state 13″ a plurality of further stroke progression start states 12″ and stroke progression end states 13″ are included, which ad up to the “one-finger stroke” touch input 39 and can be used to derive, for example, the stroke progression 9″ and, based thereon, control commands for controlling the movement of the UAV 1 during receiving the “one-finger stroke” touch input 39.

FIG. 25 shows a virtual camera position 37 from which the view of the physical environment is continuously displayed in the view direction 38. While receiving a “one-finger stroke” touch input the view is digitally rotated around the UAV's yaw axis 34. Then the view is continuously displayed from the virtual camera position 37 in the digitally rotated view direction 38′.

FIG. 4 shows a top view to a UAV 1, having a body 15 with a front end 16 and a back end 17. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE SIXTH ASPECT OF THE INVENTION

FIG. 5 shows on the left side a typical mobile control device 3 having a touch sensitive display. The touch sensitive display is configured to receive touch inputs, for example, a “two-finger pinch” touch input 23, a “stroke” based touch input 8, a “two-finger stroke” touch input 30, a “one-finger stroke” touch input 39, a “single tap” touch input 32, a “double tap” touch input 40 etc., and to display a view of the physical environment 2 in a live view 7. Thereby, the view of the physical environment 2 is generated based on image data, which are received from a camera system of the UAV 1.

The mobile control device 3 is configured to control the flight and operation of a UAV 1. Therefore, a communicative connection between the mobile control device and the UAV is established. Touch inputs, which are received by the touch sensitive display, are typically indicative of moving the UAV 1 in the physical environment 2.

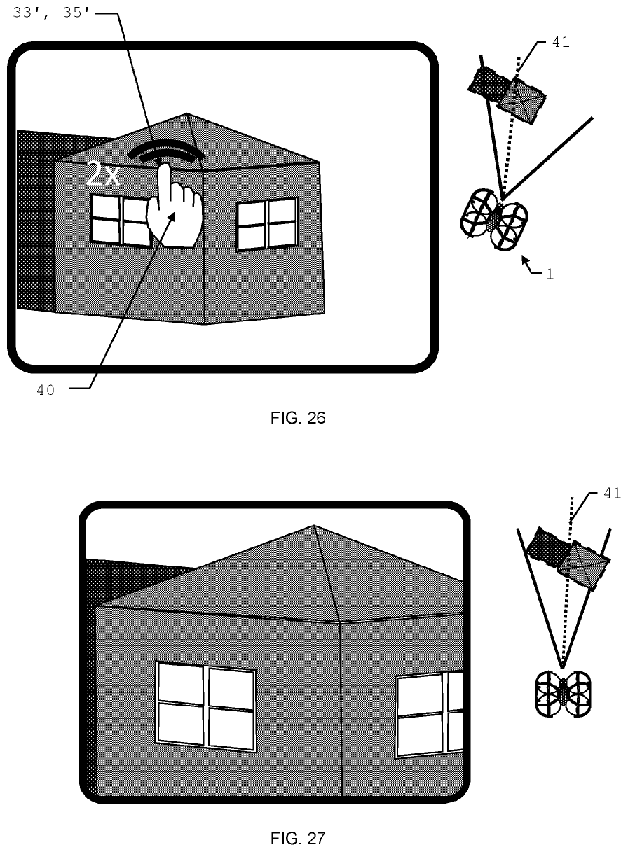

The touch sensitive display shown in FIG. 5 or FIG. 26 is receiving a “double tap” touch input 40 with a tap point 33′.

FIG. 27 shows an adapted live-view in comparison to the live-view 7 shown in FIG. 26. The live-view in FIG. 27 results from adapting by digitally rotating the live-view of FIG. 26 around at least one of the principle axes, and after the UAV has moved by a rotational movement around at least one of its principle axes 34, 34′, 34″ and at a predetermined amount along the tap direction 41, in order to centre the location 35′ of the tap point 33′ in the view.

FIG. 17 shows a UAV 1 with its principle axes 34, 34′, and 34″. More specifically a UAV 1 with its yaw axis 34, roll axis 34′ and pitch axis 34″.

FIG. 18 shows a touch sensitive display including a plurality of touch zones 36 spread to the live-view. The touch zones are strip shaped.

FIG. 19 shows a touch sensitive display including a plurality of touch zones 36′ spread to the live-view. The touch zones are square shaped.

FIG. 20 shows a virtual camera position 37 from which the view of the physical environment is continuously displayed in the view direction 38. Upon receiving a “double tap” touch input, the view is digitally rotated around the UAV's yaw axis 34. Then the view is continuously displayed from the virtual camera position 37 in the digitally rotated view direction 38′.

FIG. 4 shows a top view to a UAV 1, having a body 15 with a front end 16 and a back end 17. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE SEVENTH ASPECT OF THE INVENTION

FIG. 4 shows a top view to a UAV 1, having a body 15 with a front end 16 and a back end 17. The UAV 1 includes a front 19 and side 22 cameras, which are arranged at locations, where the shrouding of the UAV 1 is connecting to strut elements of the mounting structures. On the upper side, with respect to a flying position, a top camera 20 is arranged on the body 15. On the bottom side, with respect to a flying position, a bottom camera 21 is arranged on the body 15. Each camera has a field of view 18 with a fixed orientation in relation to the UAV 1. The UAV 1 further has four propulsion units realized in form of rotary wing/propeller units. Two propulsion units are arranged on a left side and on a right side of the body 15.

### DETAILED DESCRIPTION OF THE FIGURES ACCORDING TO THE EIGHTH ASPECT OF THE INVENTION

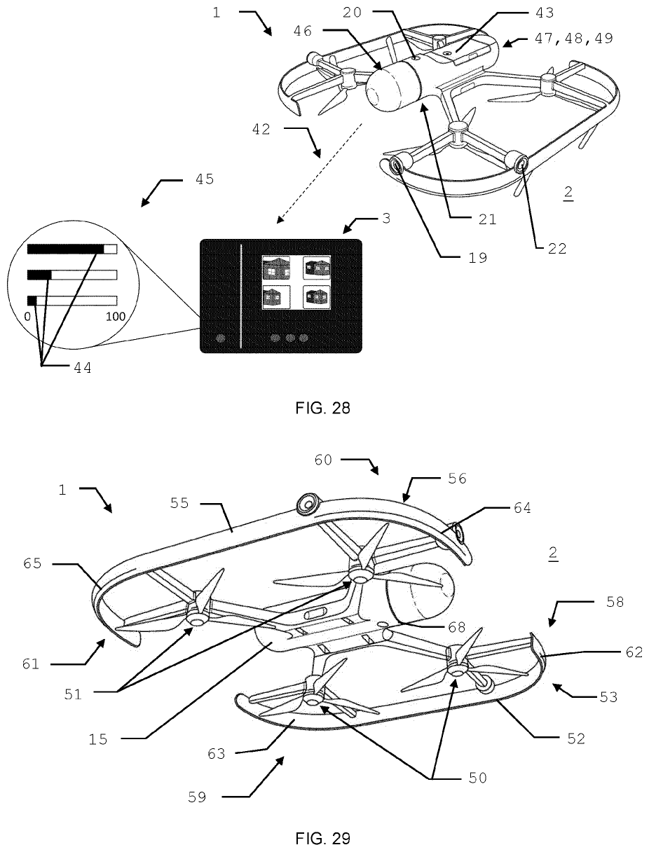

FIG. 28 shows a flying UAV 1, which is powered by a single battery 43. While flying the UAV is continuously providing battery charge level information 42, related to the battery 43, either to a computing unit of the UAV or to a mobile control device 3 for determining a most recent battery charge level 44. The mobile control device 3 has a touch sensitive display and displays a charge level notification 45 to a user of the UAV 1 based on the battery charge level 44.

In case the battery charge level 44 is determined to be at a level, which necessitates swapping the battery 43, the UAV 1 is instructed to autonomously move to a predetermined location. The location can be, for example, the location, from where the UAV has taken off/been launched, or the location from where a user is controlling the UAV. The UAV then is further instructed to land at the location, such that the battery 43 can be replaced within a predetermined time window. The predetermined time window is strongly depending on the amount of time during which the UAV can be powered by capacitor power. The predetermined time window is as well depending on which and how many of the power consuming units of the UAV have to be supplied by capacitor power during replacing/swapping the batteries.

After the UAV has landed at the location, typically the propulsion units, the cameras 19, 20, 21, 22, or at least one of the cameras and at least the most power consuming sensor module, for example, the directional distance measuring module, are deactivated.

At the latest, when the battery is being disconnected from the UAV the UAV switches from the battery powered supply mode to the capacitor powered supply mode, such that an uninterrupted power supply is provided.

After the battery has been replaced with a fully charged battery, the UAV can provide an operability, which relates to the UAV autonomously moving back to the location, where it was before returning to the location for replacing the battery. For example, if the UAV has been on a flight-mission for inspecting/surveying/measuring/digitizing the UAV's environment, the UAV can provide for an operability, which makes the UAV to autonomously continue the flight-mission after the battery has been replaced.

After the battery has been replaced with a fully charged battery, the UAV can provide an operability, which relates to the UAV automatically transmitting recorded flight data to a storage, for example, a cloud storage, or to the mobile control device.

The recorded flight data can relate to, for example, sensor data relating to inspecting/surveying/measuring/digitizing the UAV's environment.

As indicated in FIG. 28, the UAV has integrated inside the body of the UAV a UAV powering system 47, a capacitor 48 and a battery charge level information generator 49.

### DETAILED DESCRIPTION OF THE FIGURES ACCORDING TO THE NINTH ASPECT OF THE INVENTION

FIG. 29 and FIG. 30 show a UAV 1 flying in a physical environment 2. The UAV has a body 15, a first plurality of propulsion units 50 arranged on the left side of the body 15 and a second plurality of propulsion units 51 arranged on the right side of the body 15. The UAV 1 further has a first protective frame 52 running curved 53 around a portion of an outer edge 54 of the first plurality of propulsion units and a second protective frame 55 running curved 56 around a portion of an outer edge 57 of the second plurality of propulsion units.

The first protective frame forms a front left corner section 58 and a rear left corner section 59. The second protective frame 55 forms a front right corner section 60 and a rear right corner section 61.

The UAV indicator light system includes a first linear indicator 62 for emitting light and running curved around a portion of an outer edge of the front left propulsion unit and along the first protective frame in the front left corner section.

The UAV indicator light system includes a second linear indicator 63 for emitting light and running curved around a portion of an outer edge of the rear left propulsion unit and along the first protective frame in the rear left corner section.

The UAV indicator light system includes a third linear indicator 64 for emitting light and running curved around a portion of an outer edge of the front right propulsion unit and along the second protective frame in the front right corner section.

The UAV indicator light system includes a fourth linear indicator 65 for emitting light and running curved around a portion of an outer edge of rear right propulsion unit and along the second protective frame in the rear right corner section.

Thereby, each linear indicator is arranged to emit light away from the UAV and towards ground 66 into a confined emission sector 67, 67′, 67″, 67′″, and enables a variable emission of light.

The UAV indicator light system shown in FIG. 29 and FIG. 30 enables an orientation-specific user perception of the UAV, and an indicating of a UAV-status to a user.

The UAV shown in FIG. 29 has a fifth linear indicator 68 for emitting light and running curved around an outer section of the body.

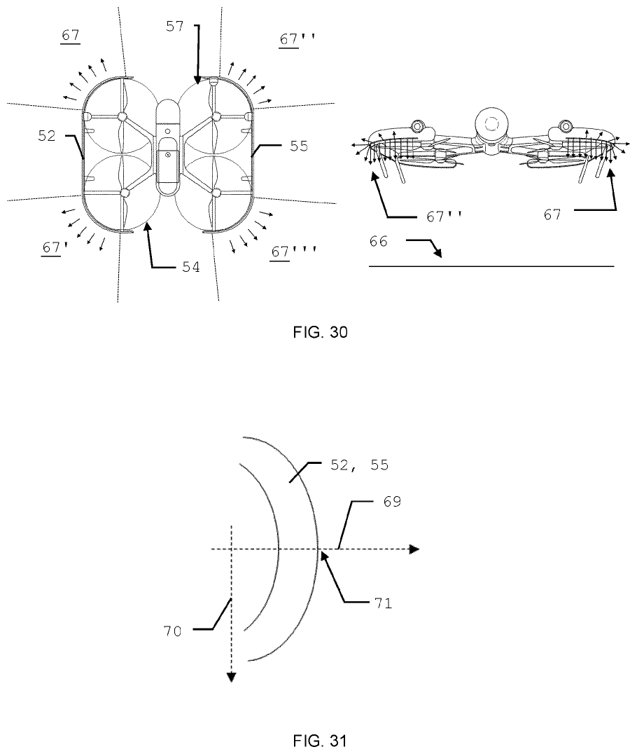

FIG. 31 shows a cross section of a band-shaped protective frame. The band-shaped protective frame is bulged in a first direction 69 transverse to its running direction. A linear indicator can be arranged at the protective frame at a location being offset, in a second direction 70 transverse to the protective frame's running direction and to the first direction 69, from a maximum bulging 71 of the protective frame.

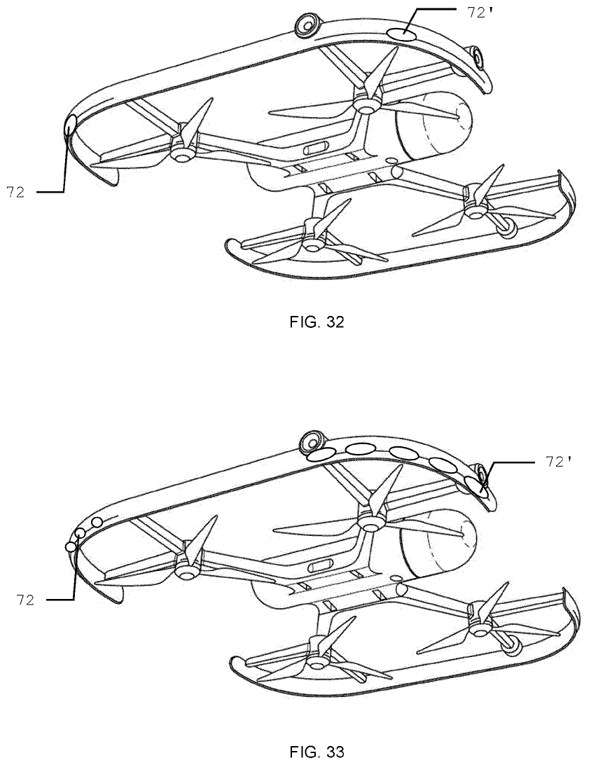

FIG. 32 shows a linear indicator comprising at least one light source 72, 72′, wherein the linear indicator is configured to linearly guide light, emitted by the at least one light source 72, 72′, curved around a portion of an outer edge of one of a plurality of propulsion units and along a protective frame in a corner section.

FIG. 33 shows a plurality of light sources 72, 72′, wherein the plurality of light sources is arranged to linearly run curved around a portion of an outer edge of one of a plurality of propulsion units and along a protective frame in a corner section.

### DETAILED DESCRIPTION OF THE FIGURES ACCORDING TO THE TENTH ASPECT OF THE INVENTION

FIG. 28 and FIG. 29 show a typical UAV 1 flying in a physical environment 2.

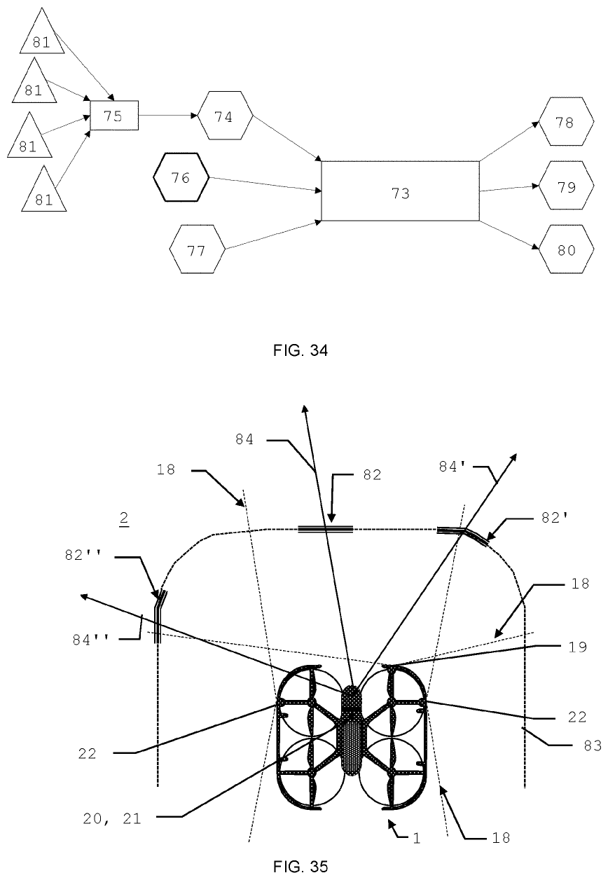

FIG. 34 shows a schematic of how an autonomous navigation control unit 73 of the UAV determines the UAV's position 78, flight-velocity 79 and orientation 80 using GNSS positioning signals 74 received from a GNSS receiver module 75, which is receiving GNSS positioning signals from GNSS satellites 81, environment data 76 and local navigation sensor signals 77.

### DETAILED DESCRIPTION OF THE FIGURES ACCORDING TO THE ELEVENTH ASPECT OF THE INVENTION

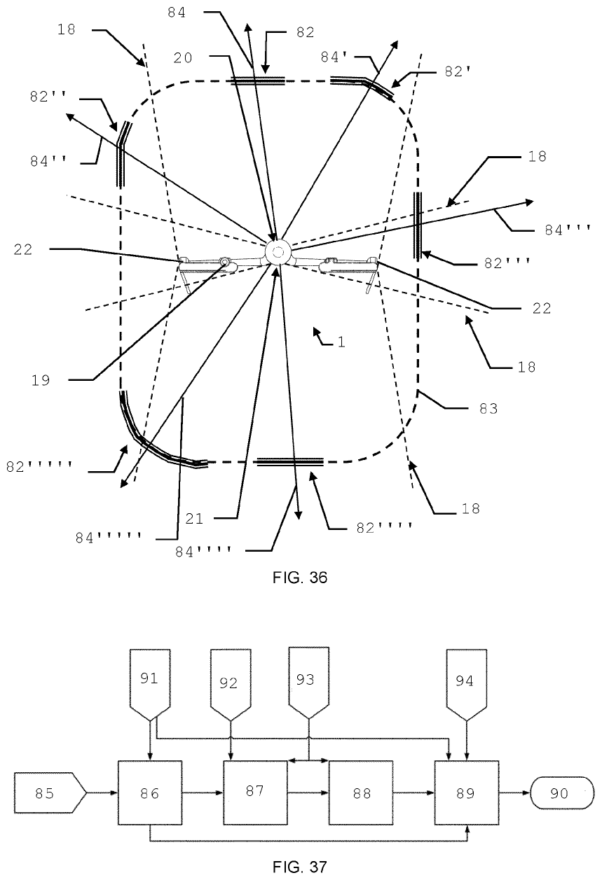

FIG. 35 and FIG. 36 show a UAV 1 in a physical environment 2. FIG. 35 and FIG. 36 further show schematically an all-round view 83, which is generated based on available image data generated by a front camera 19, a top camera 20, a bottom camera 21, and side cameras 22. Each of the cameras has a field of view 18 with a fixed orientation in relation to the UAV and directed away from the UAV.

FIG. 35 and FIG. 36 further show different views 82, 82′, 82″, 82′″, 82″″, 82′″″, which can be generated and continuously displayed in a live-view.

FIG. 35 shows a top view to the UAV 1. FIG. 36 shows a front view to the UAV. Thereby, same reference numbers in FIG. 35 and FIG. 36 do not necessarily relate to the same feature. For example, the view 82 in FIG. 35 does not relate to the same view 82 in FIG. 36.

FIG. 5 shows on the left side a typical mobile control device 3 having a touch sensitive display. The touch sensitive display is configured to receive touch inputs, for example, a “two-finger pinch” touch input 23, a “stroke” based touch input 8, a “two-finger stroke” touch input 30, a “one-finger stroke” touch input 39, a “single tap” touch input 32, a “double tap” touch input 40 etc., and to display a view of the physical environment 2 in a live view 7. Thereby, the view of the physical environment 2 is generated based on image data, which are received from a camera system of the UAV 1.

The mobile control device 3 is configured to control the flight and operation of a UAV 1. Therefore, a communicative connection between the mobile control device and the UAV is established. Touch inputs, which are received by the touch sensitive display, are typically indicative of moving the UAV 1 in the physical environment 2.

For example, in case a touch input is received by the touch sensitive display and identified by the mobile control device, which touch input indicates a desired viewing direction 84, 84′, 84″, a view to the physical environment in this desired viewing direction is generated and displayed in a live-view. Thereby, based on the desired viewing direction, the image data, which is needed for generating the desired view in the desired viewing direction, is selected from the available image data. A touch input can be, for example, a “single tap” touch input.

FIG. 18 shows a touch sensitive display including a plurality of touch zones 36 spread to the live-view. The touch zones are strip shaped.

FIG. 19 shows a touch sensitive display including a plurality of touch zones 36′ spread to the live-view. The touch zones are square shaped.

FIG. 37 shows a schematic of a method according to an embodiment of the eleventh aspect of the invention. A user input 85 related to indicating a desired viewing direction is generated and received. A virtual camera position and the desired viewing direction are computed 86 aiding the position and orientation of the drone 91. By the plurality of cameras 92 available image data is provided. Therefrom, image data is selected 87. The selected image data is then stitched 88 using an image stitching algorithm. The stitching algorithm can make use of directional distance information 93, which is recorded by a directional distance measuring module of the UAV by measuring the physical environment. Thereby the directional distance information is correlated with the selected image data such that selected image data with depth information is generated. The image stitching algorithm is stitching the selected image data then aiding the depth information. Then, the stitched image data is cropped and rendered 89 according to virtual camera settings 94, for example resolution, distortion etc. Finally, the cropped and rendered image data is streamed 90 to the mobile control device to be displayed in a live-view.

### DETAILED DESCRIPTION OF THE FIGURES ACCORDING TO THE TWELFTH ASPECT OF THE INVENTION

FIG. 1, FIG. 4, FIG. 17 all show a UAV 1 flying in a physical environment 2.

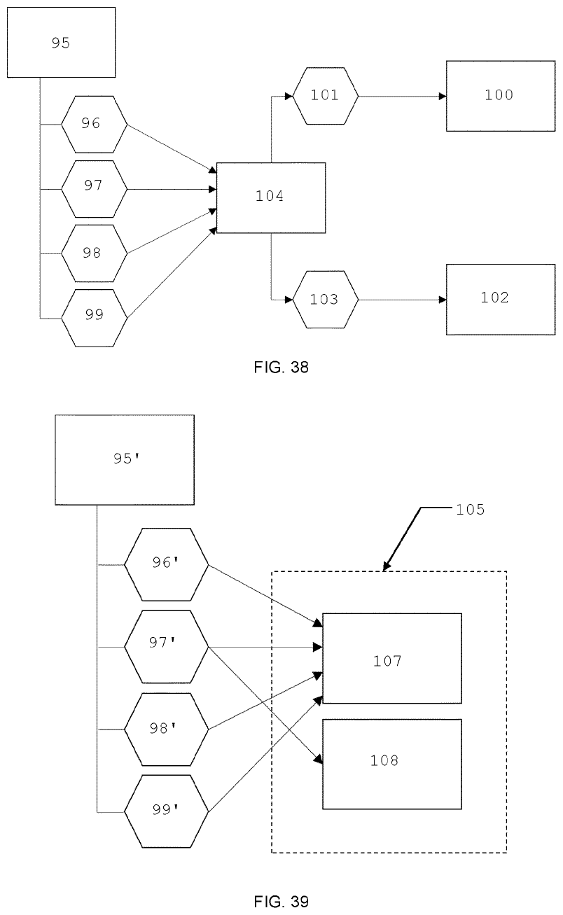

FIG. 38 shows a schematic of the method according to an embodiment of the twelfth aspect of the invention. Sensor raw data are generated by the multipurpose sensor system 95. The raw data are in the form of image data 96, motion data 97, measurement data 98 and global position data 99. The sensor raw data are provided to/received by the sensor raw data conditioning unit 104. Then, depending on the purpose for which the sensor raw data is to be used, the sensor raw data conditioning unit 104 is conditioning the sensor raw data. The sensor raw data is conditioned to form support data 101 and/or to form sensor data 103. Then the support data 101 is used by the flight control support functionality 100 to autonomously support the flight control and the sensor data 103 is used by the sensor data recording functionality 102 to be recorded for enabling a generation of a representation of the physical environment of the UAV.

### DETAILED DESCRIPTION OF THE FIGURES ACCORDING TO THE THIRTEENTH ASPECT OF THE INVENTION

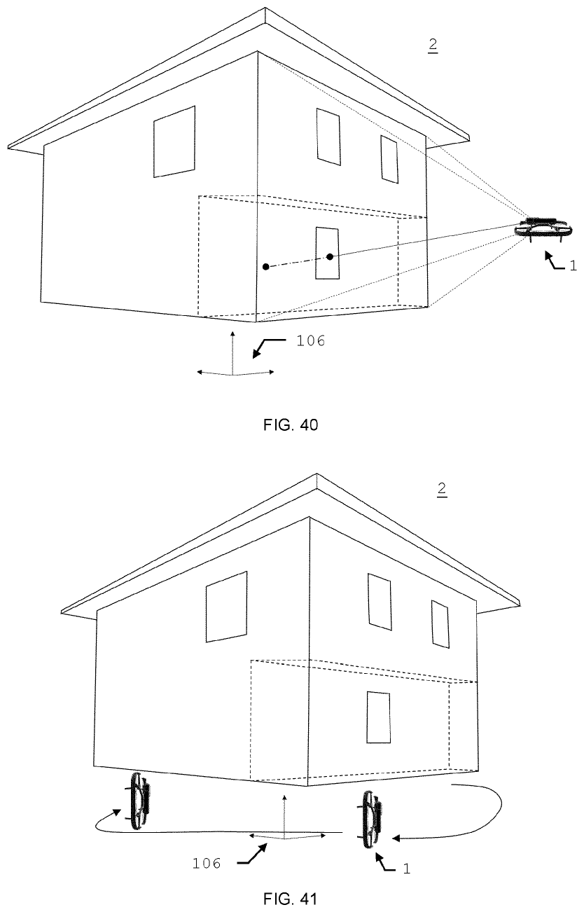

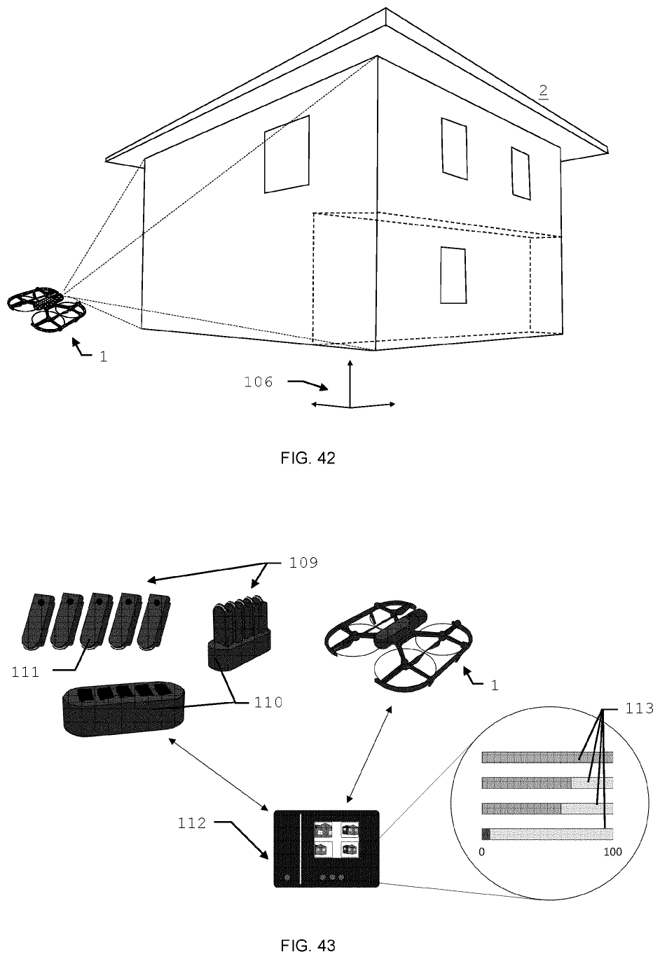

FIG. 41, FIG. 42 and FIG. 43 all show a UAV 1 flying in a physical environment 2.

FIG. 39 shows a schematic of the method according to an embodiment of the thirteenth aspect of the invention. The multipurpose sensor system 95′ of the UAV 1 generates sensor data. The sensor data are image data 96′, motion data 97′, measurement data 98′ and global position data 99′. The referencing and tracking functionality 105 uses sensor data for referencing and tracking the UAV's position and orientation. The referencing and tracking functionality 105 has modes in which it operates. A first mode 107, which is activated while the UAV is flying and, for example, performing a measurement task. While the UAV is flying, typically, as many of the sensor data are used by the referencing and tracking functionality 105 as needed to track the position and orientation of the UAV with a predefined quality. The referencing and tracking functionality 105 further has a second mode 108. The second mode is activated, while the UAV is moving propulsion-free, for example, in case when the UAV is being carried by a user from a first location to a second location. While the UAV is moving propulsion-free, typically, only the sensor data, which are needed for keeping the position and orientation of UAV referenced to the reference coordinate system 106 are used, for example, only motion data 97′, or motion data 97′ and image data 96′, or motion data 97′ and global position data 99′ etc. Sensor data, which can not reliably be generated while the UAV is moving propulsion-free, for example, because the UAV is being carried in a bag, can be left unconsidered by the referencing and tracking functionality. Thereby, also power consumption of the UAV can be optimised in such situations.

FIG. 40, FIG. 41 and FIG. 42 show a situation, where the method according to an embodiment of the thirteenth aspect of the invention enables an uninterrupted continuous tracking of the UAV's position and orientation in a reference coordinate system 106.

In FIG. 41, the UAV 1 includes a directional distance measuring module. The UAV 1 is measuring a first façade of the building. Therefore, the UAV is referenced to the reference coordinate system 106.

After the measurement is completed, in FIG. 41, the UAV 1 is carried, for example by a user, around a corner of the building. While being carried the UAV 1 is moving propulsion-free and is uninterruptedly being tracked by the referencing and tracking functionality 105.

Around the corner in front of another façade of the building, in FIG. 42, the UAV 1 is launched continues measuring the building. Thereby, all the measurement data, which is recorded, is referenced to the same reference coordinate system 106, without necessitating a fresh initial referencing procedure.

### DETAILED DESCRIPTION OF THE FIGURES ACCORDING TO THE FOURTEENTH ASPECT OF THE INVENTION

FIG. 43 shows a system according to an embodiment of the fourteenth aspect of the invention for managing a set of UAV-batteries 109 used for powering a UAV 1. The system includes a mobile battery charger unit 110. The mobile battery charger unit 110 is designed for receiving at least one UAV-battery 43, 111. The mobile battery charger unit 110 is communicatively connected by its transceiver unit to the battery management terminal 112. The battery management terminal 112 is communicatively connected to the UAV 1. The battery management terminal 112 is receiving battery management data from the mobile battery charger unit 110 and the UAV 1, synchronizes the battery management data and determines a charge state of UAV-batteries. Each determined charge state is displayed 113.

### DETAILED DESCRIPTION OF THE FIGURES ACCORDING TO THE FIFTEENTH ASPECT OF THE INVENTION

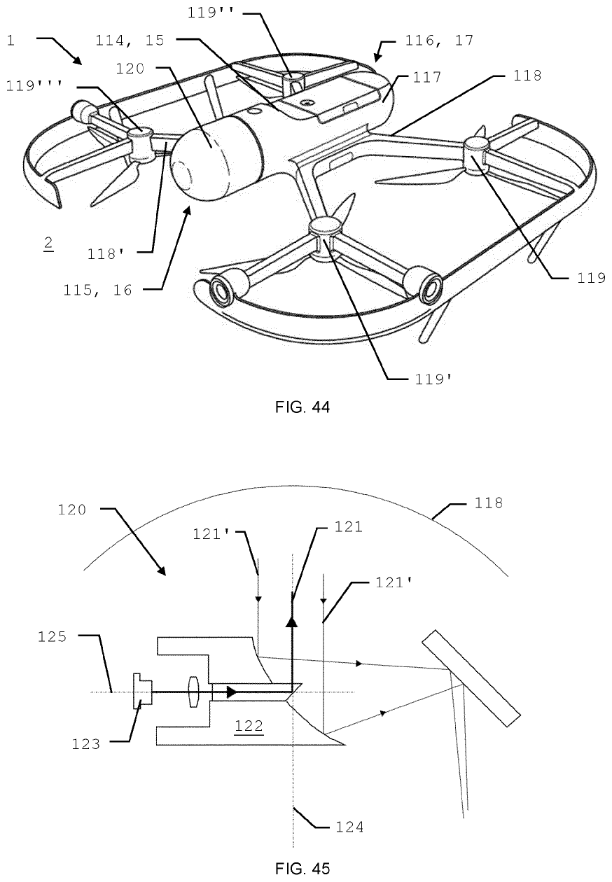

FIG. 44 shows a UAV 1 according to an embodiment of the fifteenth aspect of the invention. The UAV 1 has a body 114, 15. The body extends along an axis from its front end 16, 115 to its back end 17, 116. The body further has a housing 117. The housing's material in the front end is different from the housing's material at the back end. The UAV has a first mounting structure 118 on the left side of the body and attached to the body. The UAV further has a second mounting structure 118′ on the right side of the body and attached to the body. Furthermore the UAV includes four propulsion units 119, 119′, 119″, 119′″ for flying. In the front end of the body, a directional distance measuring module 120 is integrated. Therefore, the housing's material in the front end of the body is different from the housing's other material. The housing's material at front end is such, that distance measurement radiation 121 can be emitted/received through it.

FIG. 45 shows a schematic of the directional distance measuring module 120 being integrated in the front end of the UAV 1. The directional distance measuring module has a deflector unit 122, which deflects distance measurement radiation 121 from the distance measurement radiation source 123 through the housing 118 into the field of view. The deflector unit 122, furthermore, deflects distance measurement radiation 121′, reflected from a surface through the housing, to the detector unit. The deflector unit 122 is rotatable around a first rotation axis 124 and a second rotation axis 125 being transverse to the first rotation axis.

FIG. 29 and FIG. 30 show a UAV 1 flying in a physical environment 2. The UAV has a body 15, a first plurality of propulsion units 50 arranged on the left side of the body 15 and a second plurality of propulsion units 51 arranged on the right side of the body 15. The UAV 1 further has a first protective frame 52 running curved 53 around a portion of an outer edge 54 of the first plurality of propulsion units and a second protective frame 55 running curved 56 around a portion of an outer edge 57 of the second plurality of propulsion units.

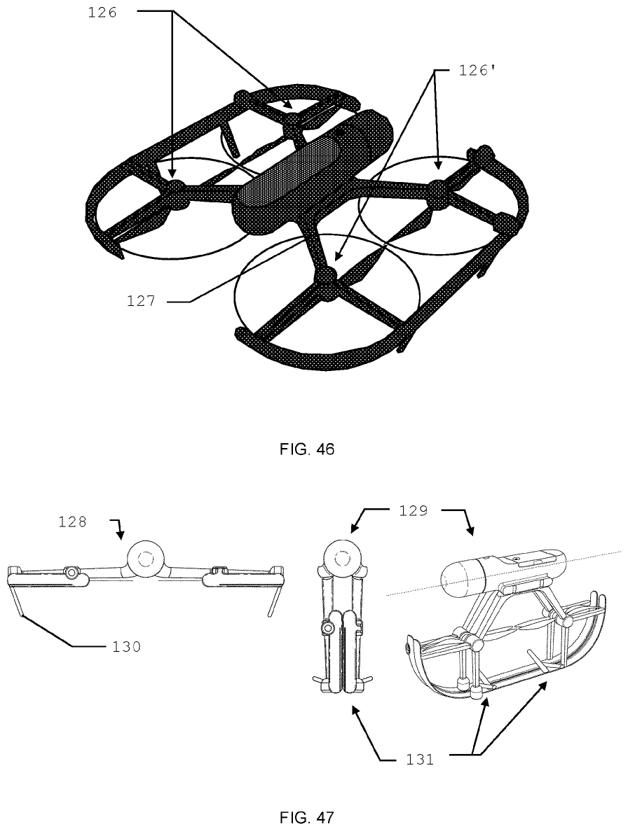

FIG. 46 shows a UAV 1 with mounting structures having mounting parts 126, 126′, where the propulsion units are mounted. Each of the mounting parts has a at least one strut element 127 having a hollow interior, wherein the hollow interior forms a hidden cable routing from a propulsion unit to the body.

FIG. 47 shows a UAV 1, where the mounting structures are attached to the body such that the mounting structures are rotatable around the axis along which the body extends, from a first snap-in position 128 to a second position 129, in particular to a second snap-in position. Landing support structures 130 are located at the protective frames. The landing support structures 130 are located such that with the mounting structures in the second position 129, the landing support structures intertwine 131.

FIG. 35 and FIG. 36 show a UAV 1 in a physical environment 2. FIG. 35 and FIG. 36 further show schematically an all-round view 83, which is generated based on available image data generated by a front camera 19, a top camera 20, a bottom camera 21, and side cameras 22. Each of the cameras has a field of view 18 with a fixed orientation in relation to the UAV and directed away from the UAV.

FIG. 35 and FIG. 36 further show different views 82, 82′, 82″, 82′″, 82″″, 82′″″, which can be generated and continuously displayed in a live-view.

FIG. 35 shows a top view to the UAV 1. FIG. 36 shows a front view to the UAV. Thereby, same reference numbers in FIG. 35 and FIG. 36 do not necessarily relate to the same feature. For example, the view 82 in FIG. 35 does not relate to the same view 82 in FIG. 36.

FIG. 28 shows a flying UAV 1, which is powered by a single battery 43. While flying the UAV is continuously providing battery charge level information 42, related to the battery 43, either to a computing unit of the UAV or to a mobile control device 3 for determining a most recent battery charge level 44. The mobile control device 3 has a touch sensitive display and displays a charge level notification 45 to a user of the UAV 1 based on the battery charge level 44.

As indicated in FIG. 28, the UAV has integrated inside the body of the UAV a UAV powering system 47, a capacitor 48 and a battery charge level information generator 49.

FIG. 29 and FIG. 30 show a UAV 1 flying in a physical environment 2. The UAV has a body 15, a first plurality of propulsion units 50 arranged on the left side of the body 15 and a second plurality of propulsion units 51 arranged on the right side of the body 15. The UAV 1 further has a first protective frame 52 running curved 53 around a portion of an outer edge 54 of the first plurality of propulsion units and a second protective frame 55 running curved 56 around a portion of an outer edge 57 of the second plurality of propulsion units.

The first protective frame forms a front left corner section 58 and a rear left corner section 59. The second protective frame 55 forms a front right corner section 60 and a rear right corner section 61.

The UAV indicator light system includes a first linear indicator 62 for emitting light and running curved around a portion of an outer edge of the front left propulsion unit and along the first protective frame in the front left corner section.

The UAV indicator light system includes a second linear indicator 63 for emitting light and running curved around a portion of an outer edge of the rear left propulsion unit and along the first protective frame in the rear left corner section.

The UAV indicator light system includes a third linear indicator 64 for emitting light and running curved around a portion of an outer edge of the front right propulsion unit and along the second protective frame in the front right corner section.

The UAV indicator light system includes a fourth linear indicator 65 for emitting light and running curved around a portion of an outer edge of rear right propulsion unit and along the second protective frame in the rear right corner section.

Thereby, each linear indicator is arranged to emit light away from the UAV and towards ground 66 into a confined emission sector 67, 67′, 67″, 67′″, and enables a variable emission of light.

The UAV indicator light system shown in FIG. 29 and FIG. 30 enables an orientation-specific user perception of the UAV, and an indicating of a UAV-status to a user.

The UAV shown in FIG. 29 has a fifth linear indicator 68 for emitting light and running curved around an outer section of the body.

FIG. 34 shows a schematic of how an autonomous navigation control unit 73 of the UAV determines the UAV's position 78, flight-velocity 79 and orientation 80 using GNSS positioning signals 74 received from a GNSS receiver module 75, which is receiving GNSS positioning signals from GNSS satellites 81, environment data 76 and local navigation sensor signals 77.

FIG. 38 shows a schematic of the method according to an embodiment of the twelfth aspect of the invention. Sensor raw data are generated by the multipurpose sensor system 95. The raw data are in the form of image data 96, motion data 97, measurement data 98 and global position data 99. The sensor raw data are provided to/received by the sensor raw data conditioning unit 104. Then, depending on the purpose for which the is to be used, the sensor raw data conditioning unit 104 is conditioning the sensor raw data. The sensor raw data is conditioned to form support data 101 and/or to form sensor data 103. Then the support data 101 is used by the flight control support functionality 100 to autonomously support the flight control and the sensor data 103 is used by the sensor data recording functionality 102 to be recorded for enabling a generation of a representation of the physical environment of the UAV.

FIG. 43 shows a system according to an embodiment of the fourteenth aspect of the invention for managing a set of UAV-batteries 109 used for powering a UAV 1. The system includes a mobile battery charger unit 110. The mobile battery charger unit 110 is designed for receiving at least one UAV-battery 43, 111. The mobile battery charger unit 110 is communicatively connected by its transceiver unit to the battery management terminal 112. The battery management terminal 112 is communicatively connected to the UAV 1. The battery management terminal 112 is receiving battery management data from the mobile battery charger unit 110 and the UAV 1, synchronizes the battery management data and determines a charge state of UAV-batteries. Each determined charge state is displayed 113.

1-227. (canceled)

228. Computer implemented method for providing a live-view of a UAV's physical environment, the method including:
continuously generating a view of the physical environment of the UAV based on image data from a camera system of the UAV, the camera system including a plurality of cameras arranged peripherally at the UAV, the cameras each having a field of view with a fixed orientation in relation to the UAV and directed away from the UAV, and the camera system providing available image data of the plurality of cameras for generating an all-round view to the physical environment,
continuously displaying the view of the physical environment in a live-view by a touch sensitive display,
receiving and identifying a touch input, indicative of a desired viewing direction in which the view of the physical environment is to be generated, and
based thereon generating and displaying in the live-view a view of the physical environment in the desired viewing direction,
wherein
selecting the image data from the available image data based on the desired viewing direction, and
generating and displaying in the live-view the view of the physical environment in the desired viewing direction based on the selected image data.

229. The method according to claim 228, including receiving the touch input by the touch sensitive display, the touch sensitive display comprising a plurality of touch zones spread to the live-view, wherein
the desired viewing direction is determined based on identifying the touch zone, where the touch input is received, and
a touch zone having assigned thereto, predetermined image data selection information based on which the image data is selected from the available image data.

230. The method according to claim 228, including stitching the selected image data using an image stitching algorithm and based thereon generating and displaying in the live-view the view of the physical environment in the desired viewing direction.

231. The method according to claim 230, including correlating directional distance information, recorded by a directional distance measuring module of the UAV by measuring the physical environment, with the selected image data such that selected image data with depth information is generated, wherein the image stitching algorithm is stitching the selected image data based on the depth information.

232. The method according to claim 228, including correcting a parallax-offset between cameras of the camera system based on the depth information and, based thereon, generating and displaying in the live-view the view of the physical environment in the desired viewing direction.

233. The method according to claim 228, including, by
selecting the image data from the available image data based on the desired viewing direction, and
generating and displaying in the live-view the view of the physical environment in the desired viewing direction based on the selected image data,
providing a virtual gimbal functionality, which enables to virtually gimbal the view, by the touch input, wherein virtually gimbal the view is decoupled from the movement of the UAV.

234. A computer program product comprising machine readable program code stored in a non-transitory machine-readable medium, which when executed by processing units related to a mobile control device having a touch sensitive display and/or a UAV enables providing a live-view of a UAV's physical environment according to the method of claim 228.

235. The system for controlling the flight of a UAV in a physical environment, the system including:
a UAV having a camera system including a plurality of cameras arranged peripherally at the UAV, the cameras having a field of view with a fixed orientation in relation to the UAV and directed away from the UAV, and the camera system providing available image data of the plurality of cameras for generating an all-round view to the physical environment, and
a computer program product according to claim 234.

236. The system according to claim 235, the UAV having a directional distance measuring module recording directional distance information by measuring the physical environment.

237. The system according to claim 235, further including a mobile control device having a touch sensitive display.

238. The system according to claim 235, the camera system including a plurality of cameras arranged peripherally at the UAV, with
each camera having a field of view with a fixed orientation in relation to the UAV and directed away from the UAV,
one front camera facing forward, one top camera facing up, one bottom camera facing down, and at least one side camera facing sideways,
wherein
the cameras are arranged such that
each field of view overlaps to a predefined degree at least one adjacent field of view, and
the camera system provides an all-round view to the physical environment, and
the camera system provides available image data of the plurality of cameras for generating an all-round view to the physical environment.

239. A computer implemented method for conditioning sensor raw data generated by a multipurpose sensor system of a UAV flying in a physical environment, the method including:
generating sensor raw data by the multipurpose sensor system in the form of
image data from a camera system of the UAV,
motion data from an inertial measurement unit (IMU) of the UAV,
measurement data, in particular 3D point data, from a directional distance measuring module of the UAV, in particular wherein the directional distance measuring module measures distances and directions to object surfaces based on the light detection and ranging (lidar) principle, and
global position data from a GNSS receiver module of the UAV,
providing
a flight control support functionality using support data for supporting the flight control, and
a sensor data recording functionality for recording sensor data, which enable a generation of a representation of the physical environment of the UAV,
autonomously supporting, by the flight control support functionality, the control of the flight of the UAV, and
recording, by the sensor data recording functionality, sensor data, which enable the generation of a representation of the physical environment of the UAV,
wherein
receiving the sensor raw data, by a sensor raw data conditioning unit of the UAV, and
conditioning, by the sensor raw data conditioning unit, the sensor raw data to generate the support data and the sensor data, wherein
at least one of the image data, the motion data, the measurement data, and the global position data is used for both to generate the support data and the sensor data.

240. The method according to claim 239, the flight control support functionality including a visual inertial system (VIS), the visual inertial system using support data in the form of conditioned image data to derive motion data related to the movement/motion of the UAV based on tracking predetermined features in the image data.

241. The method according to claim 240, conditioning including conditioning the image data based on a criterion relating to using the image data by the VIS.

242. The method according to claim 239, wherein
the sensor data enable a generation and display of a view of the physical environment of the UAV to a user, and
the generation and display is based on sensor data in the form of conditioned image data.

243. The method according to claim 240, conditioning including conditioning the image data based on a criterion relating to generating sensor data based on the image data to enable a generation and display of a view of the physical environment of the UAV to a user.

244. The method according to claim 239, the flight control support functionality including a collision avoidance functionality, the collision avoidance functionality using support data in the form of conditioned measurement data to detect obstacles in the physical environment and avoid the obstacles.

245. The method according to claim 239, wherein
the sensor data enable the generation and display of a view of the physical environment of the UAV to a user, and
the generation and display is based on sensor data in the form of conditioned measurement data, wherein the conditioned measurement data is used for supporting a stitching of conditioned image data.

246. The method according to claim 245, conditioning including conditioning the measurement data based on a criterion relating to generating sensor data based on the measurement data to enable the generation and display of a view of the physical environment of the UAV to a user.

247. The method according to claim 239, wherein
the sensor data enable a display of the representation of the physical environment of the UAV to a user, and
the display is based on sensor data in the form of conditioned measurement data including 3D point data.

248. The method according to claim 247, conditioning including conditioning the measurement data based on a criterion relating to generating sensor data based on the measurement data to enable a display of the representation of the physical environment of the UAV to a user.

249. The method according to claim 239, the flight control support functionality using support data in the form of conditioned global position data for controlling the flight of the UAV in the physical environment.

250. The method according to claim 239, wherein
the sensor data enable a display of the representation of the physical environment of the UAV to a user, and
the display is based on sensor data in the form of conditioned global position data by using the conditioned global position data to assign a global position to the representation.

251. The method according to claim 250, conditioning including conditioning the global position data based on a criterion relating to generating sensor data based on the global position data to enable a display of the representation of the physical environment of the UAV to a user with the representation having assigned thereto a global position.

252. The method according to claim 239, the support data and the sensor data each including a combination of at least two of image data,
motion data,
measurement data, and
global position data.

253. The method according to claim 239, the sensor raw data being generated at a predefined maximum rate and at a predefined maximum resolution, wherein conditioning the sensor raw data includes providing the sensor raw data at a predefined resolution and/or at a predefined rate based on a criterion relating to generating support data and/or sensor data from the sensor raw data.

254. A computer program product comprising machine readable program code stored in a non-transitory computer-readable medium, which when executed by processing units related to a mobile control device having a touch sensitive display and/or a UAV enables conditioning of sensor raw data according to the method of claim 12.
